(19) United States
(12) Patent Application Publication
(10) Pub. No.: US 2025/0377759 A1
(43) Pub. Date: Dec. 11, 2025

(54) METHODS OF ADJUSTING A SIMULATED RESOLUTION OF A VIRTUAL OBJECT IN A THREE-DIMENSIONAL ENVIRONMENT

(71) Applicant: Apple Inc., Cupertino, CA (US)

(72) Inventors: Lorena S. PAZMINO, San Francisco, CA (US); Jonathan RAVASZ, Sunnyvale, CA (US); Adam L. AMADIO, San Francisco, CA (US); James A. MCCOMBE, San Francisco, CA (US); Zoey C. TAYLOR, San Francisco, CA (US); Stephen O. LEMAY, Palo Alto, CA (US); Christopher D. MCKENZIE, Burlingame, CA (US)

(21) Appl. No.: 19/229,893

(22) Filed: Jun. 5, 2025

Related U.S. Application Data
(60) Provisional application No. 63/657,692, filed on Jun. 7, 2024.
(60) Provisional application No. 63/714,758, filed on Oct. 31, 2024.

(51) Int. Cl. G06F 3/04815; G06F 3/0482; G06F 3/04845; G06F 3/0488; G06T 19/20

(52) U.S. Cl. CPC G06F 3/04815; G06F 3/0482; G06F 3/04845; G06F 3/0488; G06T 19/20; G06T 2200/24; G06T 2219/2016

(57) ABSTRACT

Some embodiments of the disclosure are directed to facilitating changing a simulated resolution of a virtual object in a three-dimensional environment. Some embodiments of the disclosure are directed to facilitating changing a curvature of a virtual object based on a size of the virtual object relative to a viewpoint of a user in a three-dimensional environment.

### CROSS REFERENCE TO RELATED APPLICATIONS

This application claims the benefit of U.S. Provisional Application No. 63/657,692, filed Jun. 7, 2024, and U.S. Patent Application No. 63/714,758, filed Oct. 31, 2024, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system facilitates changing a simulated resolution of a virtual object in a three-dimensional environment. In some embodiments, a computer system facilitates changing a curvature of a virtual object based on a size of the virtual object relative to a viewpoint of a user in a three-dimensional environment.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the Figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7FF illustrate examples of a computer system facilitating changing of a curvature of a virtual object when changing a simulated resolution of the virtual object in accordance with some embodiments.

FIG. 8 is a flowchart illustrating an exemplary method of facilitating changing a simulated resolution of a virtual object in a three-dimensional environment in accordance with some embodiments.

FIG. 9 is a flowchart illustrating an exemplary method of facilitating changing a curvature of a virtual object based on a size of the virtual object relative to a viewpoint of a user in a three-dimensional environment in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system facilitates changing a simulated resolution of a virtual object in a three-dimensional environment. In some embodiments, while displaying, via one or more display generation components, a representation of content from a second computer system, different from a first computer system, in an environment, the first computer system detects, via one or more input devices, a first set of one or more inputs corresponding to a request to change a size of the representation of the content in the environment. In some embodiments, in response to detecting the first set of one or more inputs, in accordance with a determination that the first set of one or more inputs includes a first type of input, the first computer system changes a simulated resolution of the representation of the content in the environment based on the first set of one or more inputs, wherein changing a simulated resolution of the representation of the content increases an amount of space in the representation of content that is available for displaying content items.

In some embodiments, a computer system facilitates changing a curvature of a virtual object based on a size of the virtual object relative to a viewpoint of a user in a three-dimensional environment. In some embodiments, while displaying, via one or more display generation components, a virtual object in an environment wherein a respective portion of the virtual object has a first amount of curvature, the computer system detects, via one or more input devices, a first set of one or more inputs corresponding to a request to initiate a process to adjust one or more spatial properties of the virtual object in the environment. In some embodiments, in response to detecting the first set of one or more inputs, in accordance with a determination that the virtual object has a first size in the environment relative to a viewpoint of a user of the computer system, the computer system changes a curvature of the respective portion of the virtual object from the first amount of curvature to a second amount of curvature that is different from the first amount of curvature.

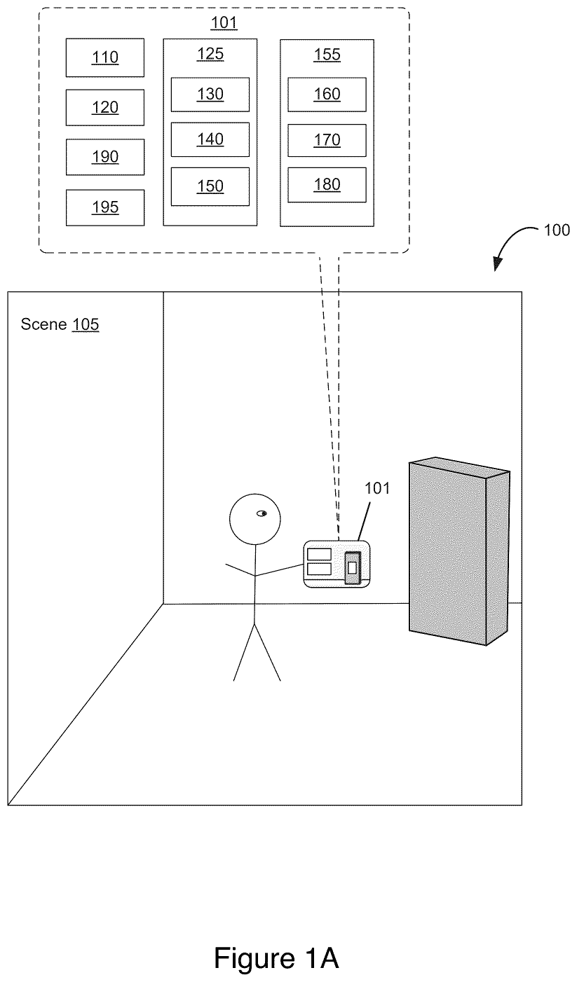

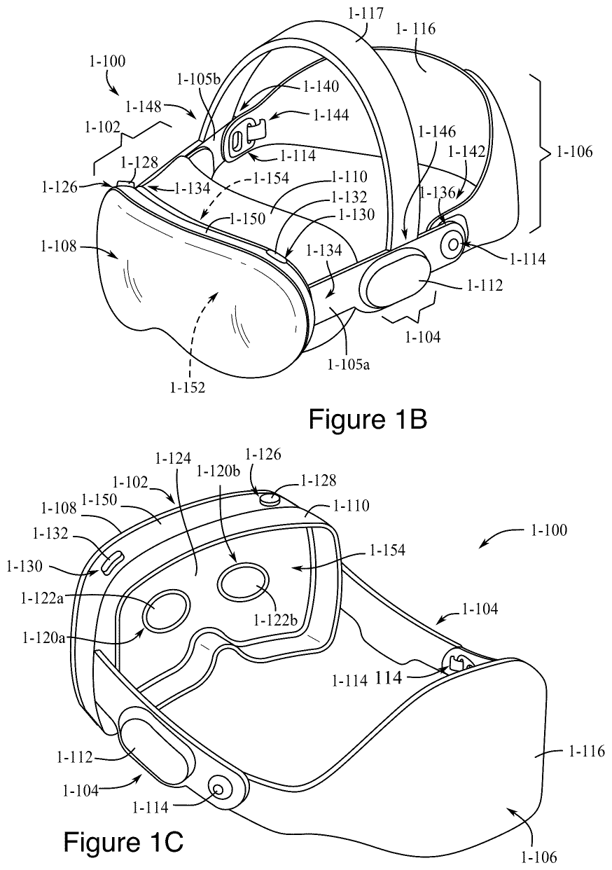

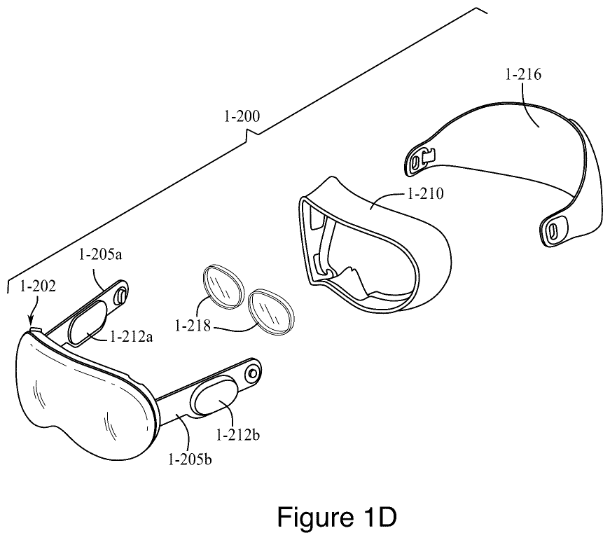

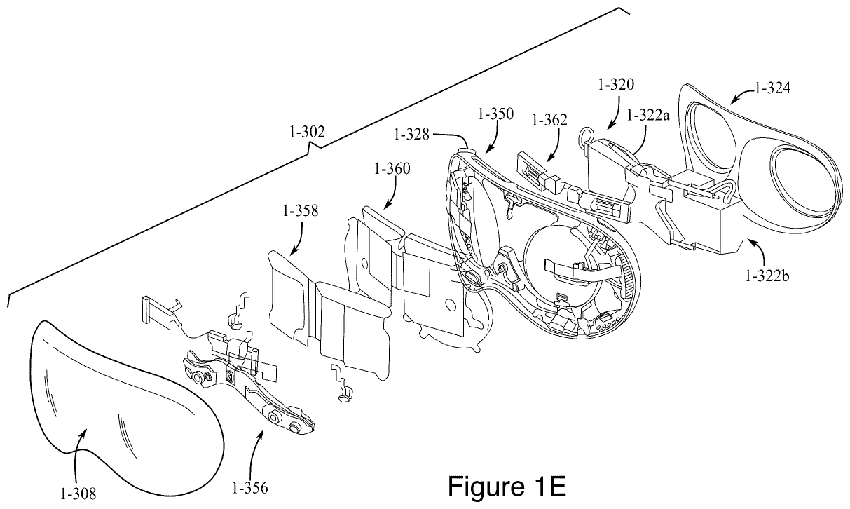

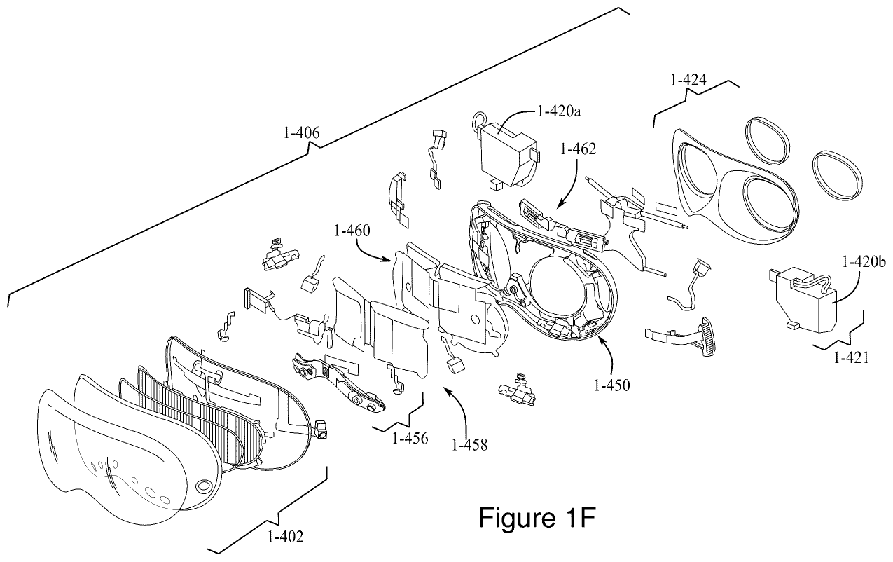

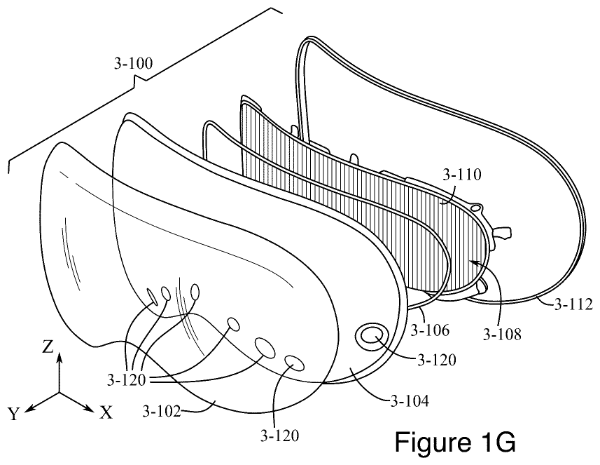

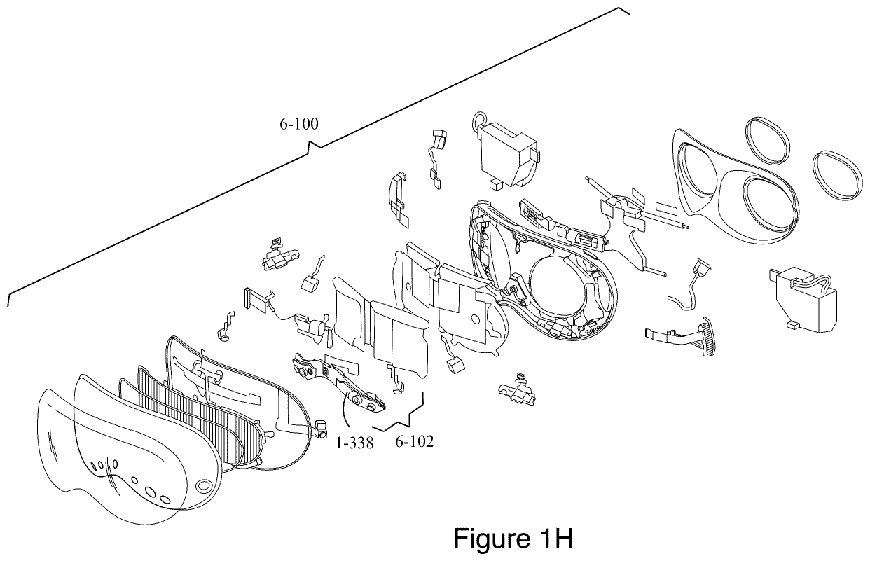

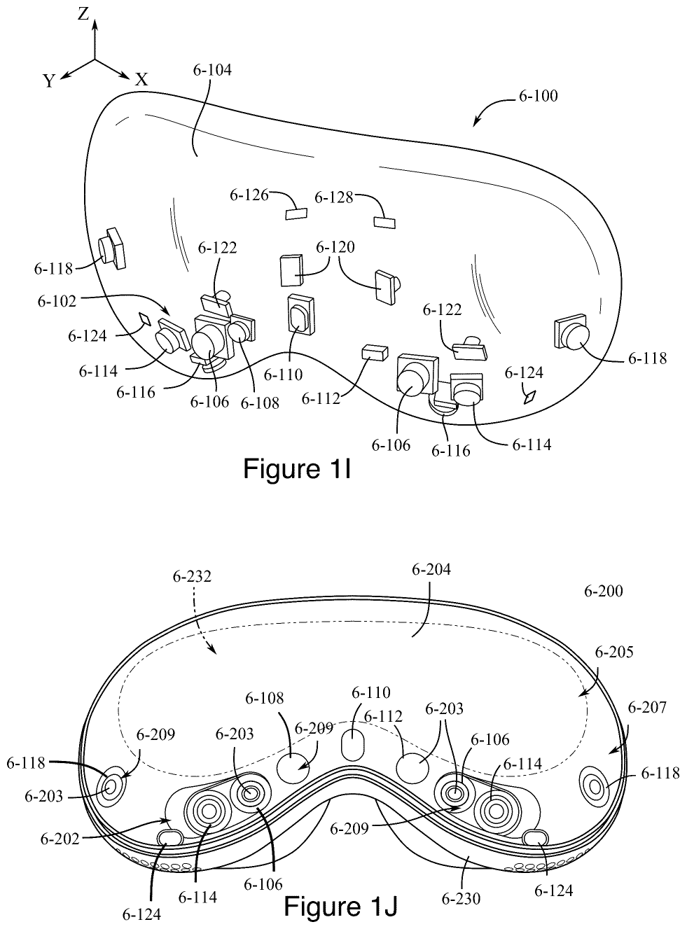

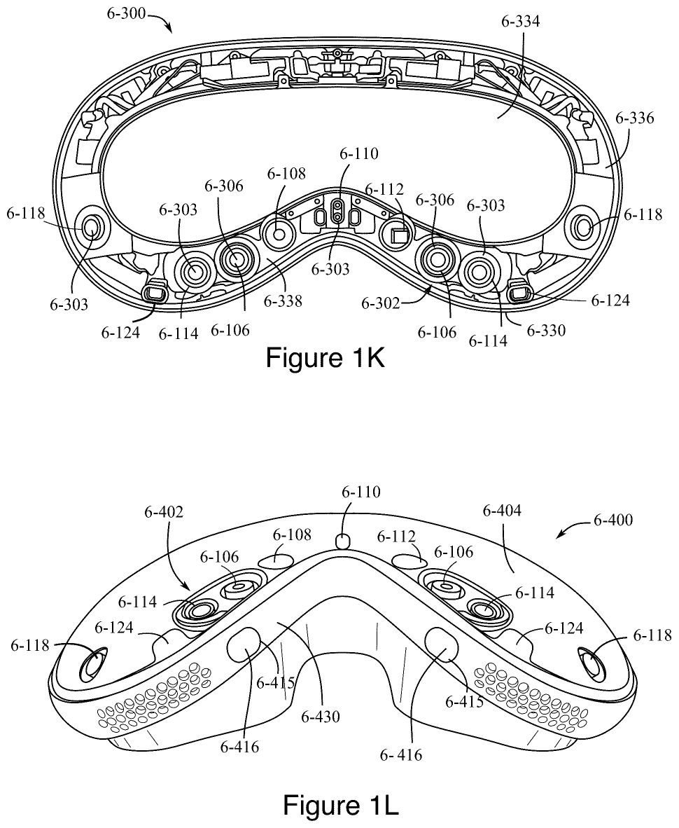

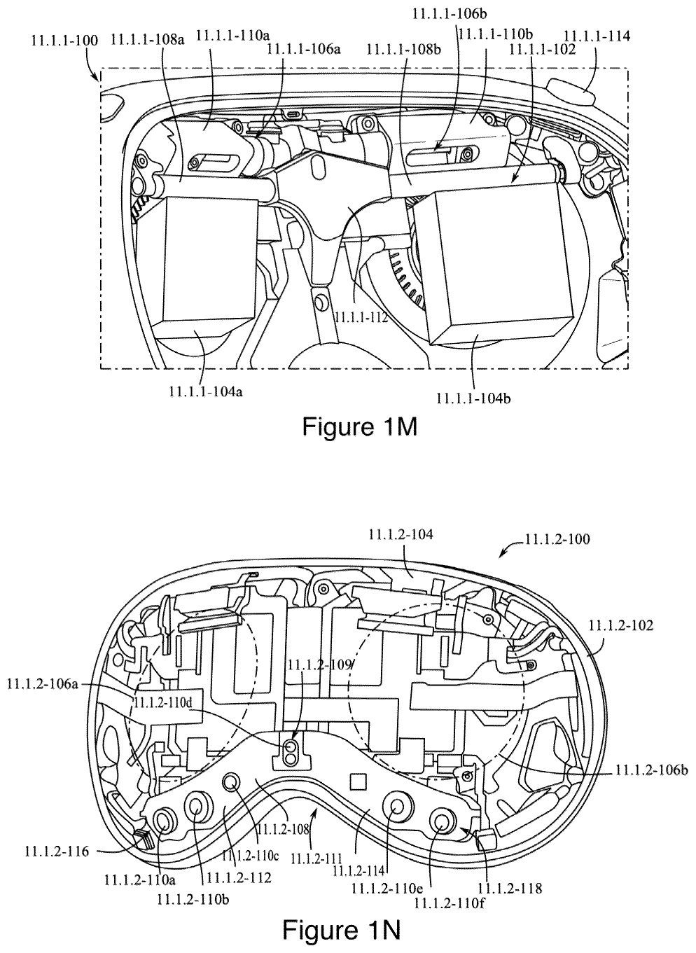

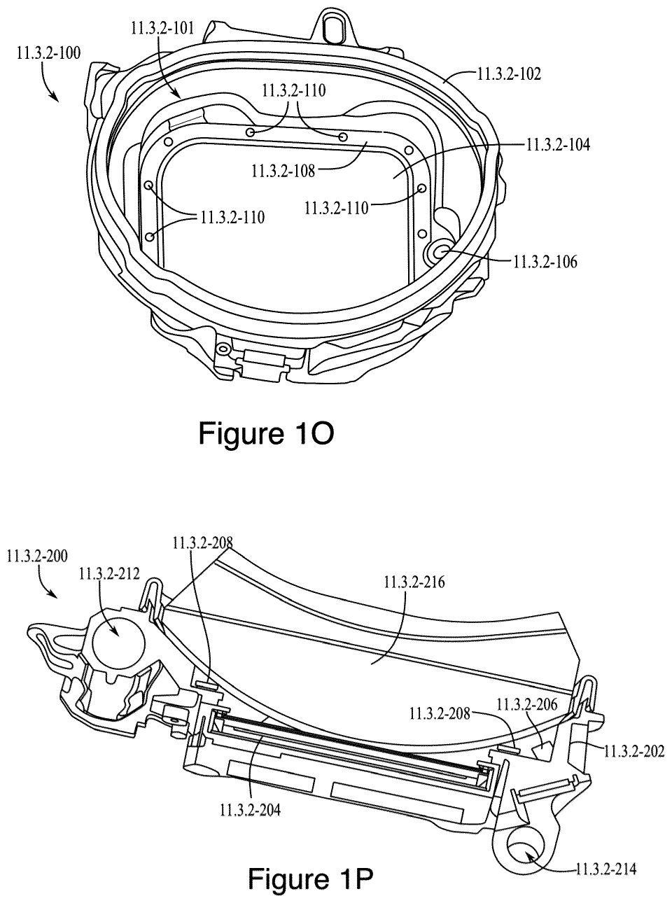

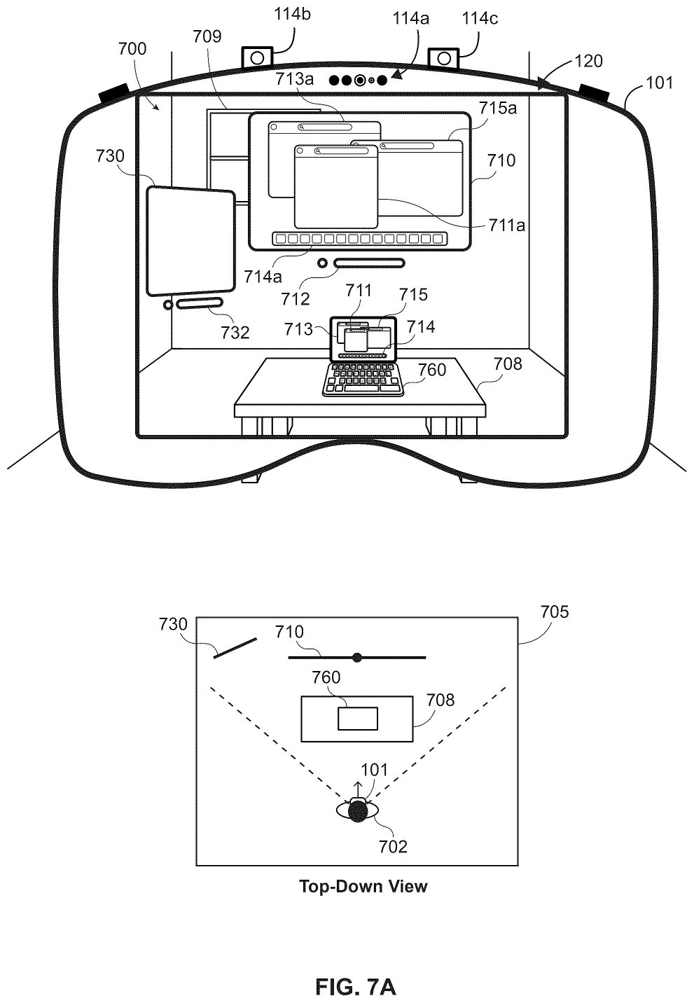

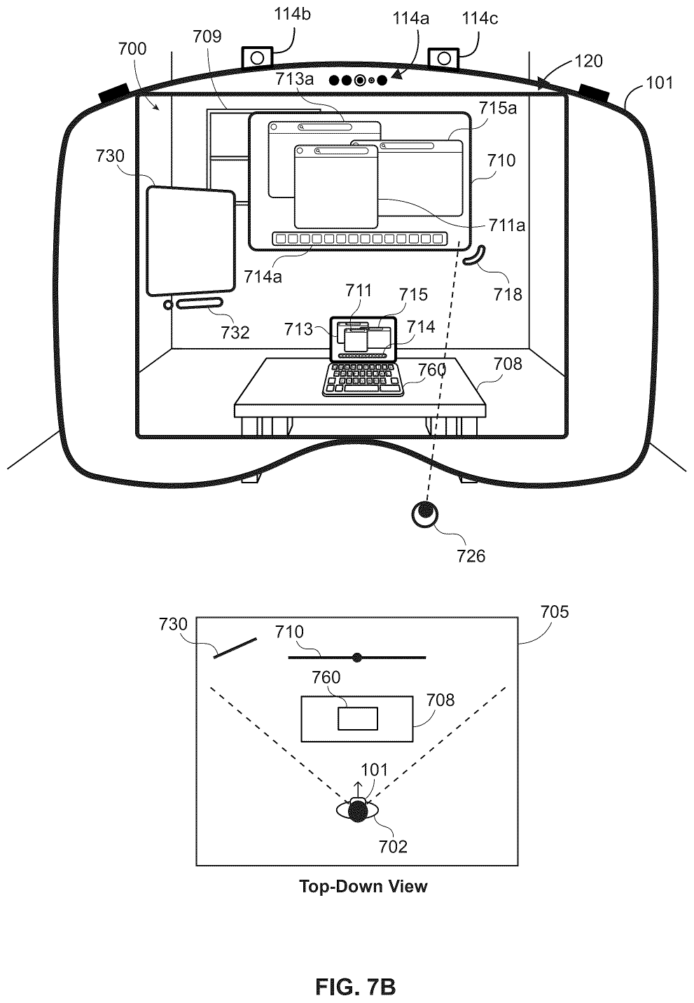

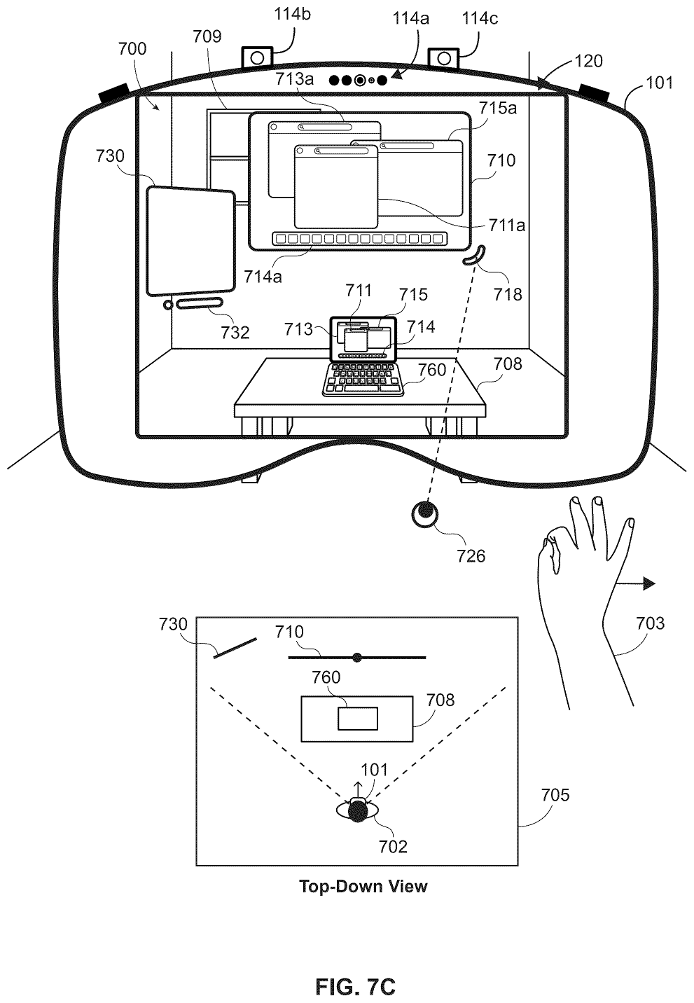

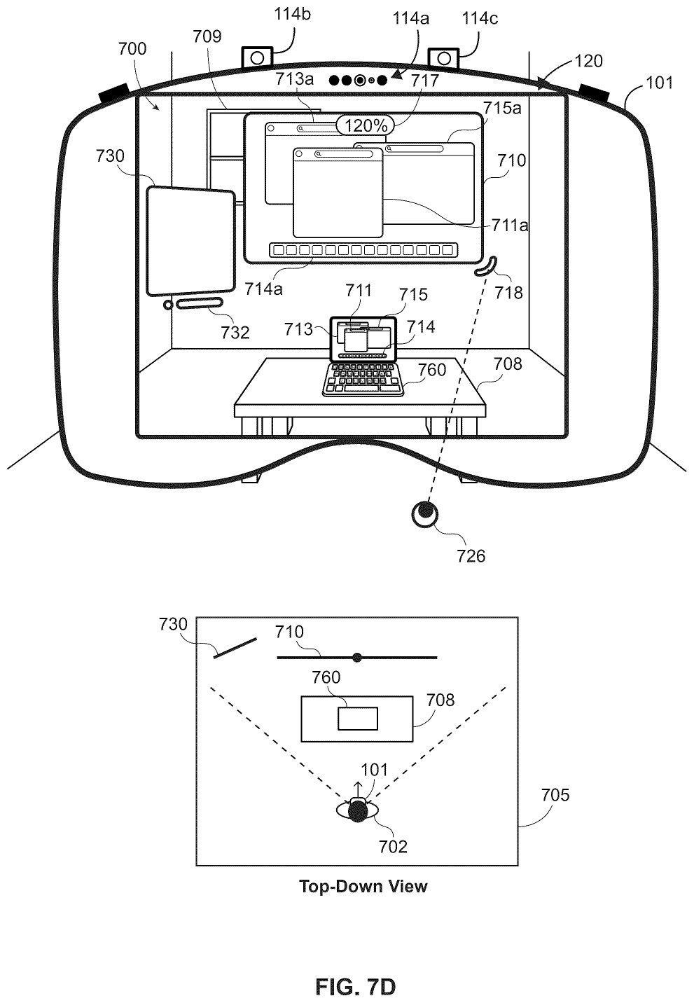

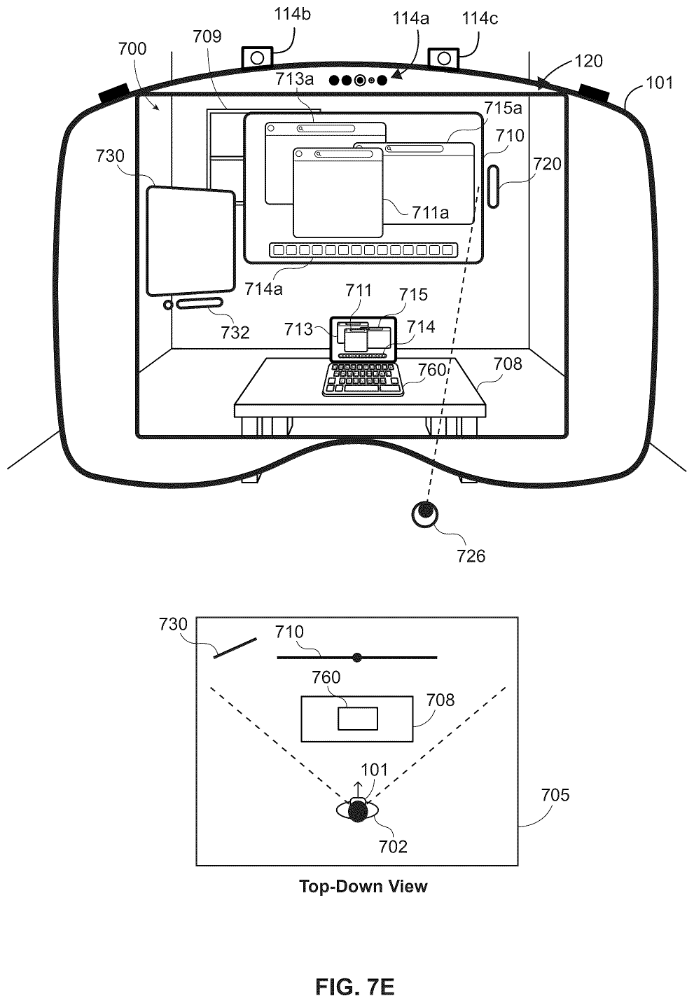

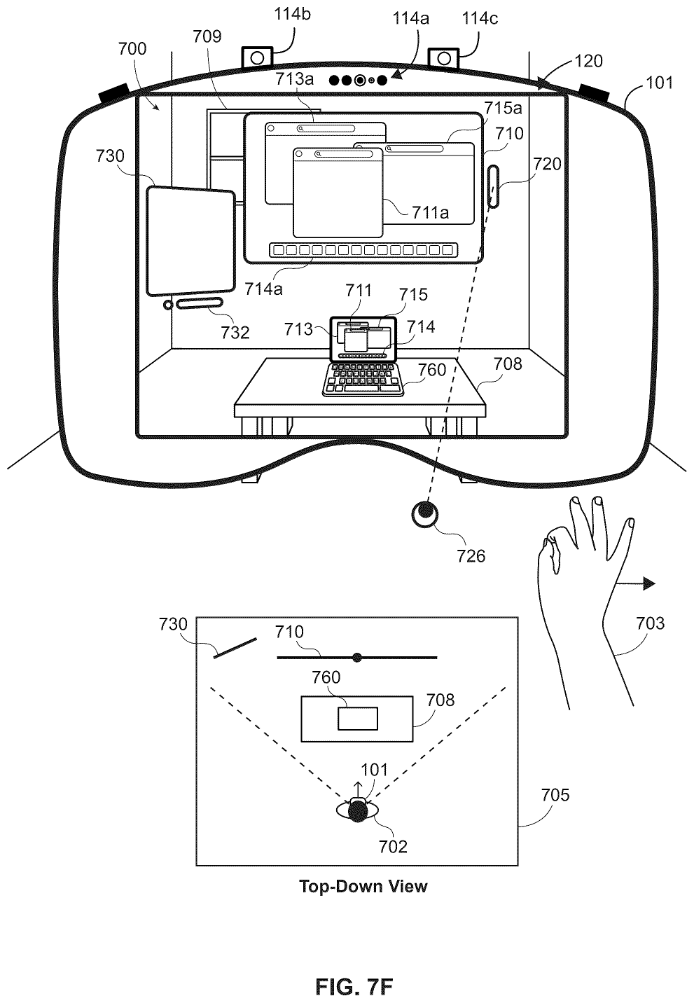

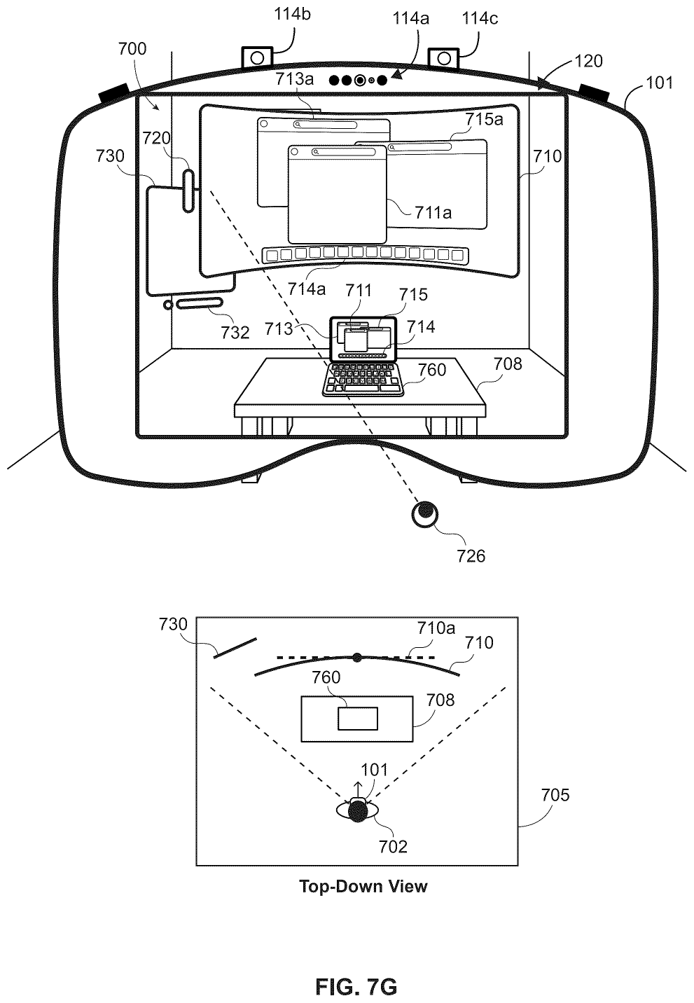

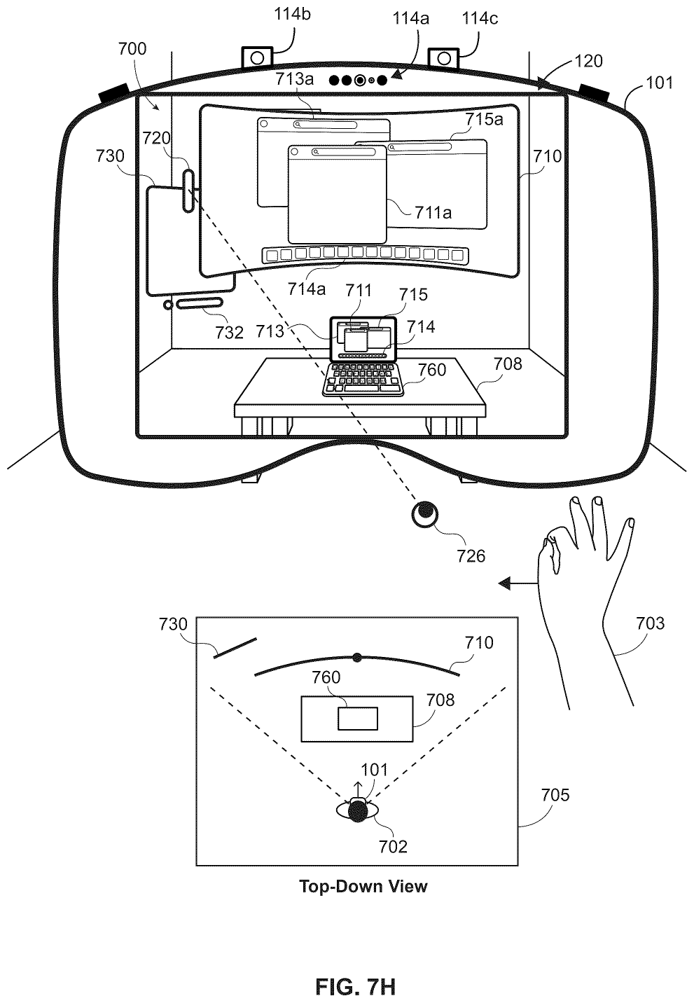

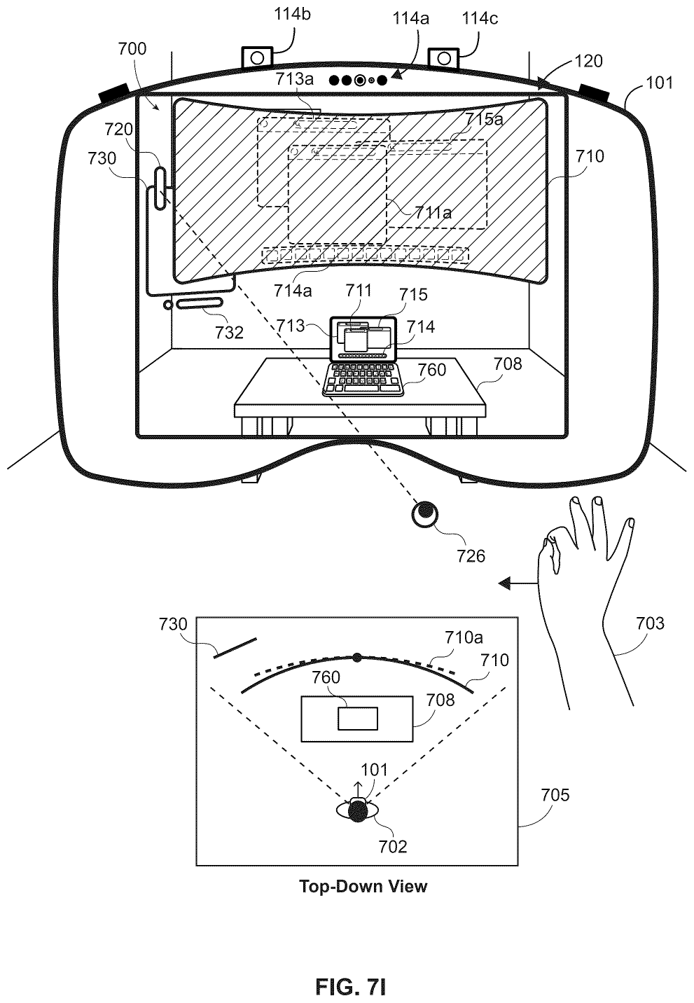

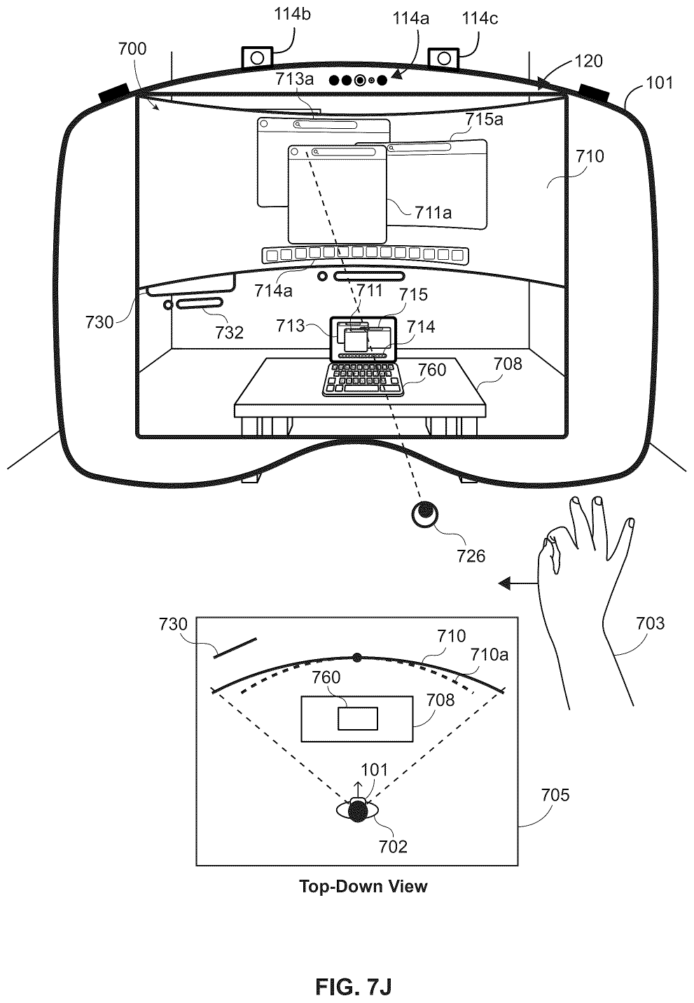

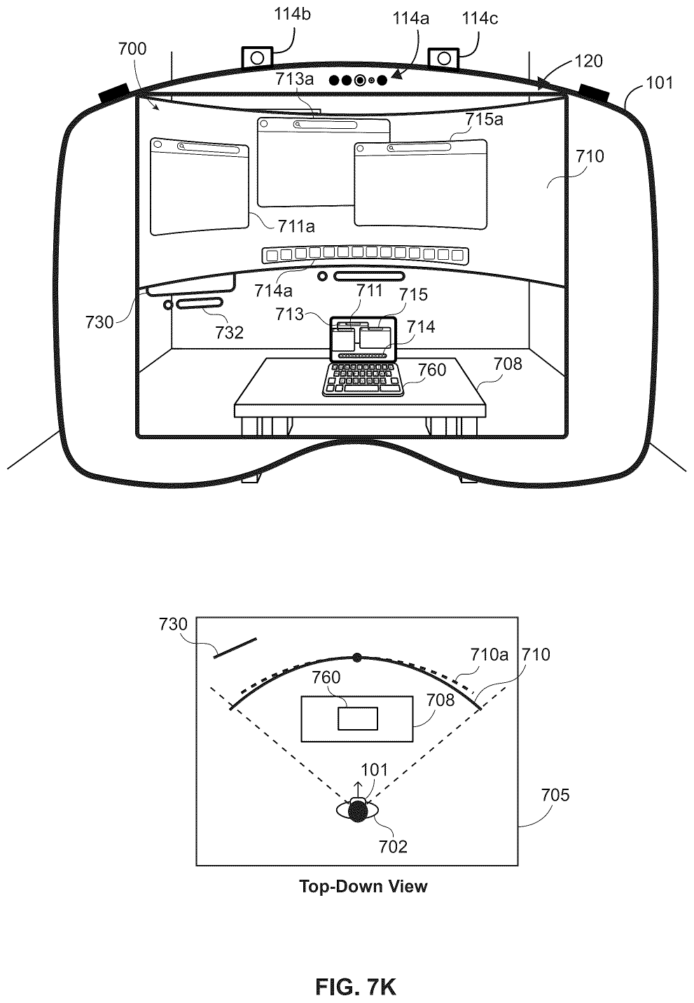

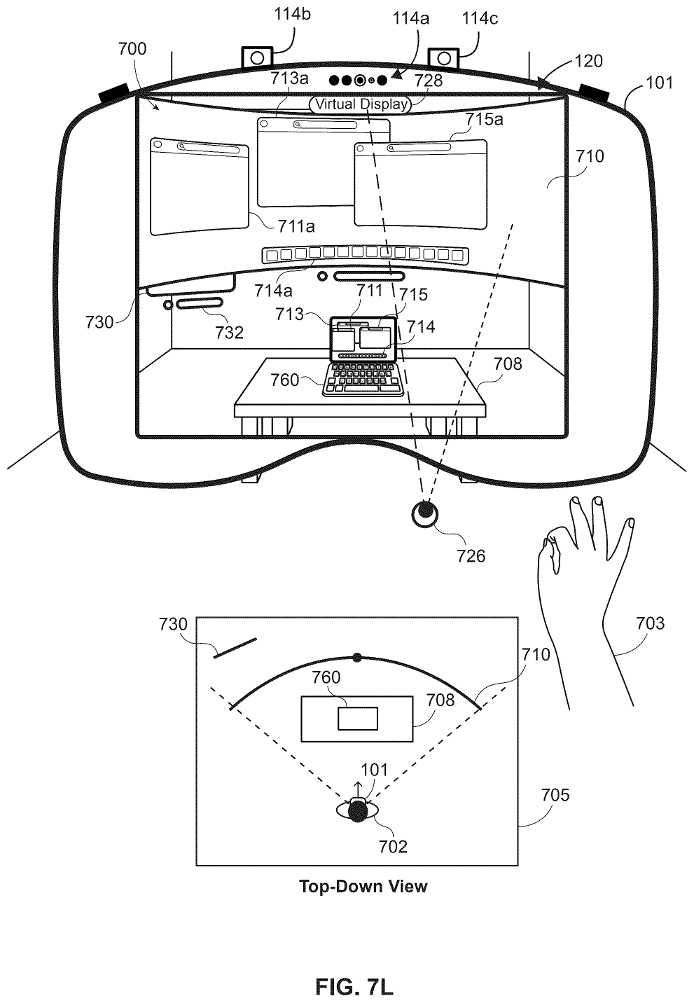

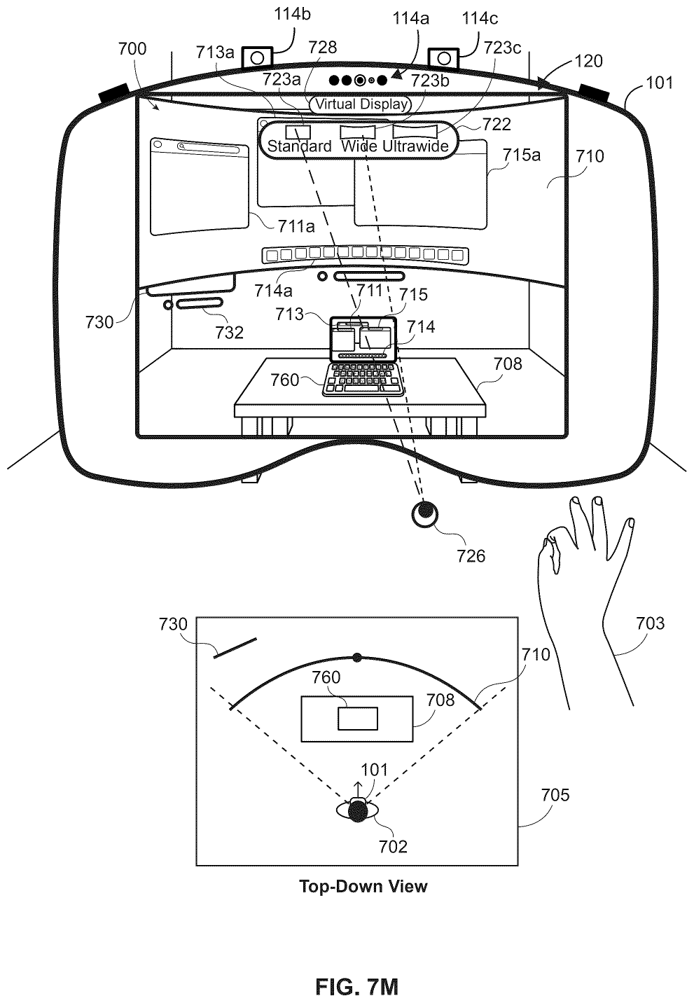

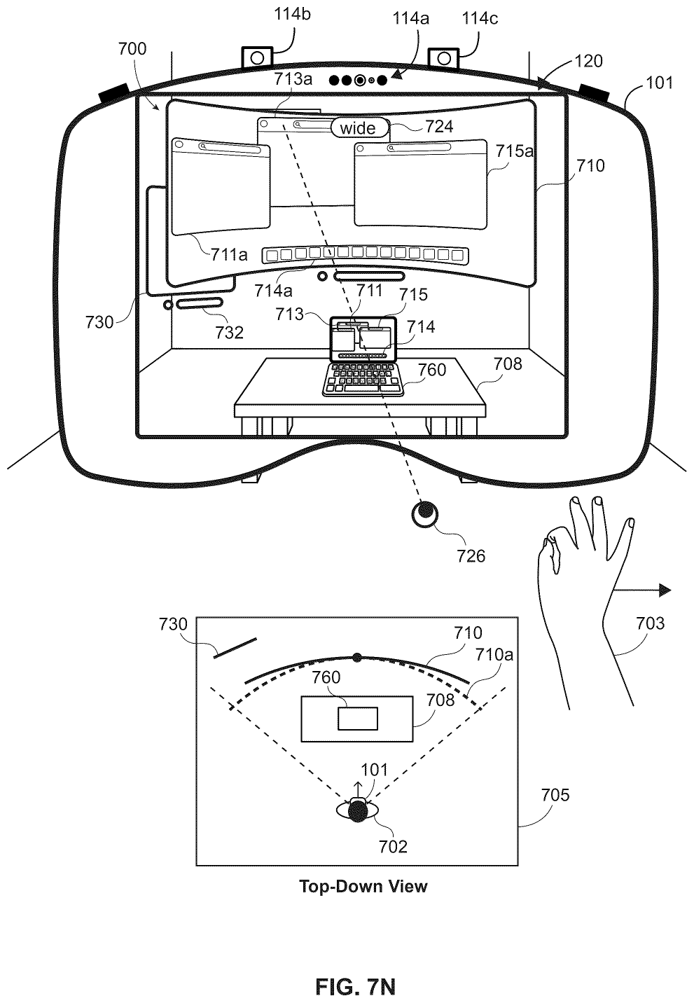

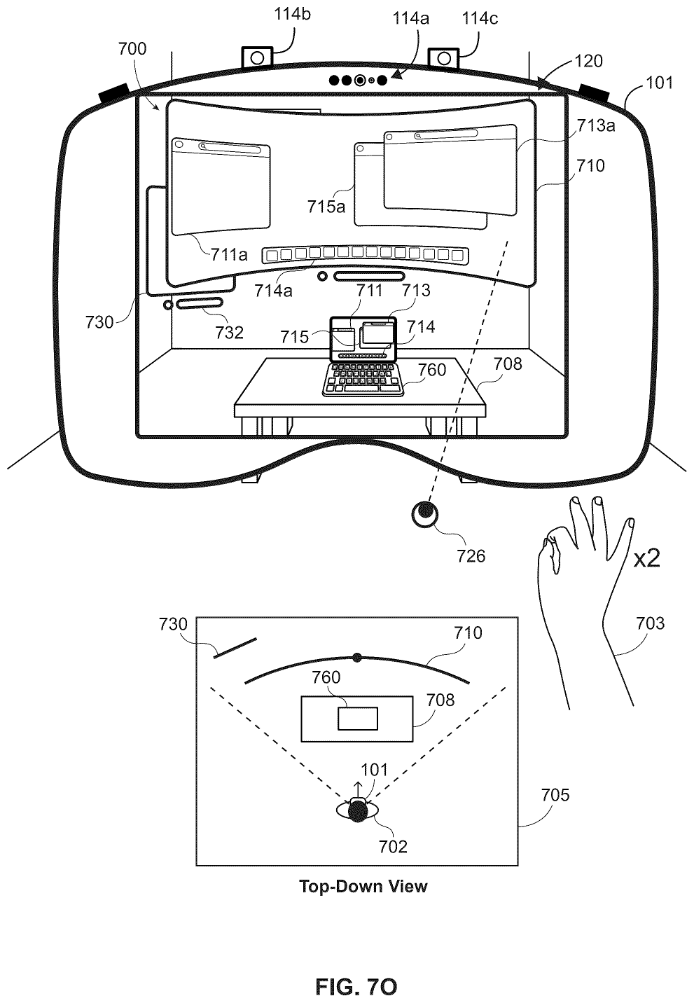

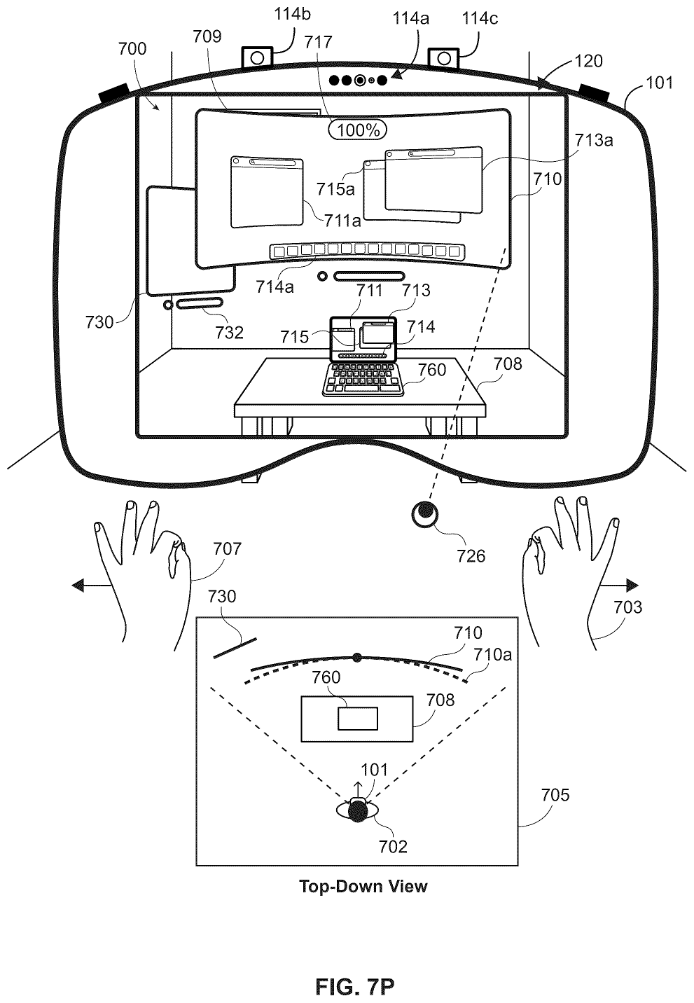

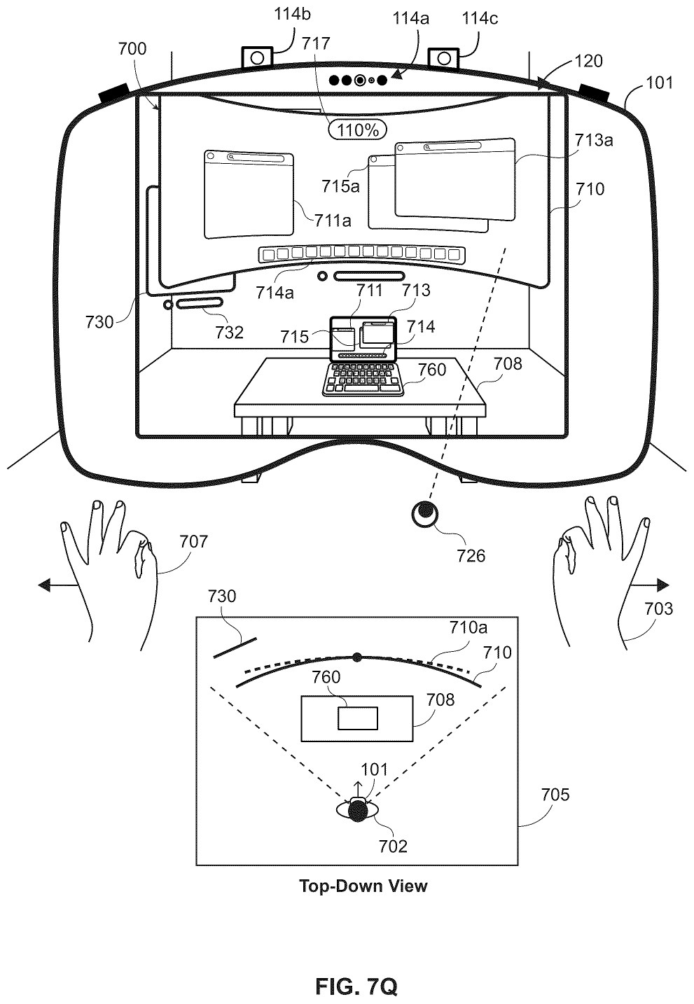

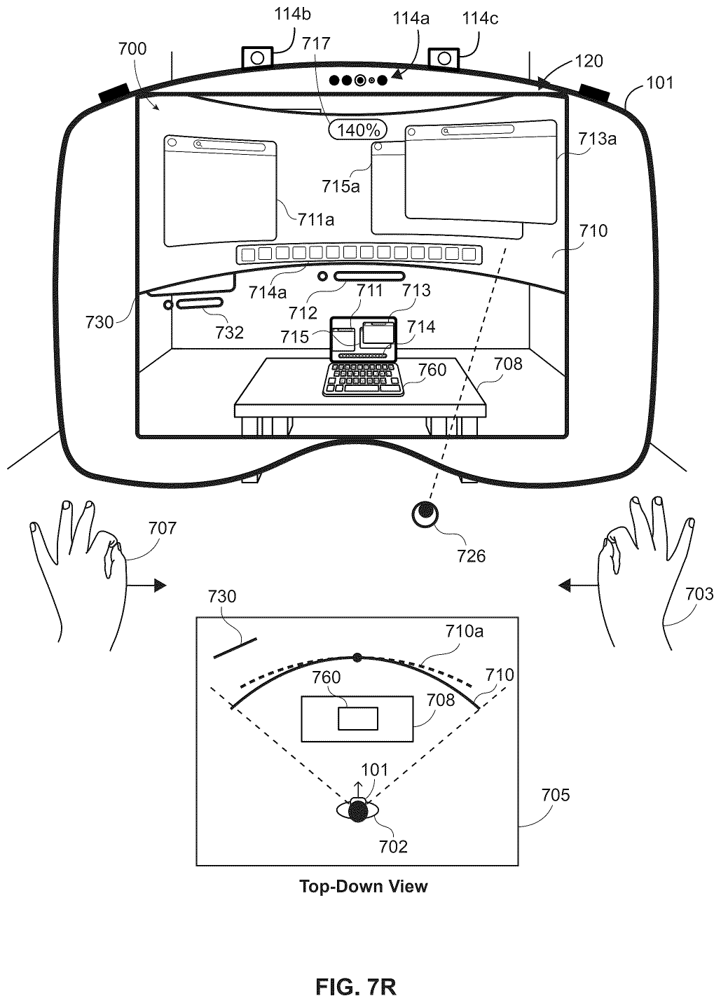

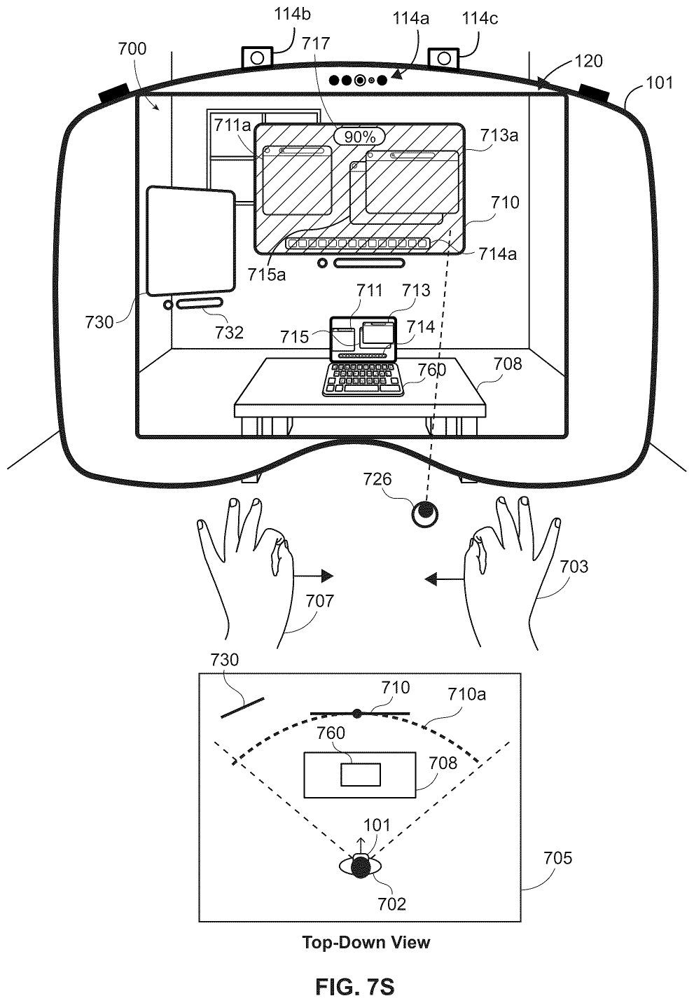

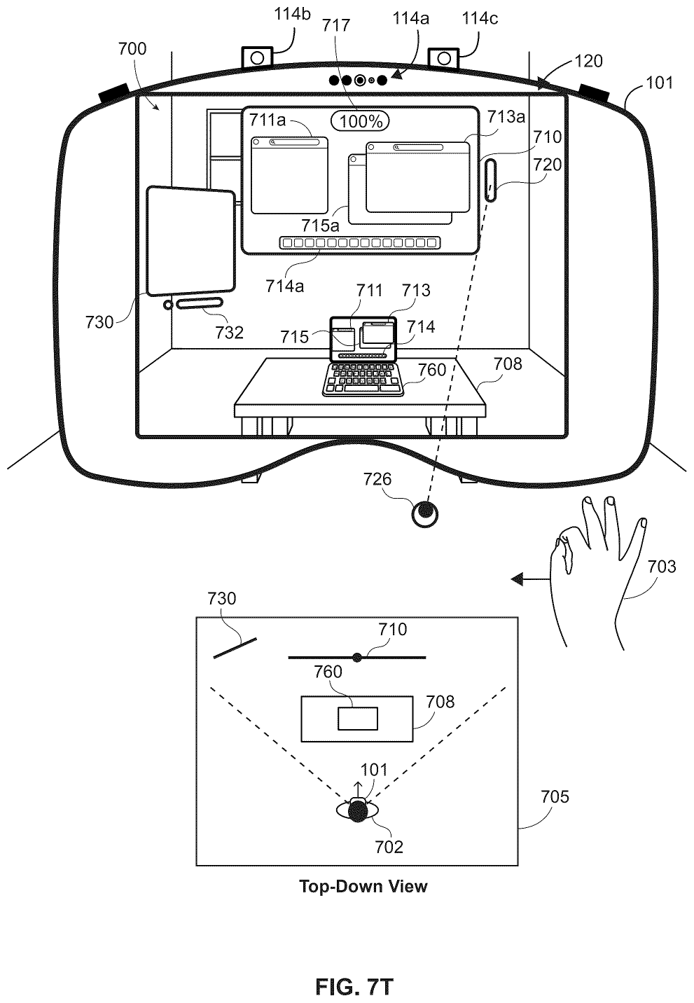

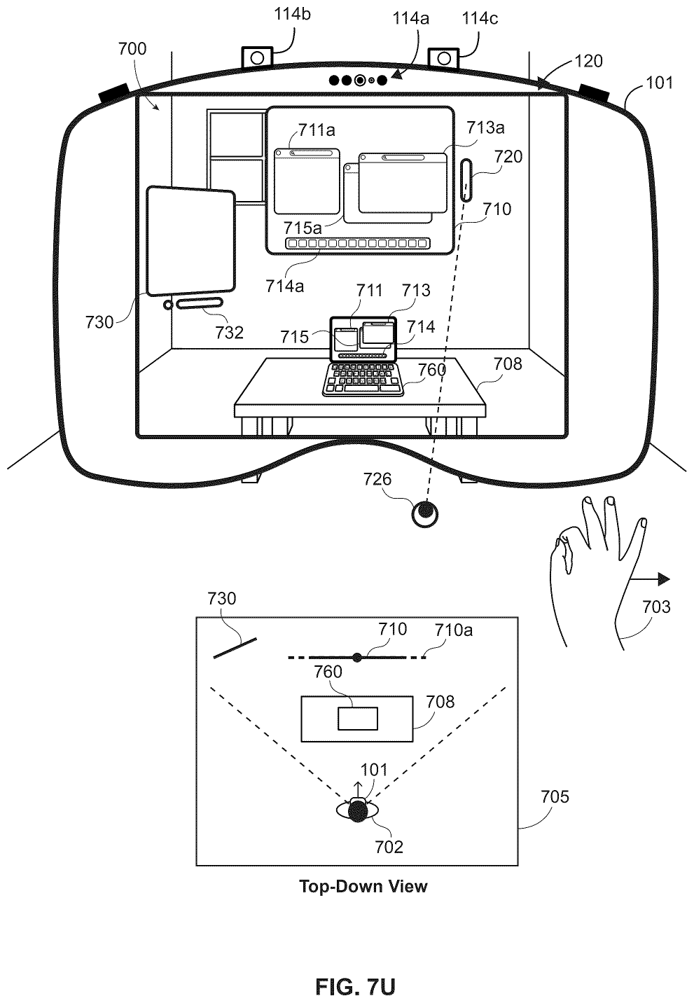

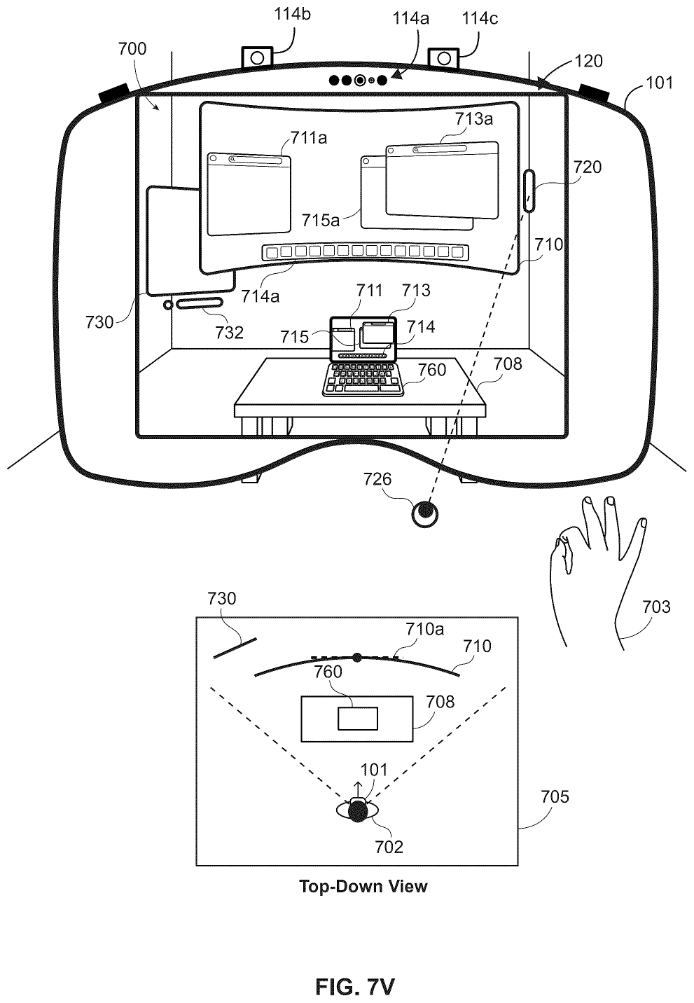

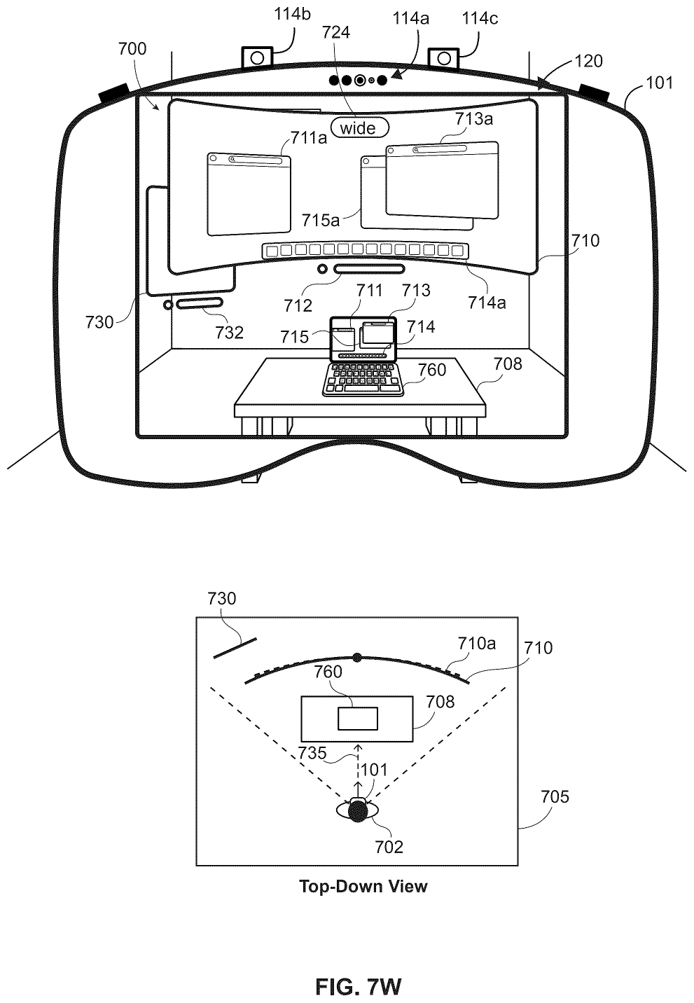

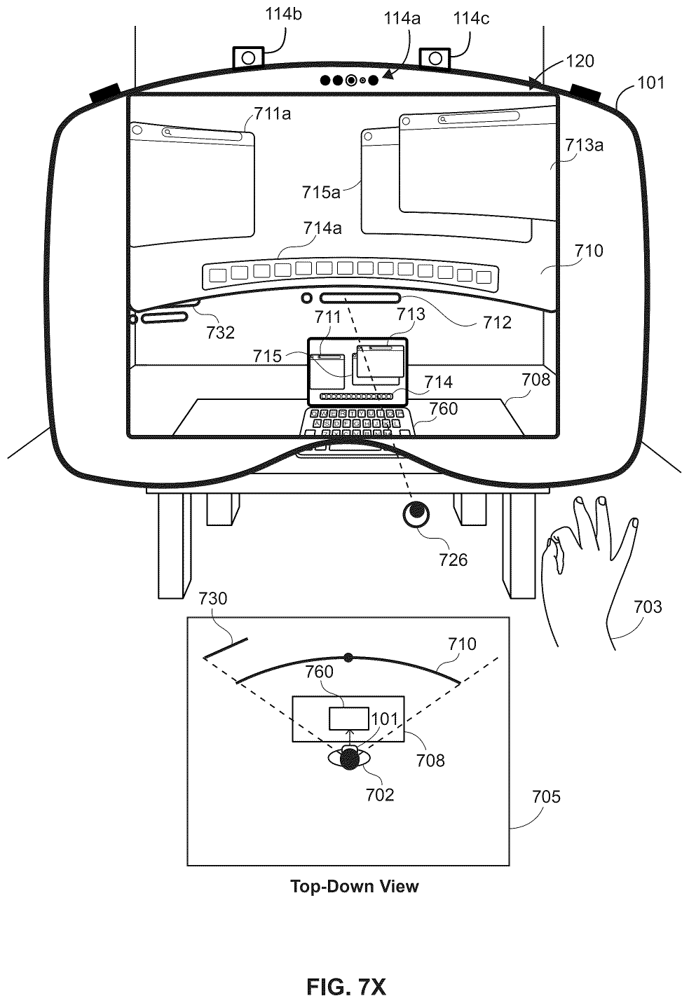

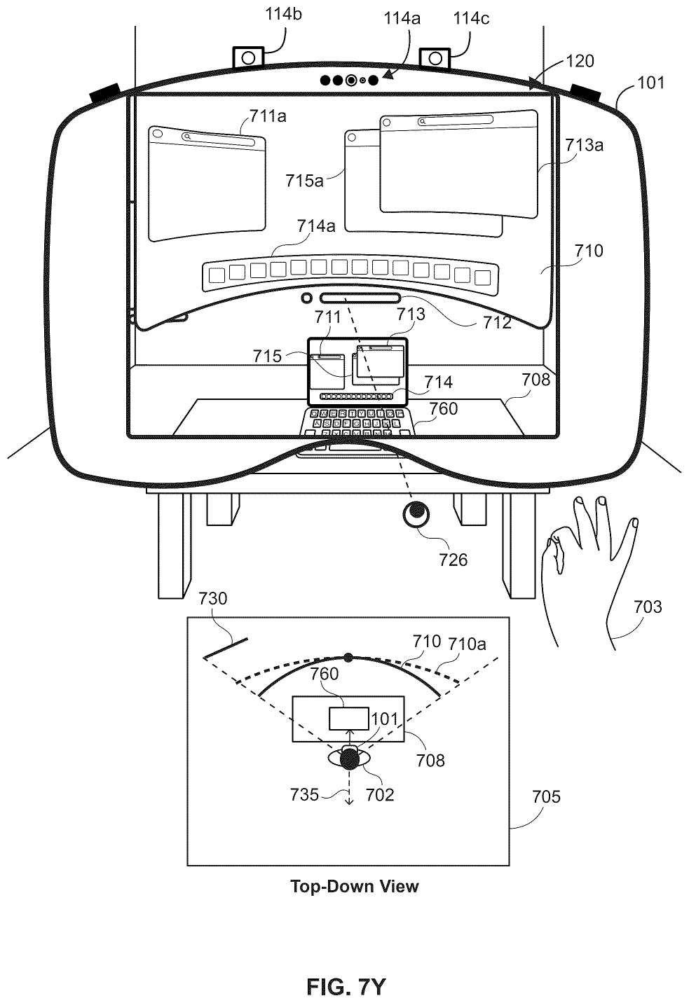

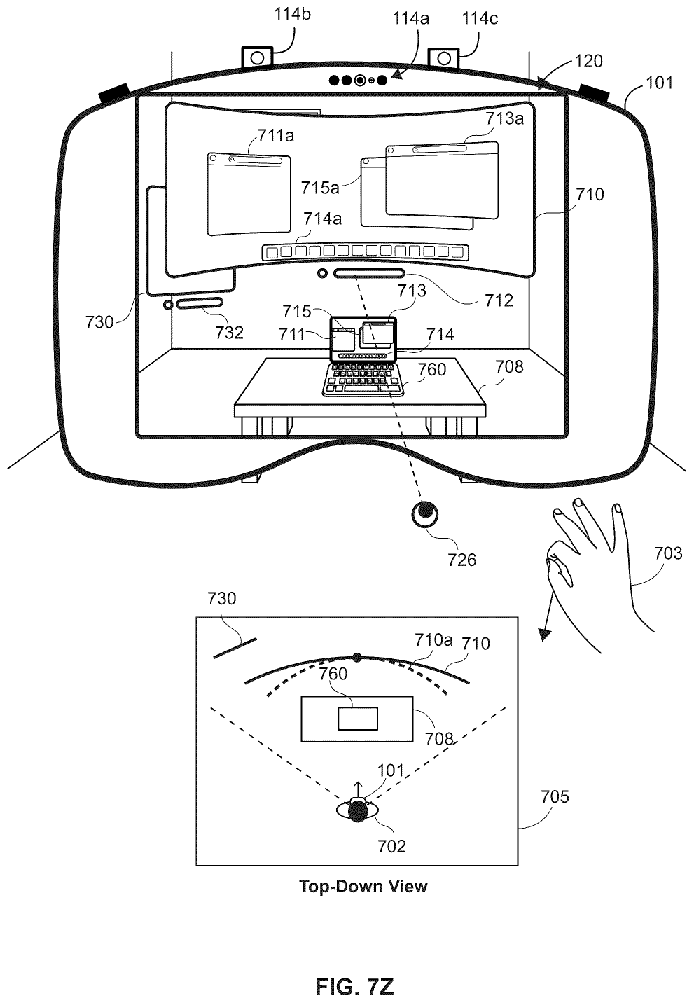

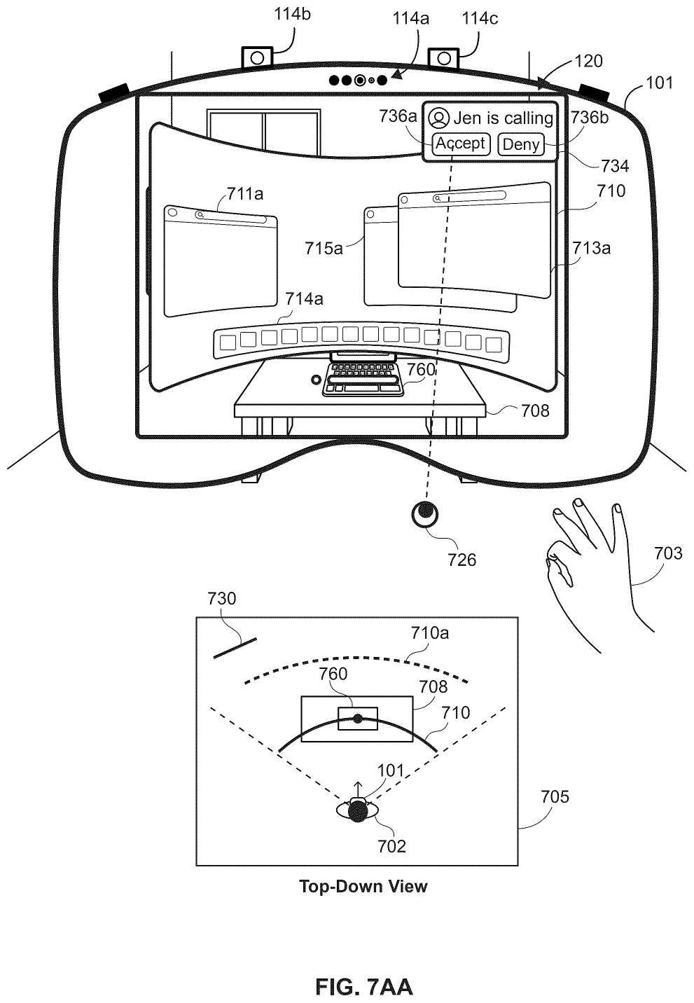

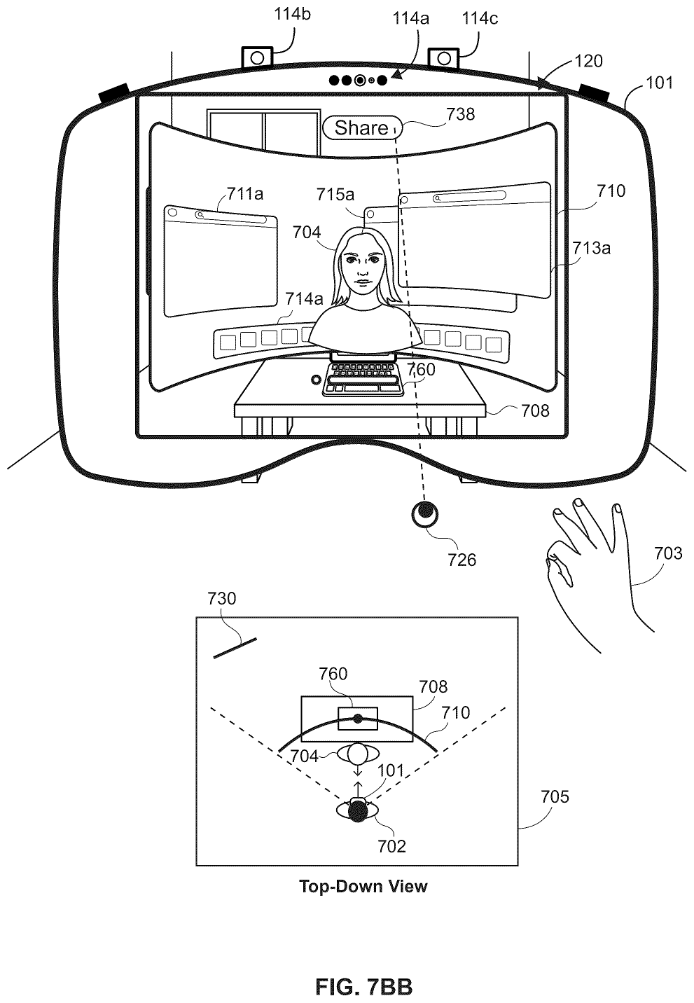

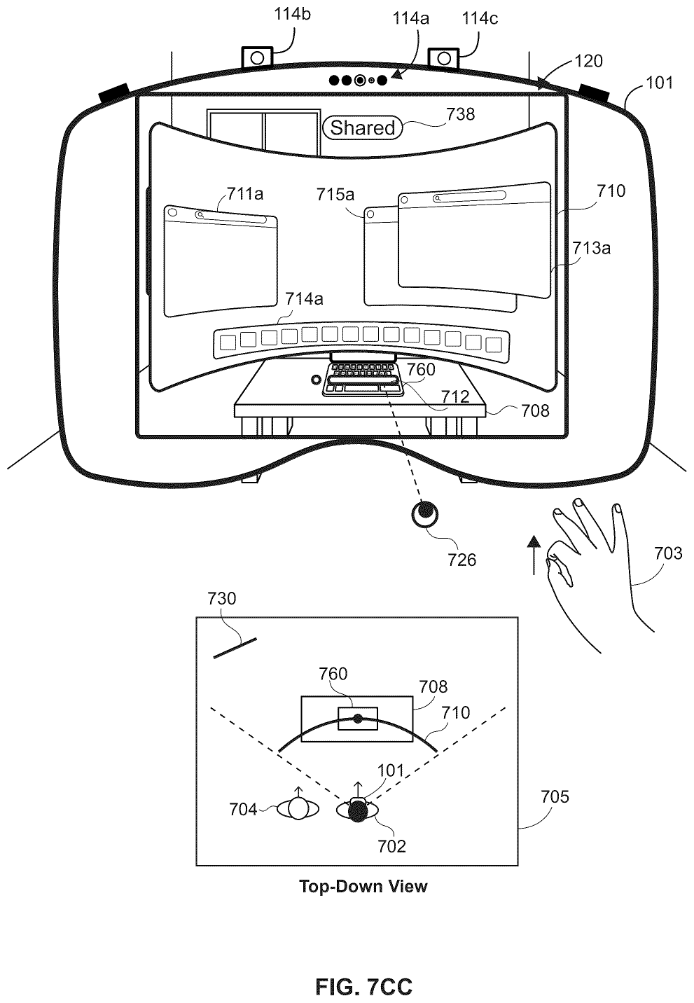

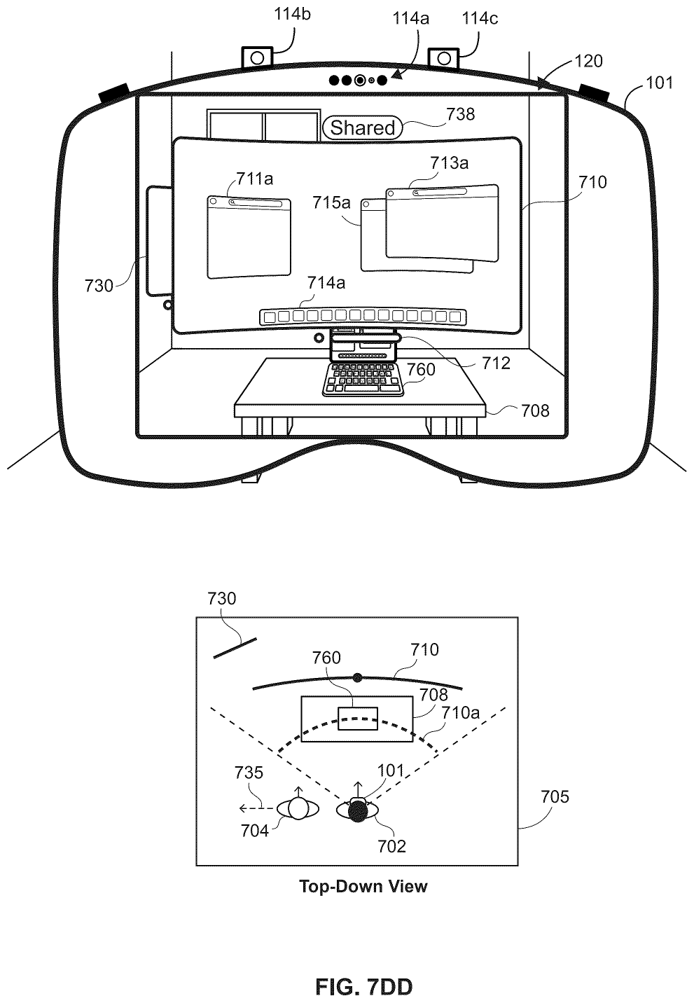

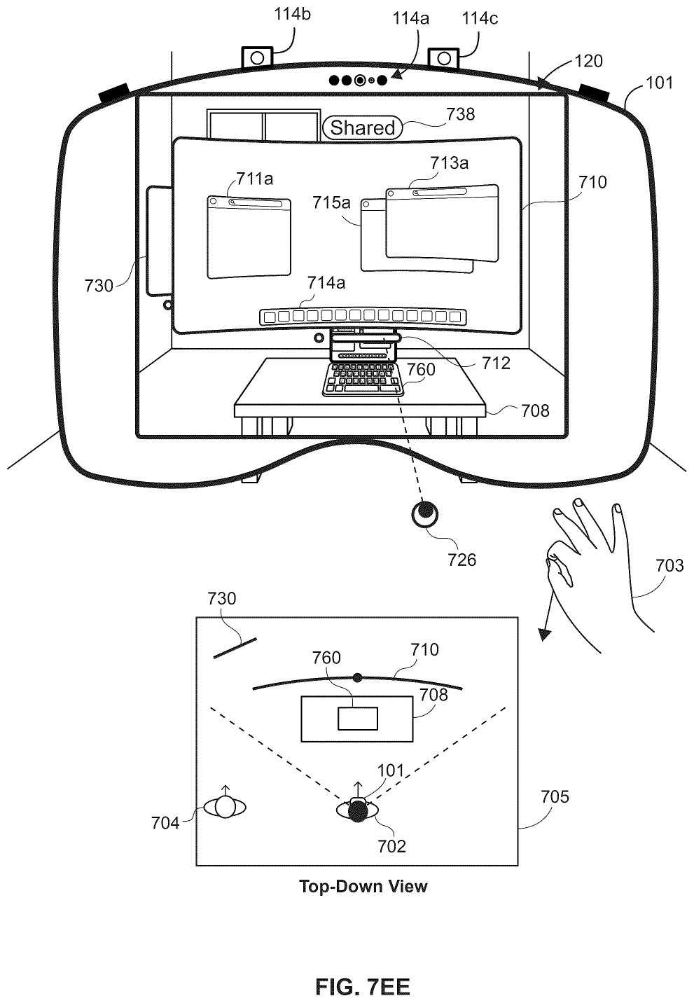

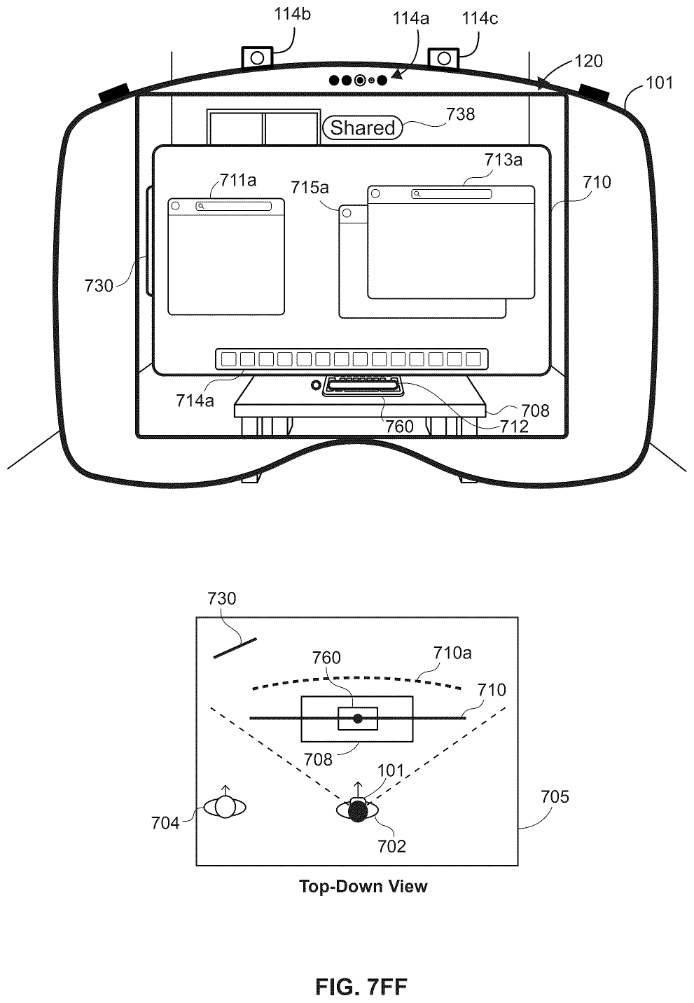

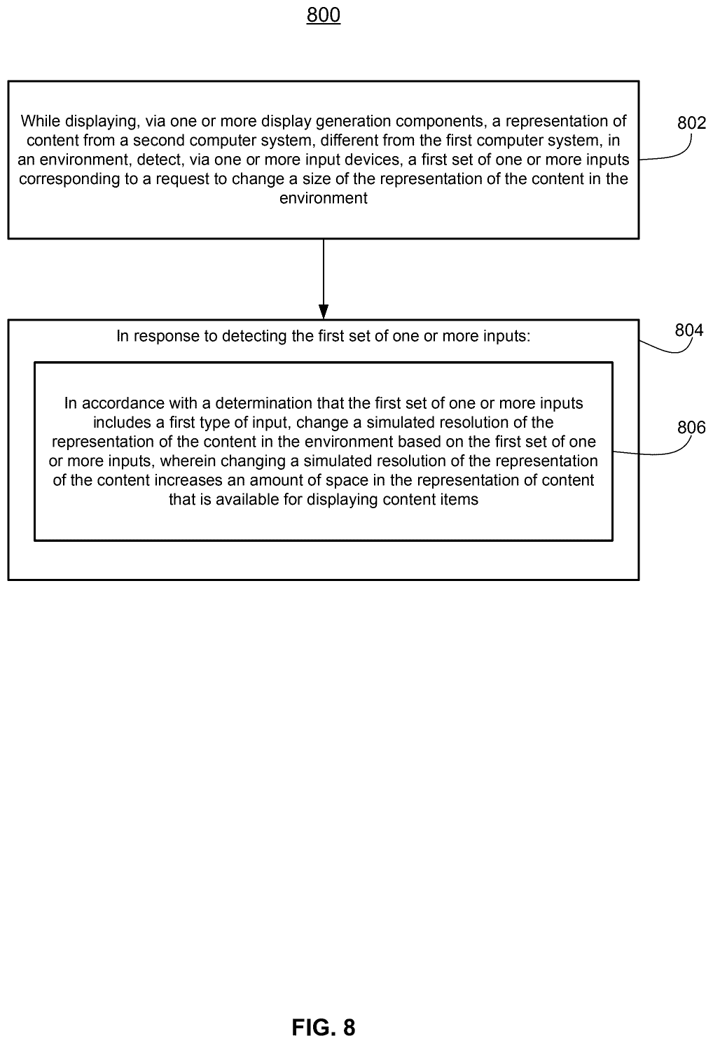

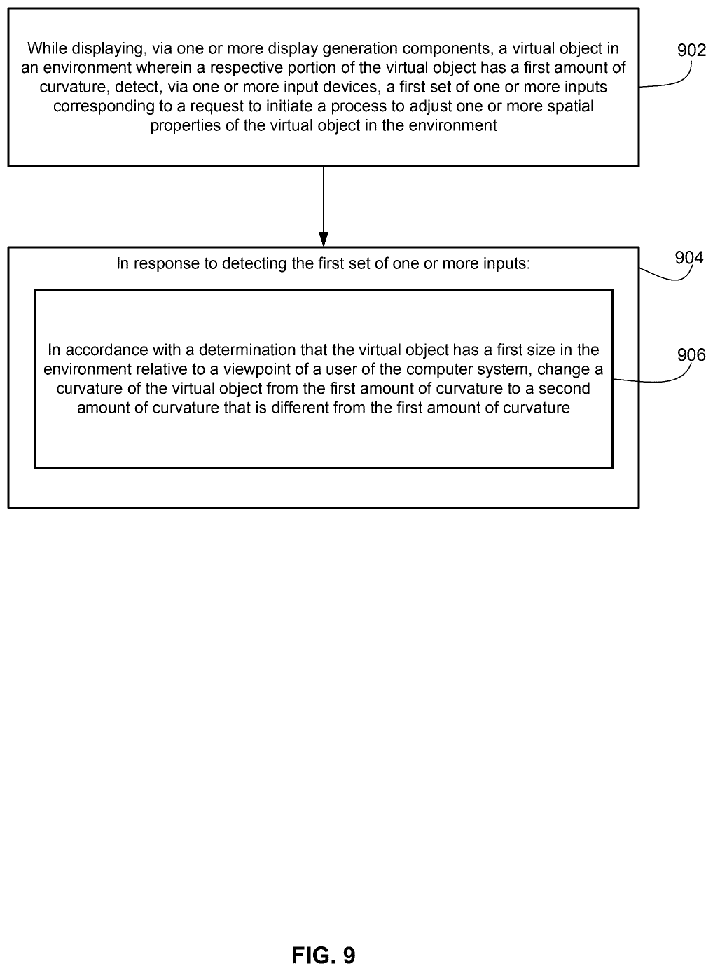

FIGS. 1A-6 provide a description of example computer systems for providing XR experiences to users (such as described below with respect to methods 800 and/or 900). FIGS. 7A-7FF illustrate examples of a computer system facilitating changing of a curvature of a virtual object when changing a simulated resolution of the virtual object in accordance with some embodiments. FIG. 8 is a flowchart illustrating an exemplary method of facilitating changing a simulated resolution of a virtual object in a three-dimensional environment in accordance with some embodiments. The user interfaces in FIGS. 7A-7FF are used to illustrate the processes in FIG. 8. FIG. 9 is a flowchart of methods of facilitating changing a curvature of a virtual object based on a size of the virtual object relative to a viewpoint of a user in a three-dimensional environment in accordance with some embodiments. The user interfaces in FIGS. 7A-7FF are used to illustrate the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

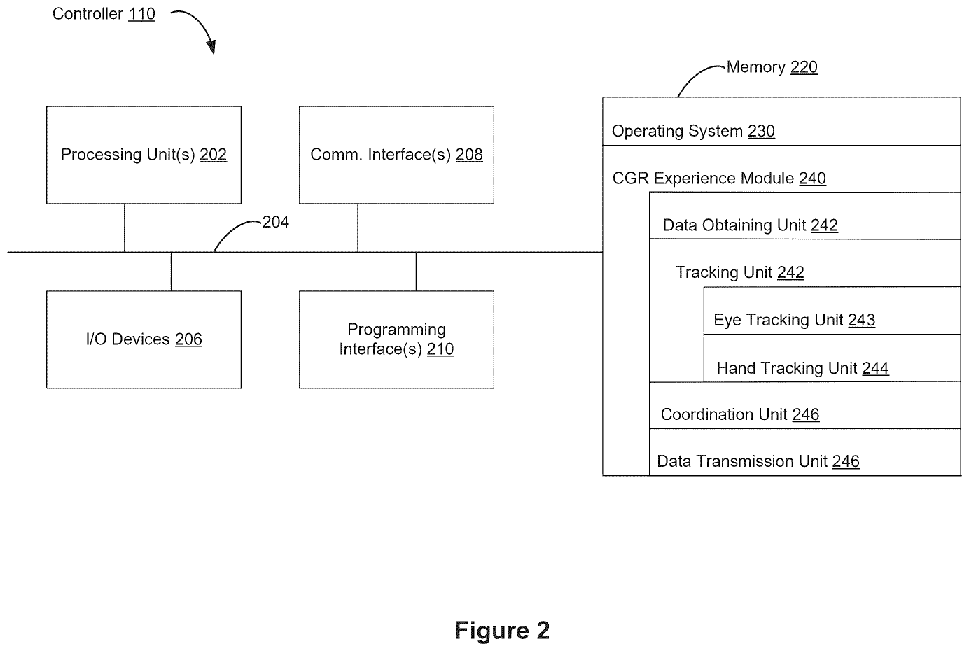

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

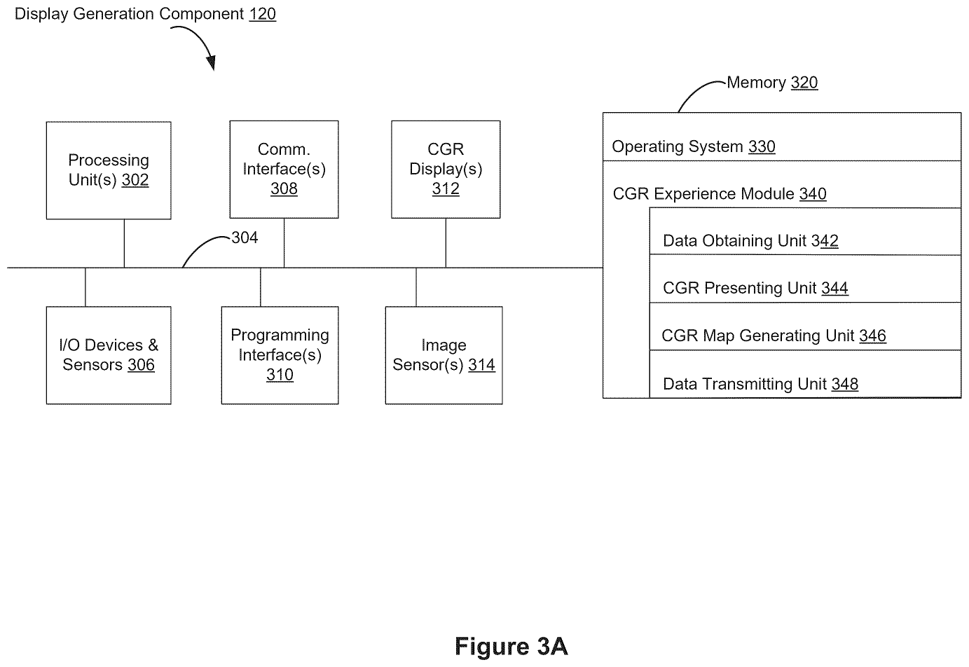

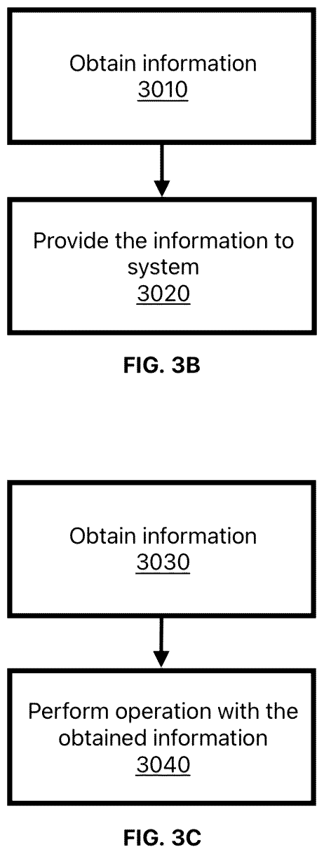

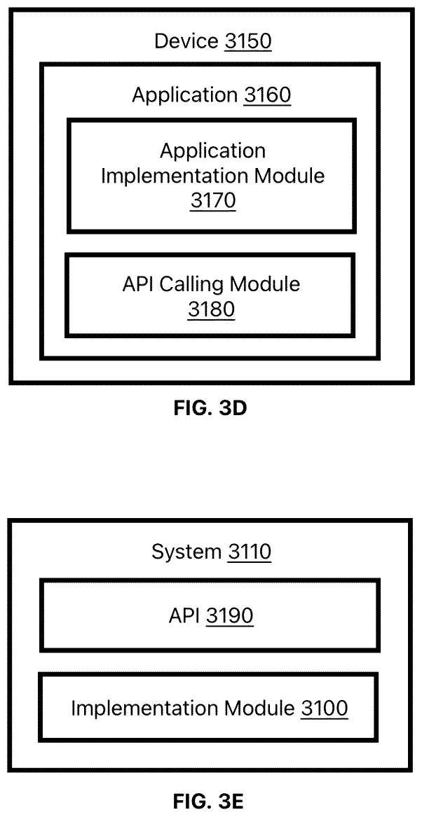

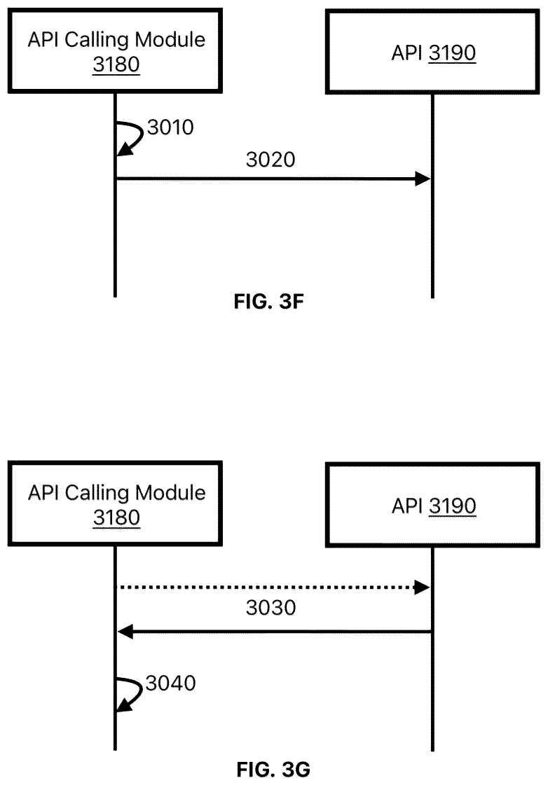

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, cither alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, cither alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, cither alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

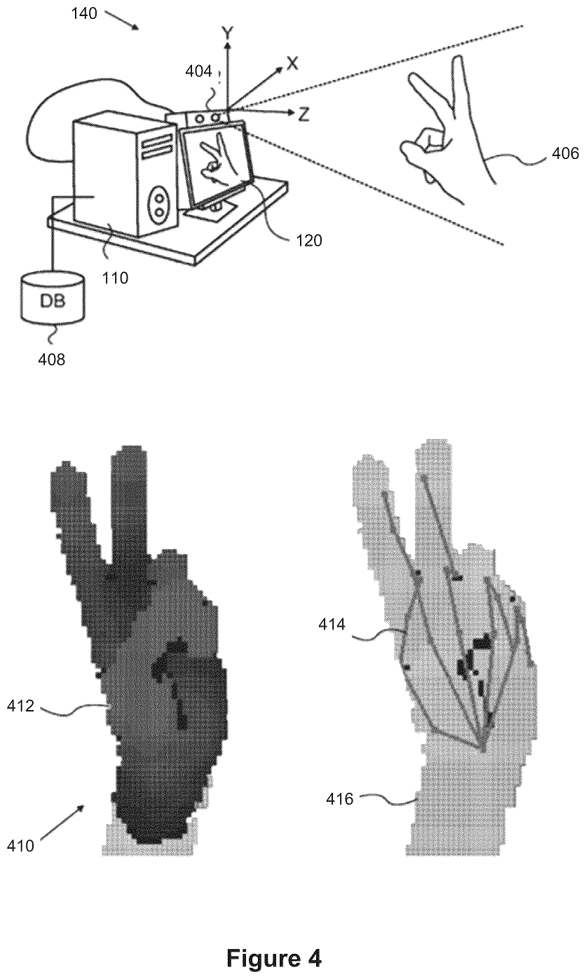

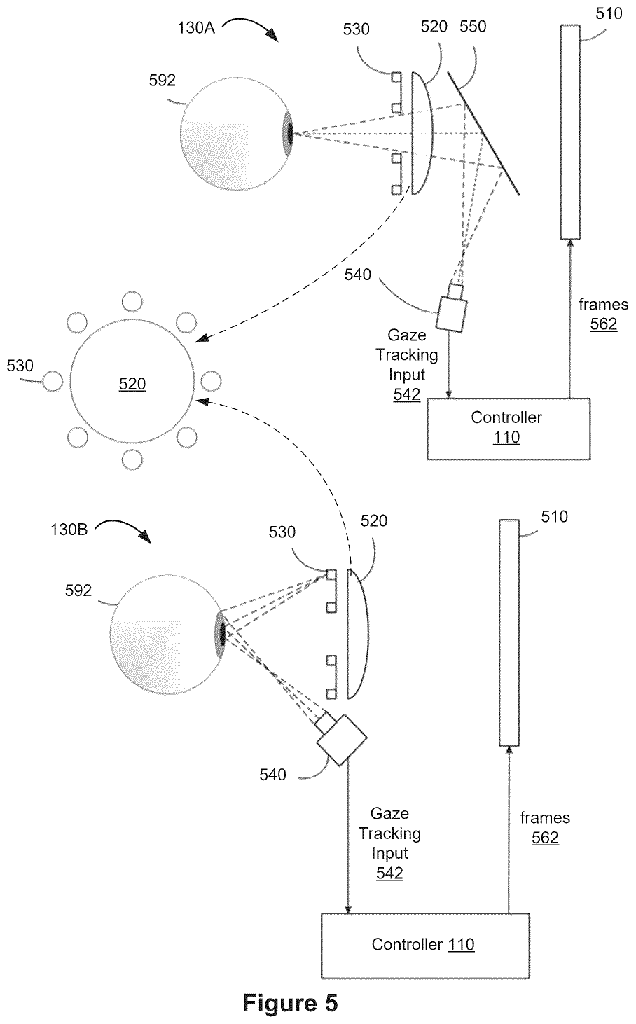

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on the device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API calling module to communicate with system 3110 via API 3190 (shown in FIG. 3E).

In some embodiments, API 3190 is a software module (e.g., a collection of computer-readable instructions) that provides an interface that allows a different module (e.g., API calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API calling module 3180. It should also be recognized that API calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform methods 800 and/or 900 (FIGS. 8 and/or 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

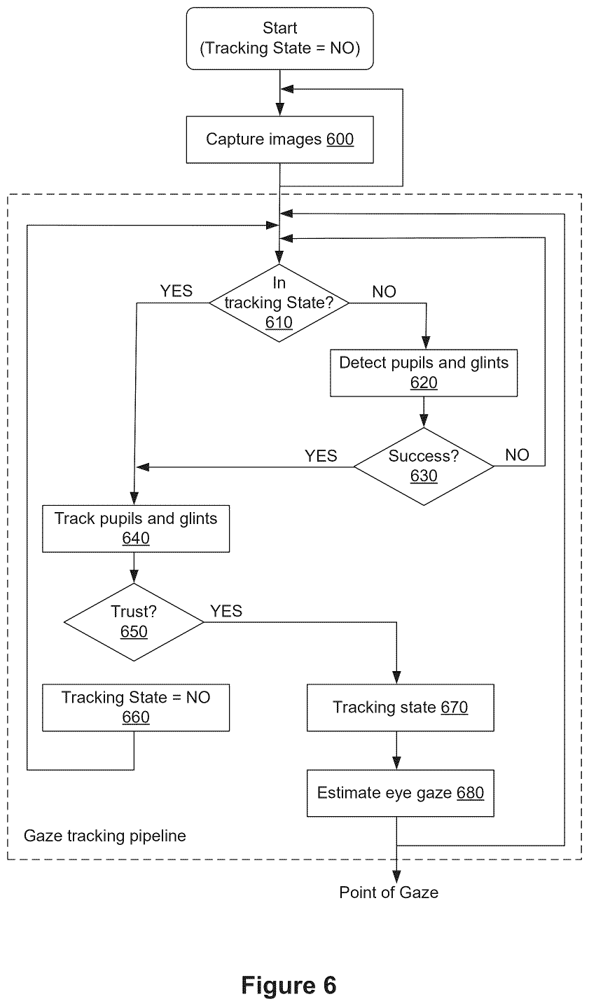

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7FF illustrate examples of a computer system facilitating changing of a curvature of a virtual object when changing a simulated resolution of the virtual object in accordance with some embodiments.

FIG. 7A illustrates a computer system 101 (e.g., an electronic device) displaying, via a display generation component (e.g., display generation component 120 of FIGS. 1 and 3), a three-dimensional environment 700 from a viewpoint of a user 702 in top-down view 705 (e.g., facing the back wall of the physical environment in which computer system 101 is located).

In some embodiments, computer system 101 includes a display generation component 120. In FIG. 7A, the computer system 101 includes one or more internal image sensors 114a oriented towards the face of the user 702 (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 700. For example, three-dimensional environment 700 includes a representation of a window 709, which is optionally a representation of a physical window in the physical environment, and a representation of a desk 708, which is optionally a representation of a physical desk 708 in the physical environment. As discussed in more detail below, as shown in FIG. 7A, the three-dimensional environment 700 optionally includes a representation of electronic device 760 (e.g., corresponding to a second computer system, such as a mobile electronic device, a laptop, a desktop, a tablet, and/or a smart television). In some embodiments, the computer system 101 is in communication with the electronic device 760.

As discussed in more detail below, in FIG. 7A, display generation component 120 is illustrated as displaying content in the three-dimensional environment 700. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 7A-7FF.

Display generation component 120 has a field of view (e.g., a field of view captured by external image sensors 114b and 114c and/or visible to the user via display generation component 120) that corresponds to the content shown in FIG. 7A. Because computer system 101 is optionally a head-mounted device, the field of view of display generation component 120 is optionally the same as or similar to the field of view of the user (e.g., indicated in the top-down view 705 in FIG. 7A).

As discussed herein, one or more air pinch gestures performed by a user (e.g., with hand 703) are detected by one or more input devices of computer system 101 and interpreted as one or more user inputs directed to content displayed by computer system 101. Additionally or alternatively, in some embodiments, the one or more user inputs interpreted by computer system 101 as being directed to content displayed by computer system 101 are detected via one or more hardware input devices (e.g., controllers) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

As mentioned above, the computer system 101 is configured to display content in the three-dimensional environment 700 using the display generation component 120. In FIG. 7A, three-dimensional environment 700 includes virtual objects 730 and 710. In some embodiments, the virtual object 730 is a user interface of an application containing content (e.g., a plurality of selectable options), three-dimensional objects (e.g., virtual clocks, virtual balls, virtual cars, etc.) or any other element displayed by computer system 101 that is not included in the physical environment of display generation component 120. For example, in FIG. 7A, the virtual object 730 is a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. It should be understood that the content discussed above is exemplary and that, in some embodiments, additional and/or alternative content and/or user interfaces are provided in the three-dimensional environment 700, such as the content described below with reference to methods 800 and/or 900.

Additionally, as mentioned above, the three-dimensional environment 700 includes the virtual object 710. In some embodiments, the virtual object 710 corresponds to a virtual instance of the content displayed by the electronic device 760 that is included in the physical environment (e.g., positioned on the desk 708 discussed above from the viewpoint of the user 702). For example, the virtual object 710 includes and/or is displaying a representation of content from the electronic device 760. As an example, in FIG. 7A, the electronic device 760 is displaying (e.g., via a display generation component of the electronic device 760) a plurality of user interfaces that is optionally visible in the three-dimensional environment 700 from the viewpoint of the user 702. As shown in FIG. 7A, the electronic device 760 is optionally displaying a dock 714 (e.g., including a plurality of selectable icons corresponding to applications, files, images, and/or folders on the electronic device 760), a first user interface 711, a second user interface 713, and a third user interface 715. In some embodiments, the first user interface 711, the second user interface 713, and the third user interface 715 are associated with one or more applications running on the electronic device 760 (e.g., a same application or different applications). For example, as shown in FIG. 7A, the first user interface 711, the second user interface 713, and the third user interface 715 correspond to different tabs and/or windows of a web-browsing application, though alternative types of user interfaces are possible, such as the user interfaces described with reference to methods 800 and/or 900. Accordingly, as shown in FIG. 7A, the virtual object 710 includes representations of the user interface(s) displayed by the electronic device 760, such as a representation of the dock 714a, a representation of the first user interface 711a, a representation of the second user interface 713a, and a representation of the third user interface 715a. It should be understood that, as discussed in more detail with reference to methods 800 and/or 900, the display of the content included in the virtual object 710 (e.g., the representation of the dock 714a and the representations of the first user interface 711a, the second user interface 713a, and the third user interface 715a) is optionally controlled by the electronic device 760 (e.g., based on data received by the computer system 101 from the electronic device 760). Additionally, it should be understood that, in some embodiments, the content of the electronic device 760 need not be visible in the three-dimensional environment 700 and/or need not be visibly displayed by the electronic device 760 (e.g., on a display generation component of the electronic device 760) while the computer system 101 is displaying the virtual object 710 that includes the content from the electronic device 760. For example, in FIG. 7A, the display generation component of the electronic device 760 is optionally off and/or is in a sleep state while the virtual object 710 is displayed in the three-dimensional environment 700. In some embodiments, the representation of the content from the electronic device 710 has a spatial arrangement in the virtual object 710 that is based on and/or that corresponds to a spatial arrangement of the content on the display generation component of the electronic device 760. For example, relative locations of the representations of the first user interface 711a, the second user interface 713a, and the third user interface 715a in the virtual object 710 correspond to relative locations of the first user interface 711, the second user interface 713, and the third user interface 715 on the electronic device 760. In some embodiments, the virtual object 710 is a different type of virtual object (e.g., different type of content) from the virtual object 730. For example, as described below, one or more behaviors of the virtual object 710 are not applied to the virtual object 730 in the three-dimensional environment 700. Additional details regarding providing and/or displaying a virtual instance of the content displayed by the electronic device 760 are provided below with reference to methods 800 and/or 900.

In some embodiments, as shown in FIG. 7A, the virtual objects 730 and 710 are displayed with movement elements 732 and 712 (e.g., grabber bars) in the three-dimensional environment 700. In some embodiments, the movement elements 732 and 712 are selectable to initiate movement of the corresponding virtual object within the three-dimensional environment 700 relative to the viewpoint of the user 702. For example, the movement element 732 that is associated with the virtual object 730 is selectable to initiate movement of the virtual object 730, and the movement element 712 that is associated with the virtual object 710 is selectable to initiate movement of the virtual object 710, within the three-dimensional environment 700.

In some embodiments, virtual objects are displayed in three-dimensional environment 700 at respective sizes relative to the viewpoint of user 702 (e.g., prior to receiving input interacting with the virtual objects, which will be described later, in three-dimensional environment 700). As shown in FIG. 7A, the virtual objects 730 and 710 optionally have first sizes in the three-dimensional environment 700 (e.g., corresponding to and/or based on the front-facing surfaces of the virtual objects 730 and 710 that face the viewpoint of user 702 relative to the viewpoint of user 702). It should be understood that the sizes of the virtual objects in FIG. 7A are merely exemplary and that other sizes are possible.

In some embodiments, virtual objects are displayed in three-dimensional environment 700 at respective locations relative to the viewpoint of user 702 (e.g., prior to receiving input interacting with the virtual objects, which will be described later, in three-dimensional environment 700). As shown in FIG. 7A, the virtual objects 730 and 710 are optionally displayed at first locations in the three-dimensional environment 700 (e.g., the virtual object 710 is displayed directly ahead of the viewpoint of the user 702 and the virtual object 730 is displayed to the left of the virtual object 710 and farther from the viewpoint of the user 702 than the virtual object 710 relative to the viewpoint of user 702). It should be understood that the locations of the virtual objects in FIG. 7A are merely exemplary and that other locations are possible.

In FIG. 7B, the computer system 101 detects attention of the user 702 (e.g., including gaze 726) directed to a respective portion of the virtual object 710 in the three-dimensional environment 700. For example, as shown in FIG. 7B, the computer system 101 detects the gaze 726 directed to a corner (e.g., bottom right corner) of the virtual object 710 in the three-dimensional environment 700. In some embodiments, as shown in FIG. 7B, in response to and/or while detecting the attention of the user 702 directed to the corner of the virtual object 710, the computer system 101 displays first resize element 718 in the three-dimensional environment 700. In some embodiments, as shown in FIG. 7B, the first resize element 718 is displayed at a location in the three-dimensional environment 700 from the viewpoint of the user 702 that corresponds to the corner to which the attention of the user 702 is directed. For example, as shown in FIG. 7B, the first resize element 718 is displayed adjacent to the bottom right corner of the virtual object 710 in the three-dimensional environment 700. Additionally, in some embodiments, as shown in FIG. 7B, when and/or while the first resize element 718 is displayed in the three-dimensional environment 700, the computer system 101 ceases display of the movement element 712 that is associated with the virtual object 710 in the three-dimensional environment 700.

In some embodiments, the first resize element 718 is selectable to initiate a process to change a size of the virtual object 710 in the three-dimensional environment 700 (e.g., relative to the viewpoint of the user 702). For example, interaction with the first resize element 718 causes the computer system 101 to change a scale of the virtual object 710, including the content of the virtual object 710, in the three-dimensional environment 700 from the viewpoint of the user 702. In FIG. 7C, the computer system 101 detects an input provided by hand 703 directed to the first resize element 718 in the three-dimensional environment 700. For example, as shown in FIG. 7C, the computer system 101 detects an air pinch gesture performed by the hand 703 (e.g., in which an index finger and thumb of the hand 703 come together to make contact), optionally while attention (e.g., including gaze 726) is directed to the first resize element 718 in the three-dimensional environment 700, followed by movement of the hand 703 in space relative to the viewpoint of the user 702. In some embodiments, as shown in FIG. 7C, the movement of the hand 703 is in a rightward direction relative to the viewpoint of the user 702 and with a respective magnitude (e.g., of speed and/or distance).

In some embodiments, as shown in FIG. 7D, in response to detecting the input directed to the first resize element 718 in the three-dimensional environment 700, the computer system 101 changes the size of the virtual object 710 in accordance with the input. For example, as shown in FIG. 7D, the computer system 101 increases the size of (e.g., scales up (e.g., to 120% scale, as indicated by indication 717)) the virtual object 710 in the three-dimensional environment 700 from the viewpoint of the user 702. In some embodiments, as shown in FIG. 7D, when the computer system 101 increases the size of the virtual object 710 in the three-dimensional environment 700, the computer system 101 increases the size of the content of the virtual object 710 in the three-dimensional environment 700 from the viewpoint of the user 702. For example, as shown in FIG. 7D, the computer system 101 increases the sizes of the representations of the first user interface 711a, the second user interface 713a, and the third user interface 715a in the three-dimensional environment (e.g., concurrently) by a same or similar amount that the size of the virtual object 710 is increased. In some embodiments, as shown in FIG. 7D, the computer system 101 changes the size of the virtual object 710 without updating display of the virtual object 730 and/or the content displayed on the electronic device 760 (e.g., the first user interface 711, the second user interface 713, and the third user interface 715). Additional details regarding scaling the virtual object 710 are provided below with reference to methods 800 and/or 900.

In FIG. 7E, the computer system 101 detects the attention of the user 702 (e.g., including the gaze 726) directed to a respective portion of the virtual object 710 in the three-dimensional environment 700. For example, as shown in FIG. 7E, the computer system 101 detects the gaze 726 directed to a side or edge (e.g., right side) of the virtual object 710 in the three-dimensional environment 700 from the viewpoint of the user 702. In some embodiments, as shown in FIG. 7E, in response to and/or while detecting the attention of the user 702 directed to the right side of the virtual object 710, the computer system 101 displays second resize element 720 in the three-dimensional environment 700. In some embodiments, as shown in FIG. 7E, the second resize element 720 is displayed at a location in the three-dimensional environment 700 from the viewpoint of the user 702 that corresponds to the side or edge to which the attention of the user 702 is directed. For example, as shown in FIG. 7E, the second resize element 720 is displayed adjacent to the right side of the virtual object 710 in the three-dimensional environment 700 from the viewpoint of the user 702. Additionally, in some embodiments, as shown in FIG. 7E, when and/or while the second resize element 720 is displayed in the three-dimensional environment 700, the computer system 101 ceases display of the movement element 712 that is associated with the virtual object 710 and the first resize element 718 discussed above in the three-dimensional environment 700.

In some embodiments, the second resize element 720 is selectable to initiate a process to change a simulated resolution of the virtual object 710 in the three-dimensional environment 700 (e.g., relative to the viewpoint of the user 702). For example, interaction with the second resize element 720 causes the computer system 101 to change an amount of space in the virtual object 710 that is available for displaying content, such as the amount of space available for displaying the representations of the first user interface 711a, the second user interface 713a, and/or the third user interface 715a or additional and/or alternative user interfaces, in the three-dimensional environment 700 from the viewpoint of the user 702. In FIG. 7F, the computer system 101 detects an input provided by hand 703 directed to the second resize element 720 in the three-dimensional environment 700. For example, as shown in FIG. 7F, the computer system 101 detects an air pinch gesture performed by the hand 703 (e.g., in which an index finger and thumb of the hand 703 come together to make contact), optionally while the attention (e.g., including the gaze 726) is directed to the second resize element 720 in the three-dimensional environment 700, followed by movement of the hand 703 in space relative to the viewpoint of the user 702. In some embodiments, as shown in FIG. 7F, the movement of the hand 703 is in a rightward direction relative to the viewpoint of the user 702 and with a respective magnitude (e.g., of speed and/or distance).

In some embodiments, as shown in FIG. 7G, in response to detecting the input directed to the second resize element 720 in the three-dimensional environment 700, the computer system 101 changes the simulated resolution of the virtual object 710 in accordance with the input. For example, as shown in FIG. 7G, the computer system 101 increases the amount of space in the virtual object 710 that is available for displaying content in the three-dimensional environment 700 from the viewpoint of the user 702. In some embodiments, as shown in FIG. 7G, the computer system 101 changes the simulated resolution of the virtual object 710 without scaling the virtual object 710 (e.g., including the content of the virtual object 710) in the three-dimensional environment 700. For example, as shown in FIG. 7G, the computer system 101 forgoes changing the sizes of the representation of the dock 714a and the representations of the first user interface 711a, the second user interface 713a, and the third user interface 715a in response to detecting the input for changing the simulated resolution of the virtual object 710 in the three-dimensional environment 700. Similarly, as shown in FIG. 7G, the computer system 101 changes the simulated resolution of the virtual object 710 without moving the virtual object 710 and/or the content of the virtual object 710 in the three-dimensional environment 700 relative to the viewpoint of the user 702. For example, from FIG. 7F to FIG. 7G, the computer system 101 maintains the locations of the representation of the dock 714a and the representations of the first user interface 711a, the second user interface 713a, and the third user interface 715a in the virtual object 710 from the viewpoint of the user 702. In some embodiments, as shown in FIG. 7G, changing the simulated resolution of the virtual object 710 in the three-dimensional environment 700 includes changing an aspect ratio of the virtual object 710. For example, in FIG. 7G, the computer system 101 increases the aspect ratio of the virtual object 710 in response to detecting the input provided by the hand 703. Additional details regarding changing the simulated resolution of the virtual object 710 are provided below with reference to methods 800 and/or 900.

In some embodiments, as shown in FIG. 7G, when the computer system 101 changes (e.g., increases) the simulated resolution of the virtual object 710 in the three-dimensional environment 700, the computer system 101 changes (e.g., increases) a curvature of the virtual object 710 in the three-dimensional environment 700 from the viewpoint of the user 702, as indicated in the top-down view 705. For example, as illustrated in the top-down view 705 in FIG. 7G, the computer system 101 increases the curvature of the front-facing surface of the virtual object 710 in the three-dimensional environment 700, such that the front-facing surface of the virtual object 710 visually transitions from appearing flat relative to the viewpoint of the user 702, as indicated by dashed line 710a, to appearing curved relative to the viewpoint of the user 702. In some embodiments, the computer system 101 changes the curvature of the virtual object 710 based on the size of the virtual object 710 in the three-dimensional environment 700 relative to the viewpoint of the user 702 (e.g., the size of the virtual object 710 when the input provided by the hand 703 is detected). Additionally, in some embodiments, changing the curvature of the virtual object 710 in the three-dimensional environment 700 includes changing a curvature of the content of the virtual object 710. For example, as shown in FIG. 7G, the computer system 101 increases the curvatures of the representation of the dock 714a and the representations of the first user interface 711a, the second user interface 713a, and the third user interface 715a when the amount of curvature of the surface (e.g., on which the representations are displayed) is increased in the three-dimensional environment 700. In some embodiments, as shown in FIG. 7G, the computer system 101 changes the curvature of the virtual object 710 without updating display of the virtual object 730 and/or the content displayed on the electronic device 760 (e.g., the first user interface 711, the second user interface 713, and the third user interface 715). In some embodiments, the surface of the virtual object 710 has and/or is displayed with a simulated three-dimensional material (e.g., a simulated surface material, such as virtual laminate, glass, or coating). In some embodiments, when the computer system 101 changes the curvature of the virtual object 710 in the manner discussed above, the computer system 101 deforms the simulated three-dimensional material on the surface of the virtual object 710 to enable the edges/sides and/or corners of the virtual object 710 to visually appear to be smooth in three-dimensional environment 700 from the viewpoint of the user 702. Additional details regarding changing the curvature of the virtual object 710 are provided below with reference to methods 800 and/or 900.

In FIG. 7G, the computer system 101 detects movement of the attention of the user 702 (e.g., including the gaze 726) to a different respective portion of the virtual object 710 in the three-dimensional environment 700. For example, as shown in FIG. 7G, the computer system 101 detects the gaze 726 directed to an opposite side or edge (e.g., left side) of the virtual object 710 than in FIG. 7F in the three-dimensional environment 700 from the viewpoint of the user 702. In some embodiments, as shown in FIG. 7G, in response to and/or while detecting the attention of the user 702 directed to the left side of the virtual object 710, the computer system 101 redisplays and/or moves the second resize element 720 in the three-dimensional environment 700 based on the updated location of the attention of the user 702. For example, as shown in FIG. 7G, the second resize element 720 is redisplayed at a location in the three-dimensional environment 700 from the viewpoint of the user 702 that corresponds to the left side of the virtual object 710 to which the attention of the user 702 is directed.

In FIG. 7H, the computer system 101 detects an input provided by hand 703 directed to the second resize element 720 in the three-dimensional environment 700. For example, as shown in FIG. 7H, the computer system 101 detects an air pinch gesture performed by the hand 703 (e.g., in which an index finger and thumb of the hand 703 come together to make contact), optionally while the attention (e.g., including the gaze 726) is directed to the second resize element 720 in the three-dimensional environment 700, followed by movement of the hand 703 in space relative to the viewpoint of the user 702. In some embodiments, as shown in FIG. 7H, the movement of the hand 703 is in a leftward direction relative to the viewpoint of the user 702 and with a respective magnitude (e.g., of speed and/or distance).

In some embodiments, in response to detecting the input provided by the hand 703 directed to the second resize element 720, the computer system 101 gradually changes the simulated resolution of the virtual object 710 in accordance with the input, as illustrated from FIG. 7H to FIG. 7J. For example, as mentioned above, the computer system 101 optionally detects the movement of the hand 703 of the user 702 that is in a leftward direction relative to the viewpoint of the user and that has a respective magnitude (e.g., of speed and/or direction). In some embodiments, the computer system 101 increases the simulated resolution of the virtual object 710 based on and/or in accordance with the magnitude of the movement of the hand 703 (e.g., such that the simulated resolution of the virtual object 710 is increased directly with and/or proportionally to the magnitude of the movement of the hand 703). Similarly, in some embodiments, in response to detecting the input provided by the hand 703, the computer system 101 gradually changes the curvature of the virtual object 710 in accordance with the input, as illustrated from FIG. 7H to FIG. 7J. For example, the computer system 101 increases the curvature of the virtual object 710 based on and/or in accordance with the magnitude of the movement of the hand 703 (e.g., due to the increased aspect ratio of the virtual object 710 as a result of the increased simulated resolution).

In some embodiments, while the simulated resolution and/or the curvature of the virtual object 710 is updated in accordance with the input provided by the hand 703 from FIG. 7H to FIG. 7J, the computer system 101 reduces a visual fidelity of the virtual object 710 in the three-dimensional environment 700. For example, as shown in FIG. 7G, while detecting the movement of the hand 703, the computer system 101 applies a visual effect to the content of the virtual object 710 in the three-dimensional environment 700, such that the content of the virtual object 710 (e.g., the representation of the dock 714a and/or the representations of the first user interface 711a, the second user interface 713a, and/or the third user interface 715a) is faded out, reduced in brightness and/or saturation, increased in transparency, and/or decreased in color.

In some embodiments, as shown in FIG. 7J, in response to detecting termination of the input provided by the hand 703 discussed above (e.g., the input detected in FIG. 7H), such as a release of the air pinch and drag gesture provided by the hand 703, the computer system 101 increases the visual fidelity of the virtual object 710 in the three-dimensional environment 700. For example, as shown in FIG. 7J, after increasing the simulated resolution and/or the curvature of the virtual object 710 in the three-dimensional environment 700, as indicated by the dashed line 710a, the computer system 101 reverses the application of the visual effect discussed above to the content of the virtual object 710 in the three-dimensional environment 700, such that the content of the virtual object 710 (e.g., the representation of the dock 714a and/or the representations of the first user interface 711a, the second user interface 713a, and/or the third user interface 715a) is faded back in, increased in brightness and/or saturation, decreased in transparency, and/or increased in color.

In FIG. 7J, the computer system 101 detects an input provided by the hand 703 corresponding to a request to move the representation of the first user interface 711a in the virtual object 710 (e.g., within the virtual instance of the content displayed by the electronic device 760) in the three-dimensional environment 700. For example, as shown in FIG. 7J, the computer system 101 detects an air pinch and drag gesture performed by the hand 703, optionally while the attention (e.g., including gaze 726) of the user 702 is directed to (e.g., a top portion of) the representation of the first user interface 711a in the virtual object 710. In some embodiments, as shown in FIG. 7J, the movement of the hand 703 relative to the viewpoint of the user 702 corresponds to a request to move the representation of the first user interface 711a leftward in the virtual object 710 relative to the viewpoint of the user 702.

In some embodiments, as shown in FIG. 7K, in response to detecting the input provided by the hand 703, the computer system 101 moves the representation of the first user interface 711a in the virtual object 710 in accordance with the input. For example, as shown in FIG. 7K, the computer system 101 moves the representation of the first user interface 711a leftward on the surface of the virtual object 710 (e.g., to an area/region of the virtual object 710 in which content is able to be displayed as a result of the current simulated resolution) in accordance with the leftward movement of the hand 703 relative to the viewpoint of the user 702. In some embodiments, as shown in FIG. 7K, when the computer system 101 moves the representation of the first user interface 711a in the virtual object 710, the computer system 101 causes the electronic device 760 to move the first user interface 711 that is displayed via the display generation component of the electronic device 760. For example, the computer system 101 transmits data and/or instructions to the electronic device 760 in response to detecting the input directed to the representation of the first user interface 711a that causes the electronic device 760 to move the first user interface 711 in a same or similar manner as the movement of the representation of the first user interface 711a.

In FIG. 7L, the computer system 101 detects an input provided by the hand 703 corresponding to selection of the virtual object 710 in the three-dimensional environment. For example, as shown in FIG. 7L, the computer system 101 detects an air pinch gesture performed by the hand 703, optionally while the attention (e.g., including the gaze 726) of the user 702 is directed to a portion of the virtual object 710 (optionally a portion that does not include content) in the three-dimensional environment.

In some embodiments, in FIG. 7L, the computer system 101 detects an input provided by the hand 703 corresponding to selection of user interface object 728 that is displayed with the virtual object 710 in the three-dimensional environment 700. For example, as shown in FIG. 7L, the computer system 101 detects an air pinch gesture performed by the hand 703, optionally while the attention (e.g., including the gaze 726) of the user 702 is directed to the user interface object 728 in the three-dimensional environment 700. In some embodiments, the user interface object 728 is selectable to display a menu that includes a plurality of selectable options for changing the aspect ratio of the virtual object 710, as described in more detail below. In some embodiments, the user interface object includes a visual indication that indicates the virtual object 710 corresponds to a virtual instance of the content displayed by the electronic device 760 that is included in the physical environment. For example, as shown in FIG. 7L, the user interface object includes a text label “Virtual Display” visually indicating that the virtual object 710 includes a virtual representation of the content (e.g., user interfaces 711-715) from the electronic device 760. In some embodiments, as described in more detail with reference to method 800, the user interface object is displayed relative to the virtual object 710 in the three-dimensional environment 700 from the viewpoint of the user 702. For example, as shown in FIG. 7L, the computer system 101 displays the user interface object 728 at a location in the three-dimensional environment 700 that is based on a location of the virtual object 710 from the viewpoint of the user 702, such as above the virtual object 710 in the three-dimensional environment 700. Additionally, in some embodiments, as described in more detail with reference to method 800, the computer system 101 moves the user interface object 728 as the virtual object 710 is moved in the three-dimensional environment 700 from the viewpoint of the user 702 (e.g., in response to movement input directed to the virtual object 710 and/or movement of the viewpoint of the user 702 as described herein). In some embodiments, when there is a separate user interface object (e.g., user interface object 728) to initiate a process for changing a size and/or aspect ratio of virtual object 710, inputs directed to virtual object 710 do not initiate a process for changing a size and/or aspect ratio of virtual object 710 (and, optionally performs a different operation like visually emphasizing virtual object 710, bringing virtual object 710 to the foreground, and/or moving input focus to virtual object 710). Additionally, while a separate user interface object (e.g., user interface object 728) to initiate a process for changing a size and/or aspect ratio of virtual object 710 is shown in FIGS. 7L and 7M and is not shown in other figures that include virtual object 710, it should be understood that, in some embodiments, the same or similar object (optionally, with the same or similar functionality) is, in some embodiments, displayed along with virtual object 710 in other situations such as those illustrated in FIGS. 7A-7K and 7N-7FF.

In some embodiments, as shown in FIG. 7M, in response to detecting the selection of the virtual object 710 or the selection of the user interface object 728, the computer system 101 displays menu 722 in the three-dimensional environment 700 (e.g., overlaid on a top portion of the virtual object 710 in the three-dimensional environment from the viewpoint of the user 702). In some embodiments, the menu 722 is associated with the virtual object 710 and includes a plurality of selectable options for changing the aspect ratio of the virtual object 710 in the three-dimensional environment. For example, as shown in FIG. 7M, the menu 722 includes a first option 723a that is selectable to display the virtual object 710 at a first aspect ratio (e.g., standard aspect ratio), a second option 723b that is selectable to display the virtual object 710 at a second aspect ratio (e.g., wide aspect ratio), greater than the first aspect ratio, and a third option 723c that is selectable to display the virtual object 710 at a third aspect ratio (e.g., ultrawide aspect ratio), greater than the first and the second aspect ratios, in the three-dimensional environment 700. In some embodiments, as similarly discussed above, changing the aspect ratio includes and/or causes changing the simulated resolution of the virtual object 710 and/or the curvature of the virtual object 710 in the three-dimensional environment 700. In some embodiments, as shown in FIG. 7M, when the computer system 101 displays the menu 722 in the three-dimensional environment 700, the computer system 101 maintains display of the user interface object 728 with the virtual object 710 in the three-dimensional environment 710 (e.g., in response to detecting the selection of the user interface object 728). Alternatively, in some embodiments, when the computer system 101 displays the menu 722 in the three-dimensional environment 700, the computer system 101 ceases display of the user interface object 728 in the three-dimensional environment 700 (e.g., the computer system 101 replaces display of the user interface object 728 with the menu 722 in the three-dimensional environment 700). In some embodiments, the computer system 101 maintains display of the user interface object 728 for different aspect ratios and/or different simulated resolutions of the virtual object 710.

In FIG. 7M, while displaying the menu 722 in the three-dimensional environment 700, the computer system 101 detects an input corresponding to a selection of a respective option of the plurality of options in the menu 722. For example, as shown in FIG. 7M, the computer system 101 detects the hand 703 perform an air pinch gesture while the attention (e.g., including the gaze 726) of the user 702 is directed to the second option 723b in the menu 722. Alternatively, in some embodiments, the computer system 101 detects the air pinch gesture performed by the hand 703 while the attention (e.g., including the gaze 726) of the user 702 is directed to the first option 723a in the menu 722. It should be understood that, while multiple gaze points are illustrated in FIG. 7M, such gaze points need not be detected by the computer system 101 concurrently; rather, in some embodiments, the computer system 101 independently responds to the gaze points illustrated and described in response to detecting such gaze points independently.

In some embodiments, as shown in FIG. 7N, in response to detecting the selection of the second option 723b in the menu 722, the computer system 101 changes the aspect ratio of the virtual object 710 according to a value corresponding to the second option 723b. For example, as indicated by indication 724, the computer system 101 changes the aspect ratio of the virtual object 710 to have the wide aspect ratio designated by the second option 723b (e.g., a discrete value of the aspect ratio). In some embodiments, as shown in FIG. 7N, because the aspect ratio is decreased from FIG. 7M to FIG. 7N in response to detecting the selection of the second option 723b, the computer system 101 changes the curvature of the virtual object 710 (e.g., based on the updated size of the virtual object 710 relative to the viewpoint of the user 702) in the three-dimensional environment 700. For example, as illustrated in the top-down view 705 in FIG. 7N, the computer system 101 decreases the curvature of the virtual object 710 in the three-dimensional environment, as indicated by the dashed line 710a. Alternatively, in some embodiments, in response to detecting the selection of the first option 723a in the menu 722, the computer system 101 changes the aspect ratio of the virtual object 710 according to a value corresponding to the first option 723a. For example, the computer system 101 changes the aspect ratio of the virtual object 710 to have the standard aspect ratio designated by the first option 723a, such as the aspect ratio of the virtual object 710 in FIG. 7A.

In FIG. 7N, the computer system 101 detects an input provided by the hand 703 corresponding to a request to move the representation of the second user interface 713a in the virtual object 710 (e.g., within the virtual instance of the content displayed by the electronic device 760) in the three-dimensional environment 700. For example, as shown in FIG. 7N, the computer system 101 detects an air pinch and drag gesture performed by the hand 703, optionally while the attention (e.g., including gaze 726) of the user 702 is directed to (e.g., a top portion of) the representation of the second user interface 713a in the virtual object 710. In some embodiments, as shown in FIG. 7N, the movement of the hand 703 relative to the viewpoint of the user 702 corresponds to a request to move the representation of the second user interface 713a rightward in the virtual object 710 relative to the viewpoint of the user 702.

In some embodiments, as shown in FIG. 7O, in response to detecting the input provided by the hand 703, the computer system 101 moves the representation of the second user interface 713a in the virtual object 710 in accordance with the input. For example, as shown in FIG. 7O, the computer system 101 moves the representation of the second user interface 713a rightward on the surface of the virtual object 710 (e.g., to an area/region of the virtual object 710 in which content is able to be displayed as a result of the current simulated resolution) in accordance with the rightward movement of the hand 703 relative to the viewpoint of the user 702. In some embodiments, as shown in FIG. 7O and as similarly discussed above, when the computer system 101 moves the representation of the second user interface 713a in the virtual object 710, the computer system 101 causes the electronic device 760 to move the second user interface 713 that is displayed via the display generation component of the electronic device 760. For example, the computer system 101 transmits data and/or instructions to the electronic device 760 in response to detecting the input directed to the representation of the second user interface 713a that causes the electronic device 760 to move the second user interface 713 in a same or similar manner as the movement of the representation of the second user interface 713a.

In FIG. 7O, the computer system 101 detects an input provided by the hand 703 corresponding to a double selection of the virtual object 710 in the three-dimensional environment 700. For example, as shown in FIG. 7O, the computer system 101 detects two air pinch gestures performed by the hand 703 (e.g., in rapid succession), optionally while the attention (e.g., including the gaze 726) of the user 702 is directed to a portion of the virtual object 710 (optionally a portion that does not include content) in the three-dimensional environment 700.

In some embodiments, as shown in FIG. 7P, in response to detecting the double selection input directed to the virtual object 710, the computer system 101 resets a scale of the virtual object 710 in the three-dimensional environment 700 from the viewpoint of the user 702. For example, as shown in FIG. 7P, the size of the virtual object 710 decreases in the three-dimensional environment to a respective (e.g., default) scale value (e.g., 100% scale), as indicated by indication 717. In some embodiments, the curvature of the virtual object 710 is based on an amount of a field of view of the user 702 that is occupied by the virtual object 710 from the viewpoint of the user 702. Accordingly, in some embodiments, as indicated in the top-down view 705 in FIG. 7P, because resetting the scale of the virtual object 710 causes the virtual object 710 to occupy a smaller amount of the field of view of the user 702 in the three-dimensional environment 700 than in FIG. 7O, the computer system changes (e.g., decreases) the curvature of the virtual object 710 due to the decreased size of the virtual object 710 relative to the viewpoint of the user 702 in the three-dimensional environment 700. Additionally, in some embodiments, resetting the scale of the virtual object 710 includes resetting a scale of the content of the virtual object 710 in the three-dimensional environment 700. For example, as shown in FIG. 7P, the computer system 101 rescales the content of the virtual object 710 (e.g., the representation of the dock 714a and the representations of the first user interface 711a, the second user interface 713a, and the third user interface 715a) to the respective scale value (e.g., 100% scale), such that the size of the content is decreased in the three-dimensional environment from the viewpoint of the user 702.

In FIG. 7P, the computer system 101 detects an input corresponding to a request to increase the size of the virtual object 710 in the three-dimensional environment 700. For example, as shown in FIG. 7P, the computer system 101 (e.g., concurrently) detects a first hand 707 of the user 702 perform an air pinch gesture and a second hand 703 (e.g., corresponding to the hand 703 discussed above) of the user 702 perform an air pinch gesture, optionally while the attention (e.g., including gaze 726) of the user 702 is directed to a portion of the virtual object 710. In some embodiments, as shown in FIG. 7P, after detecting the air pinch gestures performed by the first hand 707 and the second hand 703 of the user 702, the computer system 101 detects movement of one or both of the first hand 707 and the second hand 703. For example, the computer system 101 detects the first hand 707 and/or the second hand 703 move farther apart from each other relative to the viewpoint of the user 702.

In some embodiments, as shown in FIG. 7Q, in response to detecting the movement of the first hand 707 and/or the second hand 703 (e.g., after detecting the air pinch gestures provided by the first hand 707 and the second hand 703), the computer system 101 increases the size of the virtual object 710 in the three-dimensional environment 700. For example, as indicated by indication 717 in FIG. 7Q, the computer system 101 increases the scale of the virtual object 710 (e.g., to 110% scale), including the content of the virtual object 710 (e.g., the representation of the dock 714a and the representations of the first user interface 711a, the second user interface 713a, and the third user interface 715a), in accordance with and/or based on the movement of the first hand 707 and/or the second hand 703. Additionally, in some embodiments, as shown in FIG. 7Q, increasing the size (e.g., scale) of the virtual object 710 causes a greater amount of the field of view of the user 702 to be occupied by the virtual object 710 than in FIG. 7P, which causes the computer system 101 to increase the curvature of the virtual object 710, as indicated in the top-down view 705.

In FIG. 7Q, the computer system 101 detects further movement of the first hand 707 and/or the second hand 703 of the user 702 relative to the viewpoint of the user 702. For example, as shown in FIG. 7Q, while the first hand 707 and the second hand 703 are maintaining the air pinch gestures provided in FIG. 7P, the computer system 101 detects the first hand 707 and/or the second hand 703 move farther apart relative to the viewpoint of the user 702.

In some embodiments, as shown in FIG. 7R, in response to detecting the further movement of the first hand 707 and/or the second hand 703 (e.g., after detecting the air pinch gestures provided by the first hand 707 and the second hand 703 in FIG. 7P), the computer system 101 further increases the size of the virtual object 710 in the three-dimensional environment 700. For example, as indicated by indication 717 in FIG. 7Q, the computer system 101 further increases the scale of the virtual object 710 (e.g., to 140% scale), including the content of the virtual object 710 (e.g., the representation of the dock 714a and the representations of the first user interface 711a, the second user interface 713a, and the third user interface 715a), in accordance with and/or based on the further movement of the first hand 707 and/or the second hand 703. Additionally, in some embodiments, as shown in FIG. 7R, increasing the size (e.g., scale) of the virtual object 710 causes a greater amount of the field of view of the user 702 to be occupied by the virtual object 710 than in FIG. 7Q, which causes the computer system 101 to further increase the curvature of the virtual object 710, as indicated in the top-down view 705.

In FIG. 7R, the computer system 101 detects an input corresponding to a request to decrease the size of the virtual object 710 in the three-dimensional environment 700. For example, as shown in FIG. 7R, the computer system 101 (e.g., concurrently) detects the first hand 707 of the user 702 perform an air pinch gesture and the second hand 703 of the user 702 perform an air pinch gesture, optionally while the attention (e.g., including gaze 726) of the user 702 is directed to a portion of the virtual object 710 in the three-dimensional environment 700. In some embodiments, as shown in FIG. 7R, after detecting the air pinch gestures performed by the first hand 707 and the second hand 703 of the user 702, the computer system 101 detects movement of one or both of the first hand 707 and the second hand 703. For example, the computer system 101 detects the first hand 707 and/or the second hand 703 move closer together relative to the viewpoint of the user 702.

In some embodiments, as shown in FIG. 7S, in response to detecting the movement of the first hand 707 and/or the second hand 703 (e.g., while continuing to detect the air pinch gestures provided by the first hand 707 and the second hand 703), the computer system 101 decreases the size of the virtual object 710 in the three-dimensional environment 700. For example, as indicated by indication 717 in FIG. 7S, the computer system 101 decreases the scale of the virtual object 710 (e.g., to 90% scale), including the content of the virtual object 710 (e.g., the representation of the dock 714a and the representations of the first user interface 711a, the second user interface 713a, and the third user interface 715a), in accordance with and/or based on the movement of the first hand 707 and/or the second hand 703. Additionally, in some embodiments, as shown in FIG. 7S, decreasing the size (e.g., scale) of the virtual object 710 causes a smaller amount of the field of view of the user 702 to be occupied by the virtual object 710 than in FIG. 7R, which causes the computer system 101 to decrease the curvature of the virtual object 710, as indicated in the top-down view 705. In some embodiments, as similarly discussed above, while detecting the inputs provided by the first hand 707 and the second hand 703 (e.g., while decreasing the size of the virtual object 710 in the three-dimensional environment 700), the computer system 101 reduces the visual fidelity of the virtual object 710.

In some embodiments, the computer system 101 changes the curvature of the virtual object 710 non-linearly in the three-dimensional environment 700 when and/or as the size (e.g., scale) of the virtual object 710 is reduced in the three-dimensional environment 700 as discussed above. For example, from FIG. 7R to FIG. 7S, as the computer system 101 reduces the scale of the virtual object 710 from 140% scale down to 90% scale, the computer system 101 decreases the curvature of the virtual object 710 by a first rate (e.g., a first amount of change in curvature per unit magnitude of movement of the first hand 707 and/or the second hand 703) during a first portion of the movement of the first hand 707 and/or the second hand 703, and decreases the curvature of the virtual object 710 by a second rate, lower than the first rate, in the three-dimensional environment 700 during a subsequent portion of the movement of the first hand 707 and/or the second hand 703. Additional details regarding the non-linear change in curvature of the virtual object 710 when reducing the size of the virtual object 710 in the three-dimensional environment 700 are provided below with reference to method 900.

In FIG. 7S, after optionally detecting further movement of the first hand 707 and/or the second hand 703 closer together relative to the viewpoint of the user 702, the computer system 101 detects termination of the inputs provided by the first hand 707 and the second hand 703. For example, from FIG. 7S to FIG. 7T, the computer system 101 detects the first hand 707 and the second hand 703 release their respective air pinch gestures. In some embodiments, when the computer system 101 detects the termination of the inputs provided by the first hand 707 and the second hand 703, the requested size (e.g., scale) of the virtual object 710 in the three-dimensional environment 700 is below a threshold size (e.g., a threshold scale, such as 100% scale), such as the scale of the virtual object 710 being 90%, which is below the threshold scale. Accordingly, as shown in FIG. 7T, in response to detecting the termination of the inputs provided by the first hand 707 and the second hand 703 of the user 702, the computer system 101 (e.g., automatically) updates the size of the virtual object 710 to be at or above the threshold size. For example, as shown in FIG. 7T, the computer system 101 increases the scale of the virtual object 710, including the content of the virtual object 710, to the threshold scale (e.g., 100% scale), as indicated by indication 717.

In FIG. 7T, after displaying the second resize element 720 in response to detecting the attention (e.g., including gaze 726) of the user 702 directed to the right side of the virtual object 710 from the viewpoint of the user 702, the computer system 101 detects an input provided by the hand 703 directed to the second resize element 720 in the three-dimensional environment 700. For example, as shown in FIG. 7T, the computer system 101 detects an air pinch and drag gesture provided by the hand 703 of the user 702, optionally while the gaze 726 is directed to the second resize element 720 in the three-dimensional environment 700. In some embodiments, as shown in FIG. 7T, the movement of the hand 703 of the user 702 corresponds to movement of the second resize element 720 leftward in the three-dimensional environment relative to the viewpoint of the user 702.

In some embodiments, as shown in FIG. 7U, in response to detecting the input directed to the second resize element 720, the computer system 101 changes the simulated resolution of the virtual object 710 in the three-dimensional environment 700 as similarly discussed above. For example, as shown in FIG. 7U, the computer system 101 decreases the simulated resolution of the virtual object 710 in accordance with the leftward movement of the second resize element 720, which causes the aspect ratio of the virtual object 710 to decrease as well from the viewpoint of the user 702. Particularly, in some embodiments, as similarly discussed above, the computer system 101 decreases the amount of space in the virtual object 710 that is available for displaying content. In some embodiments, when decreasing the amount of space in the virtual object 710 that is available for displaying content, in accordance with a determination that the decreased amount of space falls below a threshold amount of space (e.g., based on a ratio of the size of the content in the virtual object 710 to the size of the virtual object 710), the computer system 101 decreases the size of the content in the virtual object 710 (e.g., to enable the content to remain visibly displayed in the virtual object 710 at the decreased simulated resolution). For example, in FIG. 7U, when the computer system 101 decreases the simulated resolution of the virtual object 710 in accordance with the input provided by the hand 703, the computer system 101 determines that the decreased amount of space falls below the threshold amount of space, causing the computer system 101 to (e.g., automatically) resize (e.g., reduce the sizes of) the representation of the dock 714a and/or the representations of the first user interface 711a, the second user interface 713a, and the third user interface 715a in the virtual object 710. Additionally, in some embodiments, as shown in FIG. 7U, when the computer system 101 decreases the simulated resolution of the virtual object 710 in accordance with the input provided by the hand 703, the computer system 101 shifts the content in the virtual object 710 to maintain the content visibly displayed in the virtual object 710 at the decreased simulated resolution. For example, as shown in FIG. 7U, the computer system 101 moves the representations of the first user interface 711a, the second user interface 713a, and the third user interface 715a closer together in the virtual object 710 from the viewpoint of the user 702.

In FIG. 7U, while displaying the second resize element 720 (e.g., in response to detecting the attention (e.g., including gaze 726) of the user 702 directed to the right side of the virtual object 710 from the viewpoint of the user 702), the computer system 101 detects an input provided by the hand 703 directed to the second resize element 720 in the three-dimensional environment 700. For example, as shown in FIG. 7U, the computer system 101 detects an air pinch and drag gesture provided by the hand 703 of the user 702, optionally while the gaze 726 is directed to the second resize element 720 in the three-dimensional environment 700. In some embodiments, as shown in FIG. 7U, the movement of the hand 703 of the user 702 corresponds to movement of the second resize element 720 rightward in the three-dimensional environment relative to the viewpoint of the user 702.

In some embodiments, in response to detecting the input directed to the second resize element 720, the computer system 101 changes the simulated resolution of the virtual object 710 to a value of simulated resolution within a set of discrete values of simulated resolution (e.g., corresponding to the values associated with the plurality of options in the menu 722 in FIG. 7M) based on the input. For example, as shown in FIG. 7U, in response to detecting the movement of the hand 703 that corresponds to movement of the second resize element 720 rightward in the three-dimensional environment 700 relative to the viewpoint of the user 702, the computer system 101 initiates changing the simulated resolution of the virtual object 710 in accordance with the movement of the second resize element 720. As shown in FIG. 7U, the computer system 101 optionally increases the aspect ratio of the virtual object 710 in accordance with the movement of the second resize element 720, which optionally causes the amount of space in the virtual object 710 that is available for displaying content to be increased as well. Additionally, as shown in FIG. 7V, the computer system 101 increases the curvature of the virtual object 710 based on the increased size (e.g., increased aspect ratio) of the virtual object 710 in the three-dimensional environment 700 from the viewpoint of the user 702, as indicated in the top-down view 705.

In some embodiments, in response to detecting a termination of the input provided by the hand 703, the computer system 101 selects a value of simulated resolution from the set of discrete values of simulated resolution mentioned above. Particularly, in some embodiments, the computer system 101 selects a value of simulated resolution from the set of discrete values of simulated resolution that is closest to the current value of simulated resolution corresponding to the movement of the second resize element 720. For example, in FIG. 7V, after moving the second resize element 720 in accordance with the movement of the hand 703, which causes the computer system 101 to initiate the change in simulated resolution of the virtual object 710 in the manner discussed above, the computer system 101 detects the hand 703 release the air pinch gesture. In some embodiments, as shown in FIG. 7W, in response to detecting the release of the air pinch gesture provided by the hand 703, the computer system 101 changes the simulated resolution of the virtual object 710 to a respective simulated resolution, as indicated by indication 724 (e.g., a wide simulated resolution, optionally corresponding to a wide aspect ratio, such as similarly described with reference to FIG. 7N), from the set of discrete values of simulated resolution. For example, as shown in FIG. 7W, the computer system 101 selects a discrete value of simulated resolution (e.g., wide simulated resolution) from the set of discrete values of simulated resolution that is closest to the current and/or requested value of simulated resolution in FIG. 7V when the input provided by the hand 703 is terminated, which causes the simulated resolution of the virtual object 710 to decrease in the three-dimensional environment 700. Additionally, as shown in FIG. 7W, when the computer system 101 decreases the simulated resolution of the virtual object 710 in the three-dimensional environment 700, the computer system 101 optionally decreases the curvature of the virtual object 710 in the three-dimensional environment 700 (e.g., based on the decreased aspect ratio and/or size of the virtual object 710 relative to the viewpoint of the user 702, as similarly discussed above), as indicated in the top-down view 705.

In FIG. 7W, the computer system 101 detects movement of the viewpoint of the user 702 relative to the three-dimensional environment 700. For example, as illustrated by arrow 735 in the top-down view 705 in FIG. 7W, the computer system 101 detects the user 702 move (e.g., walk) forward in the physical environment toward the desk 708, which causes the computer system 101 (e.g., which is worn on the head of the user 702) to also move forward in the physical environment toward the desk 708, thereby changing the viewpoint of the user 702, as shown in FIG. 7X.

In some embodiments, as shown in FIG. 7X, when the viewpoint of the user 702 changes, the view of the three-dimensional environment 700 is updated based on the updated viewpoint of the user 702. For example, as shown in FIG. 7X, because the viewpoint of the user 702 is closer to the virtual object 710 (e.g., and the virtual object 730), the content of the virtual object 710 visually appears larger in the field of view of the user 702 from the updated viewpoint of the user 702 in the three-dimensional environment 700 (e.g., without the size of the virtual object 710 actually increasing in the three-dimensional environment 700, as indicated in the top-down view 705 from FIG. 7W to FIG. 7X). Particularly, as shown in FIG. 7X, because the viewpoint of the user 702 is closer to the surface of the virtual object 710 in the three-dimensional environment 700, respective portions (e.g., edge portions) of the representations of the first user interface 711a and the second user interface 713a in the virtual object 710 are at least partially obscured in the three-dimensional environment 700 from the updated viewpoint of the user 702. However, as shown in FIG. 7X, despite the virtual object 710 appearing larger in the three-dimensional environment 700 relative to the updated viewpoint of the user 702, the computer system 101 forgoes changing the curvature of the virtual object 710 based on the now larger apparent size of the virtual object 710 relative to the viewpoint of the user 702. For example, as indicated in the top-down view 705 in FIG. 7X, the computer system 101 maintains the same amount of curvature of the virtual object 710 in the three-dimensional environment 700 after the viewpoint of the user 702 is updated.

In FIG. 7X, after the viewpoint of the user 702 is updated, the computer system 101 detects an input directed to the virtual object 710 in the three-dimensional environment 700. For example, as shown in FIG. 7X, the computer system 101 detects an air pinch gesture provided by the hand 703, optionally while the attention (e.g., including the gaze 726) of the user 702 is directed to the movement element 712 associated with the virtual object 710 in the three-dimensional environment 700. In some embodiments, the computer system 101 detects the air pinch gesture directed to the movement element 712 without detecting movement of the hand 703 in space relative to the viewpoint of the user 702. In some embodiments, the computer system 101 detects the air pinch gesture directed to the movement element 712, followed by movement of the hand 703 in space relative to the viewpoint of the user 702.

In some embodiments, as shown in FIG. 7Y, in response to detecting the input directed to the virtual object 710, the computer system 101 changes the curvature of the virtual object 710 in the three-dimensional environment 700 based on the size of the virtual object 710 relative to the updated viewpoint of the user 702. For example, as indicated in the top-down view 705 in FIG. 7Y, because the movement of the viewpoint of the user 702 in FIG. 7X above causes the size of the virtual object 710 to increase relative to the updated viewpoint of the user 702, the computer system 101 increases the curvature of the virtual object 710 in the three-dimensional environment 700 in response to detecting the air pinch gesture provided by the hand 703 directed to the movement element 712 (e.g., causing the representations of the first user interface 711a and the second user interface 713a to be visibly displayed in the virtual object 710).

In FIG. 7Y, the computer system 101 detects movement of the viewpoint of the user 702 while concurrently detecting an input directed to the virtual object 710 in the three-dimensional environment 700. For example, as shown in FIG. 7Y, as similarly discussed above, in the top-down view 705, the computer system 101 detects movement of the viewpoint of the user 702, as indicated by the arrow 735, while detecting an air pinch gesture provided by the hand 703 of the user 702, optionally while the attention (e.g., including the gaze 726) of the user 702 is directed to the movement element 712 in the three-dimensional environment 700. In some embodiments, as indicated by the arrow 735 in the top-down view 705, the movement of the viewpoint of the user 702 corresponds to movement of the viewpoint of the user 702 away from (e.g., farther from) the virtual object 710 in the three-dimensional environment 700. In FIG. 7Y, as similarly discussed above, the computer system 101 detects the air pinch gesture provided by the hand 703 optionally without detecting movement of the hand 703 in space relative to the viewpoint of the user 702.

In some embodiments, as shown in FIG. 7Z, when the viewpoint of the user 702 changes, the view of the three-dimensional environment 700 is updated based on the updated viewpoint of the user 702. For example, as shown in FIG. 7Z, because the viewpoint of the user 702 is farther from the virtual object 710 (e.g., and the virtual object 730), the content of the virtual object 710 visually appears smaller in the field of view of the user 702 from the updated viewpoint of the user 702 in the three-dimensional environment 700 (e.g., without the size of the virtual object 710 actually decreasing in the three-dimensional environment 700, as indicated in the top-down view 705 from FIG. 7Y to FIG. 7Z). Particularly, as shown in FIG. 7Z, because the viewpoint of the user 702 is farther from the surface of the virtual object 710 in the three-dimensional environment 700, the representation of the dock 714a and the representations of the first user interface 711a, the second user interface 713a, and the third user interface 715a in the virtual object 710 visually appear smaller in the three-dimensional environment 700 from the updated viewpoint of the user 702. Additionally, as shown in FIG. 7Z, because an input is detected as being directed to the virtual object 710 (e.g., the air pinch gesture provided by the hand 703 above) while the change in the viewpoint of the user 702 is detected, the computer system 101 changes the curvature of the virtual object 710 based on the now smaller apparent size of the virtual object 710 in the three-dimensional environment 700 relative to the updated viewpoint of the user 702. For example, as indicated in the top-down view 705 in FIG. 7Z, the computer system 101 decreases the curvature of the virtual object 710 in the three-dimensional environment 700 after the viewpoint of the user 702 is updated.

In FIG. 7Z, the computer system 101 detects an input corresponding to a request to move the virtual object 710 in the three-dimensional environment 700 relative to the viewpoint of the user 702. For example, as shown in FIG. 7Z, the computer system 101 detects an air pinch and drag gesture performed by the hand 703 of the user 702, optionally while the attention (e.g., including the gaze 726) of the user 702 is directed to the movement element 712 associated with the virtual object 710 in the three-dimensional environment 700. In some embodiments, as shown in FIG. 7Z, the movement of the hand 703 corresponds to movement of the virtual object 710 toward (e.g., closer to) the viewpoint of the user 702 in the three-dimensional environment 700.

In some embodiments, as shown in FIG. 7AA, in response to detecting the input provided by the hand 703, the computer system 101 moves the virtual object 710 in the three-dimensional environment 700 in accordance with the input. For example, as shown in FIG. 7AA, the computer system 101 moves the virtual object 710 toward the viewpoint of the user 702 in the three-dimensional environment 700 relative to the viewpoint of the user 702 in accordance with the movement of the hand 703. Additionally, in some embodiments, as shown in FIG. 7AA, when the computer system 101 moves the virtual object 710 in the three-dimensional environment 700 in accordance with the input provided by the hand 703, the computer system 101 changes the curvature of the virtual object 710 in the three-dimensional environment 700 based on the updated size of the virtual object 710 relative to the viewpoint of the user 702. For example, in FIG. 7AA, when the virtual object 710 is moved closer to the viewpoint of the user 702 in the three-dimensional environment 700 in response to detecting the input provided by the hand 703, the apparent size of the virtual object 710 increases relative to the viewpoint of the user 702, causing the computer system 101 to increase the curvature of the virtual object 710 in the three-dimensional environment 700 based on the increased apparent size of the virtual object 710 relative to the viewpoint of the user 702, as illustrated in the top-down view 705.

In FIG. 7AA, the computer system 101 receives an indication of a request to enter a communication session with a second user (e.g., Jen). For example, in FIG. 7AA, the computer system 101 detects a notification event corresponding to an incoming call, such as an incoming phone call or video call, from Jen. In some embodiments, as shown in FIG. 7AA, in response to detecting the notification event, the computer system 101 displays notification 734 in the three-dimensional environment 700. In some embodiments, as shown in FIG. 7AA, the notification 734 includes a first option 736a that is selectable to answer (e.g., accept) the incoming call from the second user (e.g., Jen) and a second option 736b that is selectable to decline (e.g., deny) the incoming call from the second user. In some embodiments, the request to enter the communication session with the second user corresponds to a request to enter a spatial real-time communication session with the second user. Details regarding spatial real-time communication sessions are provided with reference to method 900.

In FIG. 7AA, while displaying the notification 734 in the three-dimensional environment 700, the computer system 101 detects an input corresponding to selection of the first option 736a in the notification 734. For example, as shown in FIG. 7AA, the computer system 101 detects an air pinch gesture provided by the hand 703, optionally while the attention (e.g., including the gaze 726) of the user 702 is directed to the first option 736a in the three-dimensional environment 700.

In some embodiments, as shown in FIG. 7BB, in response to detecting the selection of the first option 736a, the computer system 101 enters the communication session (e.g., the spatial real-time communication session) with the second user (e.g., Jen). In some embodiments, as shown in FIG. 7BB, while the user 702 and the second user are participating in the communication session, the computer system 101 displays representation 704 of the second user in the three-dimensional environment 700. For example, as shown in FIG. 7BB, the computer system 101 displays a virtual avatar (e.g., a three-dimensional representation) of the second user in the three-dimensional environment 700. Additional details regarding the representation 704 of the second user are provided with reference to method 900.

In FIG. 7BB, while the user 702 and the second user are participating in the communication session, the computer system 101 detects an input corresponding to a request to share the content of the virtual object 710 with the second user in the communication session. For example, as shown in FIG. 7BB, the computer system 101 detects the hand 703 of the user 702 perform an air pinch gesture, optionally while the attention (e.g., including the gaze 726) of the user is directed to share option 738 in the three-dimensional environment 700. In some embodiments, the share option 738 is selectable to initiate a process to share the content of the virtual object 710 with the second user.

In some embodiments, as shown in FIG. 7CC, in response to detecting the selection of the share option 738, the computer system 101 shares the content of the virtual object 710 with the second user in the communication session. For example, the virtual object 710 becomes and/or is a shared object in the communication session, such that the representation of the dock 714a and the representations of the first user interface 711a, the second user interface 713a, and the third user interface 715a are viewable by and/or interactive to the user 702 and the second user (e.g., at their respective computer systems). Accordingly, in FIG. 7CC, a number of users/participants viewing and/or interacting with the virtual object 710 increases (e.g., from one user to two or more users) when the content of the virtual object 710 is shared in the communication session. However, as shown in FIG. 7CC, the computer system 101 optionally forgoes updating the curvature of the virtual object 710 in the three-dimensional environment 700 despite the number of participants who are viewing and/or interacting with the virtual object 710 increasing. Alternatively, in some embodiments, when and/or in response to the content of the virtual object 710 is shared with the second user in the communication session, the computer system 101 (e.g., automatically) updates the curvature of the virtual object 710 in the three-dimensional environment based on the increased number of participants who are viewing and/or interacting with the virtual object 710. For example, as shown in the top-down view 705 in FIG. 7DD, the computer system 101 decreases the curvature of the virtual object 710 in the three-dimensional environment 700 (e.g., to enable the content of the virtual object 710 to be and/or remain visible to the participants in the communication session from their unique viewpoints).

In FIG. 7CC, after sharing the content of the virtual object 710 in the communication session (and optionally without updating the curvature of the virtual object 710 in the three-dimensional environment 700 as discussed above), the computer system 101 detects an input corresponding to a request to move the virtual object 710 in the three-dimensional environment 700 relative to the viewpoint of the user 702. For example, as shown in FIG. 7CC, the computer system 101 detects an air pinch and drag gesture provided by the hand 703, optionally while the attention (e.g., including the gaze 726) of the user 702 is directed to the movement element 712 associated with the virtual object 710 in the three-dimensional environment 700. In some embodiments, as shown in FIG. 7CC, the movement of the hand 703 of the user 702 corresponds to movement of the virtual object 710 away from (e.g., farther from) the viewpoint of the user 702 in the three-dimensional environment 700 relative to the viewpoint of the user 702.

In some embodiments, as shown in FIG. 7DD, in response to detecting the input provided by the hand 703, the computer system 101 moves the virtual object 710 in the three-dimensional environment 700 in accordance with the input. For example, as shown in FIG. 7DD, the computer system 101 moves the virtual object 710 away from (e.g., farther from) the viewpoint of the user 702 in the three-dimensional environment 700 in accordance with the movement of the hand 703 relative to the viewpoint of the user 702. Additionally, in some embodiments, as shown in FIG. 7DD, when the computer system 101 moves the virtual object 710 in response to detecting the input provided by the hand 703, the computer system 101 updates the curvature of the virtual object 710 in the three-dimensional environment 700 based on the updated apparent size of the virtual object 710 relative to the viewpoint of the user 702, as similarly discussed above. Additionally or alternatively, in some embodiments, the computer system 101 changes the curvature of the virtual object 710 based on the increased number of participants viewing and/or interacting with the virtual object 710 in the communication session, as similarly discussed above. For example, as indicated in the top-down view 705 in FIG. 7DD, the computer system 101 decreases the curvature of the virtual object 710 to enable the content of the virtual object 710 (e.g., the representation of the dock 714a and/or the representations of the first user interface 711a, the second user interface 713a, and the third user interface 715a) to be and/or remain visible to the participants in the communication session from their unique viewpoints (e.g., based on and/or after the movement of the virtual object 710 discussed above).

In FIG. 7DD, the computer system 101 detects movement of the viewpoint of the second user in the shared space of the communication session, as indicated by arrow 735 in the top-down view 705. Particularly, in FIG. 7DD, the computer system 101 detects the viewpoint of the second user move farther from the viewpoint of the user 702, causing the representation 704 of the second user to move farther from the viewpoint of the user 702 in the three-dimensional environment 700 relative to the viewpoint of the user 702, as shown in the top-down view 705 in FIG. 7EE.

In some embodiments, in FIG. 7EE, the movement of the viewpoint of the second user, which causes the representation 704 of the second user to move in the three-dimensional environment 700 relative to the viewpoint of the user 702, corresponds to and/or causes a change in a spatial distribution of the participants in the communication session. For example, as indicated in the top-down view 705 from FIG. 7DD to FIG. 7EE, the representation 704 (e.g., representing the viewpoint of the second user) is located farther from the viewpoint of the user 702 in the three-dimensional environment 700, corresponding to an increase in the spatial distribution of the user 702 and the second user. However, as shown in FIG. 7EE, the computer system 101 forgoes changing the curvature of the virtual object 710 in the three-dimensional environment 700 despite the viewpoint of the second user (e.g., corresponding to the representation 704) being located farther from the viewpoint of the user 702 in the shared space.

In FIG. 7EE, the computer system 101 detects an input corresponding to a request to move the virtual object 710 in the three-dimensional environment 700 relative to the viewpoint of the user 702. For example, as shown in FIG. 7EE, the computer system 101 detects an air pinch and drag gesture provided by the hand 703, optionally while the attention (e.g., including the gaze 726) of the user 702 is directed to the movement element 712 associated with the virtual object 710 in the three-dimensional environment 700. In some embodiments, as shown in FIG. 7EE, the movement of the hand 703 of the user 702 corresponds to movement of the virtual object 710 toward (e.g., closer to) the viewpoint of the user 702 in the three-dimensional environment 700 relative to the viewpoint of the user 702.

In some embodiments, as shown in FIG. 7FF, in response to detecting the input provided by the hand 703, the computer system 101 moves the virtual object 710 in the three-dimensional environment 700 in accordance with the input. For example, as shown in FIG. 7FF, the computer system 101 moves the virtual object 710 toward (e.g., closer to) the viewpoint of the user 702 in the three-dimensional environment 700 in accordance with the movement of the hand 703 relative to the viewpoint of the user 702. Additionally, in some embodiments, as shown in FIG. 7FF, when the computer system 101 moves the virtual object 710 in response to detecting the input provided by the hand 703, the computer system 101 updates the curvature of the virtual object 710 in the three-dimensional environment 700 based on the updated apparent size of the virtual object 710 relative to the viewpoint of the user 702, as similarly discussed above. Additionally or alternatively, in some embodiments, the computer system 101 changes the curvature of the virtual object 710 based on the increased spatial distribution of the participants viewing and/or interacting with the virtual object 710 in the communication session, as similarly discussed above. For example, as indicated in the top-down view 705 in FIG. 7FF, the computer system 101 decreases the curvature of the virtual object 710 to enable the content of the virtual object 710 (e.g., the representation of the dock 714a and/or the representations of the first user interface 711a, the second user interface 713a, and the third user interface 715a) to be and/or remain visible to the participants in the communication session from their unique viewpoints (e.g., based on and/or after the movement of the virtual object 710 discussed above).

FIG. 8 is a flowchart illustrating an exemplary method 800 of facilitating changing a simulated resolution of a virtual object in a three-dimensional environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, a method 800 is performed at a first computer system (e.g., computer system 101 in FIG. 7A) in communication with one or more display generation components (e.g., display generation component 120) and one or more input devices (e.g., image sensors 114a-114c). For example, a mobile device (e.g., a tablet, a smartphone, a media player, or a wearable device), or a computer or other electronic device. In some embodiments, the one or more display generation components are or include one or more displays integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, a hand motion sensor). In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, while displaying, via the one or more display generation components, a representation of content from a second computer system, different from the first computer system, in an environment (e.g., a three-dimensional environment), such as virtual object 710 in three-dimensional environment 700 in FIG. 7A, the first computer system detects (802), via the one or more input devices, a first set of one or more inputs corresponding to a request to change a size of the representation of the content in the environment, such as the input provided by hand 703 directed to second resize element 720 in FIG. 7F. In some embodiments, the three-dimensional environment is an extended reality (XR) environment, such as a virtual reality (VR) environment, a mixed reality (MR) environment, or an augmented reality (AR) environment. In some embodiments, a physical environment is visible via the one or more display generation components as an image view/stream or a computer-generated representation of the portion of the physical environment via optical (e.g., passive) passthrough of the physical environment. In some embodiments, the second computer system is a mobile device (e.g., a tablet, a smartphone, a media player, or a wearable device), or a computer or other electronic device. The second computer system is optionally in communication with one or more second display generation components that display one or more (virtual) objects via the one or more second display generation components. One or more of the one or more objects displayed via the one or more second display generation components are optionally visible via the one or more display generation components that are in communication with the first computer system (e.g., via active or passive passthrough). In some embodiments, the second computer system has one or more of the characteristics of the first computer system. In some embodiments, the one or more display generation components of the first computer system include a transparent portion such that the second computer system is visible via the one or more display generation components by virtue of passive passthrough of the second computer system. Alternatively, in some embodiments, the one or more display generation components of the first computer system perform active passthrough, such that the second computer system is visible in the three-dimensional environment via display of captured images of the physical environment. In some embodiments, the first computer system and the second computer system are both associated with the same user (e.g., the user of the first computer system). For example, the first computer system and the second computer system are optionally associated with the same user due to a same user credential, account and/or profile associated with the user being signed into on the first computer system and the second computer system. For example, the user is optionally logged into the first computer system via a first user credential associated with the user and the user is optionally logged into the second computer system via the first user credential associated with the user.

The representation of content from the second computer system is optionally the same content that is displayed by the second computer system via the one or more second display generation components, such as the representations of user interfaces 711a-715a that are also displayed by electronic device 760 in FIG. 7A. For example, the second computer system is optionally displaying a first application window (e.g., an Internet application window such as a web browser window or an email application window, a desktop, or an icon) via the one or more second display generation components. The first window is optionally visible via the one or more display generation components of the first computer system. In some embodiments, the representation of content from the second computer system corresponds to a virtual instance of the second computer system. For example, the second computer system initiates the virtual instance of the second computer system, and shares the virtual instance with the first computer system, such that the second computer system controls/directs, via data transmitted by the second computer system, the display of the virtual instance, including the content displayed with and/or included within the virtual instance. Alternatively, in some embodiments, the first computer system initiates the virtual instance of the second computer system. The first computer system is optionally authorized to display, interact with, and/or modify the virtual instance of the second computer system. For example, data accessible on the second computer system is optionally accessible on the first computer system via the virtual instance of the second computer system displayed via the one or more display generation components of the first computer system.

In some embodiments, the second computer system is a remotely controlled computer system via the first computer system, such as the electronic device 760 being remotely controlled by the computer system 101 in FIGS. 7A-7FF. For example, the first computer system is optionally able to access the data, functionalities, and/or network of the second computer system. Interaction with the second computer system optionally includes interaction with the virtual instance of the second computer system that causes corresponding actions to occur at the second computer system. In some embodiments, in response to selection and/or interaction with the representation of content from the second computer system displayed via the one or more display generation components, the first computer system transmits data indicative of the selection and/or interaction to the second computer system. The second computer system, upon receiving and/or processing the data transmitted by the first computer system, optionally responds as if the selection and/or interaction happened at the second computer system. Such response optionally includes the second computer system transmitting, to the first computer system, instructions for updating display of the representation of content from the second computer system on the first computer system in response to the interaction.

In some embodiments, detecting the first set of one or more inputs includes detecting an air gesture provided by a hand of the user directed to the representation of the content from the second computer system, such as the air pinch and drag gesture provided by the hand 703 as shown in FIG. 7F. For example, the first computer system detects an air pinch and drag gesture provided by a hand of the user directed to a resize affordance displayed with the representation of the content from the second computer system. As an example, as discussed in more detail below, the resize affordance is displayed at and/or adjacent to a corner or edge/side of the virtual instance of the second computer system, and while the attention (e.g., including gaze) of the user is directed to the resize affordance, the first computer system detects an air pinch gesture, followed by movement of the hand of the user while maintaining the pinch hand gesture in a respective direction and/or with a respective magnitude (e.g., of speed and/or distance). In some embodiments, detecting the first set of one or more inputs includes detecting a selection of a resize option that is displayed with the representation of the second from the second computer system. For example, the computer system detects an air pinch gesture provided by a hand of the user, optionally while the attention (e.g., including gaze) of the user is directed toward the resize option in the three-dimensional environment. In some embodiments, the resize option is a first resize option of a plurality of resize options (e.g., displayed within a menu or toolbar of selectable options). In some embodiments, the first resize option includes a designation/indication of a particular size to which to increase or decrease the representation of the content in the environment.

In some embodiments, in response to detecting the first set of one or more inputs (804), in accordance with a determination that the first set of one or more inputs includes a first type of input, such as movement of the second resize element 720 as shown in FIG. 7F, the first computer system changes (806) a simulated resolution (e.g., a display resolution optionally determined by an aspect ratio) of the representation of the content in the environment based on the first set of one or more inputs, wherein changing a simulated resolution of the representation of the content increases an amount of space in the representation of content that is available for displaying content items (optionally without changing a size of content items that are already displayed within or on the representation of content), such as increasing the simulated resolution of the virtual object 710 as shown in FIG. 7G. For example, the first type of input, as discussed below, includes interaction with a first resize affordance that is displayed with the representation of the content from the second computer system in the three-dimensional environment. In some embodiments, the first set of one or more inputs includes the first type of input in accordance with a determination that the first set of one or more inputs includes a selection of the first resize affordance, such as via an air pinch gesture provided by a hand of the user, followed by movement of the first resize affordance, such as via a movement of the hand while maintaining the air pinch gesture, in a respective direction and/or with a respective magnitude (e.g., of speed and/or distance). In some embodiments, as discussed in more detail below, the first resize affordance is displayed adjacent to an edge or side of the representation of the content from the second computer system in the environment (e.g., the first resize affordance is displayed vertically along a left or right side of the rectangular virtual instance of the second computer system). Additionally or alternatively, in some embodiments, the first set of one or more inputs includes the first type of input in accordance with a determination that the first set of one or more inputs includes a selection of a resize option (e.g., via an air gesture, such as an air pinch gesture or an air tap gesture, provided by the hand of the user) that corresponds to a request to change an aspect ratio associated with the representation of the content from the second computer system. For example, the resize option includes and/or corresponds to a designation/indication of a particular aspect ratio (e.g., 16:9; 21:9; 32:9).

In some embodiments, in accordance with the determination that the first set of one or more inputs includes the first type of input, the first computer system changes a simulated resolution (optionally including changing an aspect ratio) of the representation of the content from the second computer system based on the first set of one or more inputs, such as the simulated resolution of the virtual object 710 being increased based on the movement of the hand 703 as shown in FIG. 7G. For example, the first computer system increases or decreases the simulated resolution of the representation of the content from the second computer system to a value that corresponds to the magnitude movement of the first resize affordance discussed above. As an example, if the first input includes movement of the first resize affordance by a first magnitude (e.g., of speed and/or distance) in the three-dimensional environment, the first computer system changes the simulated resolution of the content from the second computer system to be a first resolution that is based on the first magnitude, and if the first input includes movement of the first resize affordance by a second magnitude, different from the first magnitude, the first computer system changes the simulated resolution of the content from the second computer system to be a second resolution, different from the first resolution, that is based on the second magnitude. Additionally, in some embodiments, whether the simulated resolution is increased or decreased is based on the direction of the movement of the first resize affordance discussed above. For example, if the first input includes movement of the first resize affordance in a first direction in the three-dimensional environment, the first computer system increases the simulated resolution of the content from the second computer system, and if the first input includes movement of the first resize affordance in a second direction, opposite the first direction, the first computer system decreases the simulated resolution of the content from the second computer system. Additionally or alternatively, in some embodiments, as discussed in more detail below, the simulated resolution of the representation of the content from the second computer system is updated to be a particular resolution from a set of discrete resolutions (e.g., 16:9; 21:9; 32:9). For example, if the first input includes a selection of a respective resize option that includes and/or corresponds to a designation of a respective aspect ratio, the first computer system changes the simulated resolution of the representation of the content from the second computer system to correspond to the respective aspect ratio in the three-dimensional environment. In some embodiments, a resolution of the one or more display generation components in communication with the first computer system is not updated/changed when the simulated resolution of the representation of the content from the second computer system is updated in the manner(s) described herein. For example, the simulated (e.g., virtual) resolution of the content displayed in the three-dimensional environment is different from and/or is independent of the resolution of the one or more display generation components. Similarly, in some embodiments, a resolution of the one or more second display generation components of the second computer system discussed above is not updated/changed when the simulated resolution of the representation of the content from the second computer system is updated in the manner(s) described herein. For example, the simulated (e.g., virtual) resolution of the content displayed in the three-dimensional environment is different from and/or is independent of the resolution of the one or more second display generation components. Additional details regarding changing the simulated resolution of the representation of the content from the second computer system are provided below. Changing a resolution of a representation of content from the second computer system in a three-dimensional environment in response to detecting input corresponding to a request to resize the representation of content based on whether the input is a first type of input reduces the number of inputs needed to change the resolution of the representation of content from the second computer system and/or facilitates input for interacting with the second computer system via components of the first computer system, which avoids interrupting the use of the first computer system, thereby improving user-device interaction.

In some embodiments, the first type of input includes interaction with a resize element associated with the representation of the content from the second computer system in the environment, such as interaction the second resize element 720 in FIG. 7F. For example, as similarly discussed above, the first type of input includes a selection of a resize element displayed with the representation of the content from the second computer system in the environment, optionally followed by movement of the resize element in the environment. In some embodiments, as similarly discussed above, the interaction with the resize element is provided via one or more air gestures performed by a hand of the user, such as an air pinch gesture while the attention of the user is directed to the resize element, optionally followed by an air drag gesture. In some embodiments, movement of the resize element in a respective direction and/or with a respective magnitude (e.g., of speed and/or distance) causes the first computer system to change the simulated resolution of the representation of the content from the second computer system based on and/or in accordance with the movement of the resize element. For example, movement of the resize element in a first direction (e.g., rightward or leftward in the environment relative to the viewpoint of the user) in the environment and/or with a first magnitude (e.g., of speed and/or distance) causes the first computer system to change the simulated resolution (e.g., increase or decrease the simulated resolution) of the representation of the content from the second computer system in the environment by an amount that is based on and/or is in accordance with the first magnitude of the movement of the resize element. In some embodiments, the first computer system concludes and/or completes the changing of the simulated resolution of the representation of the content from the second computer system in response to detecting a termination of the interaction with the resize element (e.g., a deselection of the resize element, such as via a release of the air pinch gesture). In some embodiments, the resize element is different from a movement element (e.g., a grabber bar) that is also associated with the representation of the content from the second computer system but is selectable to initiate movement of the representation in the environment relative to the viewpoint of the user. Changing a resolution of a representation of content from the second computer system in a three-dimensional environment in response to detecting input that includes interaction with a resize element associated with the representation of content reduces the number of inputs needed to change the resolution of the representation of content from the second computer system and/or facilitates input for interacting with the second computer system via components of the first computer system, which avoids interrupting the use of the first computer system, thereby improving user-device interaction.

In some embodiments, the resize element is displayed in the environment in response to detecting attention of a user of the first computer system directed toward a respective portion of the representation of the content from the second computer system in the environment, such as the second resize element 720 being displayed in the three-dimensional environment 700 in response to detecting the gaze 726 directed to the side of the virtual object 710 in FIG. 7E. For example, prior to and/or when detecting the first set of one or more inputs, the first computer system detects the attention (e.g., including gaze) of the user directed to a portion of the representation of the content from the second computer system in the environment. In some embodiments, in response to detecting the attention of the user directed to the respective portion of the representation, the first computer system displays the resize element with the representation in the environment, such as adjacent to the respective portion, below the respective portion, above the respective portion, overlaid on the respective portion, and/or in front of the respective portion from the viewpoint of the user in the environment. In some embodiments, in response to detecting that the attention of the user is no longer directed toward the respective portion of the representation of the content from the second computer system and/or in response to detecting termination of the interaction with the resize element, the first computer system ceases display of the resize element in the environment. Changing a resolution of a representation of content from the second computer system in a three-dimensional environment in response to detecting input that includes interaction with a resize element associated with the representation of content that is displayed based on attention of the user reduces the number of inputs needed to change the resolution of the representation of content from the second computer system and/or facilitates input for interacting with the second computer system via components of the first computer system, which avoids interrupting the use of the first computer system, thereby improving user-device interaction.

In some embodiments, the respective portion of the representation of the content from the second computer system includes a respective edge of the representation of the content from the second computer system, such as the right edge of the virtual object 710 in FIG. 7E. For example, the respective edge of the representation is a right or left edge of the representation from the viewpoint of the user. In some embodiments, the resize element is displayed with and/or adjacent to the respective edge of the representation in the environment from the viewpoint of the user. For example, if the respective edge of the representation is the right edge of the representation, the first computer system displays the resize element adjacent to the right edge of the representation in the environment from the viewpoint of the user in response to detecting the attention of the user directed to the right edge. In some embodiments, if the respective edge of the representation is the left edge of the representation, the first computer system displays the resize element adjacent to the left edge of the representation in the environment from the viewpoint of the user in response to detecting the attention of the user directed to the left edge. Changing a resolution of a representation of content from the second computer system in a three-dimensional environment in response to detecting input that includes interaction with a resize element associated with the representation of content that is displayed based on attention of the user reduces the number of inputs needed to change the resolution of the representation of content from the second computer system and/or facilitates input for interacting with the second computer system via components of the first computer system, which avoids interrupting the use of the first computer system, thereby improving user-device interaction.

In some embodiments, displaying the resize element in the environment in response to detecting the attention of the user directed toward the respective portion of the representation of the content from the second computer system includes, in accordance with a determination that the attention (e.g., including the gaze 726 in FIG. 7E) of the user is directed toward a first portion (e.g., a left edge/side) of the representation of the content from the second computer system in the environment, displaying, via the one or more display generation components, the resize element at a first location in the environment that is based on (e.g., adjacent to) the first portion, such as displaying the second resize element 720 adjacent to the right side of the virtual object 710 as shown in FIG. 7E. In some embodiments, in accordance with a determination that the attention (e.g., including the gaze 726 in FIG. 7G) of the user is directed toward a second portion (e.g., a right edge/side), different from the first portion, of the representation of the content from the second computer system in the environment, the first computer system displays the resize element at a second location, different from the first location, in the environment that is based on (e.g., adjacent to) the second portion, such as displaying the second resize element 720 adjacent to the left side of the virtual object 710 as shown in FIG. 7G. For example, as similarly discussed above, the location at which the resize element is displayed in the environment from the viewpoint of the user is based on the particular portion of the representation of the content from the second computer system the attention of the user is directed. In some embodiments, while the resize element is displayed at the first location in the environment in response to detecting the attention of the user directed to the first portion of the representation, if the first computer system detects movement of the attention of the user from being directed to the first portion to being directed to the second portion of the representation, the first computer system ceases display of the resize element at the first location and displays the resize element at the second location in the environment. Changing a resolution of a representation of content from the second computer system in a three-dimensional environment in response to detecting input that includes interaction with a resize element associated with the representation of content that is displayed at a particular location in the three-dimensional environment based on attention of the user reduces the number of inputs needed to change the resolution of the representation of content from the second computer system and/or facilitates input for interacting with the second computer system via components of the first computer system, which avoids interrupting the use of the first computer system, thereby improving user-device interaction.

In some embodiments, the first type of input includes selection of a respective option that is selectable to change the simulated resolution of the representation of the content from the second computer system in the environment, such as selection of first option 723a or second option 723b as shown in FIG. 7M. For example, as similarly discussed above, the respective option is or includes an aspect ratio option that is displayed in the environment with the representation of the content from the second computer system. In some embodiments, the respective option is one of a plurality of selectable options displayed within a menu user interface object in the environment, such as a plurality of aspect ratio options. In some embodiments, the respective option is selectable to change the simulated resolution of the representation by changing the aspect ratio of the representation in the environment. For example, the respective option is selectable to cause the first computer system to change the aspect ratio of the representation to an aspect ratio corresponding to the respective option, such as 16:9, 21:9, or 32:9, as similarly discussed above, thereby changing the simulated resolution of the representation in the environment. Changing a resolution of a representation of content from the second computer system in a three-dimensional environment in response to detecting input that includes a selection of a respective option for changing the simulated resolution of the representation of content reduces the number of inputs needed to change the resolution of the representation of content from the second computer system and/or facilitates input for interacting with the second computer system via components of the first computer system, which avoids interrupting the use of the first computer system, thereby improving user-device interaction.

In some embodiments, the respective option is displayed within a menu of selectable options (e.g., a plurality of aspect ratio options, as similarly discussed above), and the menu is displayed in the environment in response to detecting input directed to the representation of the content from the second computer system, such as display of menu 722 in response to detecting a selection of the virtual object 710 as shown in FIG. 7M. For example, prior to and/or when detecting the first set of one or more inputs, the first computer system detects a selection of the representation of the content from the second computer system, such as via an air pinch gesture while the attention of the user is directed to the representation in the environment. In some embodiments, in response to detecting the input directed to the representation, the first computer system displays the menu including the respective option in the environment, such as adjacent to, above, below, or overlaid on the representation from the viewpoint of the user. In some embodiments, while the menu is displayed in the environment, the first computer system detects a selection of the respective option, such as via an air pinch gesture performed by a hand of the user while the attention of the user is directed to the respective option. In some embodiments, if the first computer system detects a selection of an option that is different from the respective option in the menu of the selectable options, the first computer system changes the simulated resolution of the representation based on the selection of the option. For example, the first computer system changes the aspect ratio of the representation to an aspect ratio corresponding to the selected option, which is optionally a different aspect ratio from the aspect ratio corresponding to the respective option above. Changing a resolution of a representation of content from the second computer system in a three-dimensional environment in response to detecting input that includes a selection of a respective option of a plurality of selectable options for changing the simulated resolution of the representation of content reduces the number of inputs needed to change the resolution of the representation of content from the second computer system and/or facilitates input for interacting with the second computer system via components of the first computer system, which avoids interrupting the use of the first computer system, thereby improving user-device interaction.

In some embodiments, the representation of the content from the second computer system is concurrently displayed (e.g., via the one or more display generation components) with a respective user interface object (e.g., a window management control, auxiliary user interface object, or window option affordance) in the environment, such as user interface object 728 in FIG. 7L. For example, the respective user interface object is displayed adjacent to the representation of the content from the second computer system in the three-dimensional environment, such as above, below, or to a side of the representation of the content from the second computer system from the viewpoint of the user of the first computer system. In some embodiments, the first computer system maintains a spatial relationship between the respective user interface object and the representation of the content from the second computer system in the three-dimensional environment relative to the viewpoint of the user in response to detecting input directed to the representation of the content from the second computer system. For example, if the first computer system detects an input provided by the user for moving, resizing, reorienting, and/or changing the simulated resolution of the representation of the content from the second computer system in the three-dimensional environment, such as via one or more air pinch gestures provided by the user, or via movement of the viewpoint of the user, and detected by the first computer system as similarly discussed herein, the first computer system maintains the location of the respective user interface object in the three-dimensional environment (e.g., including distance and/or orientation of the respective user interface object) relative to the representation of the content from the second computer system from the viewpoint of the user (e.g., maintains display of the respective user interface object at the location that is above, below, or to the side of the representation of the content from the second computer system in the three-dimensional environment). In some embodiments, the respective user interface object is displayed in the environment with the representation of the content from the second computer system for as long as the representation of the content from the second computer system is displayed in the environment. For example, when the first computer system displays the representation of the content from the second computer system in the three-dimensional environment (e.g., in response to detecting user input as similarly discussed above), the first computer system displays the respective user interface object with the representation of the content from the second computer system in the three-dimensional environment, and maintains display of the respective user interface object in the three-dimensional environment while the representation of the content from the second computer system is displayed in the three-dimensional environment. Similarly, in some embodiments, when the first computer system ceases display of the representation of the content from the second computer system in the three-dimensional environment (e.g., in response to detecting user input for ceasing display of the representation of the content from the second computer system), the first computer system ceases display of the respective user interface object in the three-dimensional environment. In some embodiments, as described below, the respective user interface object is selectable to display the menu that includes the respective option. In some embodiments, the respective user interface object provides a visual indication that the representation of the content from the second computer system is a virtual representation of a user interface of the second computer system. For example, the respective user interface object includes a label (e.g., textual label or image-based label) indicating that the representation of the content from the second computer system corresponds to a virtual instance of the second computer system, as previously described above.

In some embodiments, a menu that includes one or more selectable options (e.g., one aspect ratio option or a plurality of aspect ratio options, as similarly discussed above) is displayed, via the one or more display generation components, in the environment in response to detecting input directed to the respective user interface object, such as display of menu 722 in response to selection of the user interface object 728 as shown in FIG. 7M. For example, prior to and/or when detecting the first set of one or more inputs, the first computer system detects, via the one or more input devices, a selection of the respective user interface object, such as via an air pinch gesture while the attention of the user is directed to the respective user interface object in the environment. In some embodiments, in response to detecting the input directed to the respective user interface object, the first computer system displays the menu including the respective option in the environment, such as adjacent to, above, below, or overlaid on the representation of the content from the second computer system from the viewpoint of the user. In some embodiments, when the first computer system displays the menu that includes the respective option in the environment, the first computer system maintains display of the respective user interface object with the representation of the content from the second computer system in the environment. Alternatively, in some embodiments, when the first computer system displays the menu that includes the respective option in the environment, the first computer system ceases display of the respective user interface object in the environment. For example, the first computer system replaces display of the respective user interface object with the menu in the three-dimensional environment. In some embodiments, while the menu is displayed in the environment, the first computer system detects a selection of the respective option, such as via an air pinch gesture performed by a hand of the user while the attention of the user is directed to the respective option. In some embodiments, if the first computer system detects a selection of an option that is different from the respective option in the menu of the selectable options, the first computer system changes the simulated resolution of the representation based on the selection of the option. For example, the first computer system changes the aspect ratio of the representation to an aspect ratio corresponding to the selected option, which is optionally a different aspect ratio from the aspect ratio corresponding to the respective option above.

In some embodiments, the respective option is displayed (e.g., via the one or more display generation components) within the menu that includes the one or more selectable options, such as first option 723a, second option 723b, and/or third option 723c within the menu 722 in FIG. 7M. Displaying a respective option of a plurality of selectable options for changing a simulated resolution of the representation of content from the second computer system in the three-dimensional environment in response to detecting a selection of a user interface object displayed with the representation of content reduces the number of inputs needed to change the resolution of the representation of content from the second computer system, which avoids interrupting the use of the first computer system, and/or reduces erroneous input directed to the representation of content from the second computer system, thereby improving user-device interaction.

In some embodiments, in response to detecting the first set of one or more inputs, in accordance with a determination that the first set of one or more inputs includes a second type of input, different from the first type of input, such as interaction with first resize element 718 provided by the hand 703 as shown in FIG. 7C, the first computer system changes a size of the representation of the content from the second computer system relative to a viewpoint of a user of the first computer system in the environment, without changing the simulated resolution of the representation of the content from the second computer system in the environment (e.g., without increasing an amount of space in the representation of content that is available for displaying content items), based on the first set of one or more inputs, such as scaling the virtual object 710 as shown in FIG. 7D without changing the simulated resolution of the virtual object 710. For example, the first computer system scales and/or resizes the representation of the content from the second computer system relative to the viewpoint of the user in the environment in response to detecting the second type of input. In some embodiments, an amount that the representation of the content from the second computer system is changed in size is based on a direction and/or magnitude of the second type of input. For example, the second type of input, as discussed in more detail below, includes interaction with a scaling element and/or a respective two-handed air gesture (e.g., a two-handed air pinch gesture where both hands are concurrently performing an air pinch gesture, and where the air pinch from a first hand was optionally detected within a time threshold (e.g., 0.01, 0.05, 0.1, 0.2, 0.5, 0.75, 1, 2, 3, or 5 seconds) of detecting an air pinch from the second hand) performed by the user, both of which involve movement of one or both hands of the user (e.g., increasing or decreasing a distance between the hands of the user). In some embodiments, the direction and/or magnitude of the second type of input corresponds to a direction and/or magnitude of the movement of the hand(s) of the user. For example, if the second type of input includes movement of the hand(s) of the user (e.g., directed to the scaling element) in a first direction and/or with a first magnitude (e.g., of speed and/or distance), the first computer system resizes/scales (e.g., increases or decreases the size of) the representation in the environment relative to the viewpoint of the user by an amount that is based on or that is in accordance with the first magnitude. Resizing a representation of content from the second computer system in a three-dimensional environment, without changing a resolution of the representation, in response to detecting input corresponding to a request to resize the representation of content if the input is a second type of input helps avoid unintentional change of the resolution of the representation of content from the second computer system, which negates user input for correcting such change, and/or facilitates input for interacting with the second computer system via components of the first computer system, which avoids interrupting the use of the first computer system, thereby improving user-device interaction.

In some embodiments, the first type of input includes interaction with a first resize element associated with the representation of the content from the second computer system in the environment (e.g., as similarly discussed above), such as interaction with the second resize element 720 as shown in FIG. 7F. In some embodiments, the second type of input includes interaction with a second resize element, different from the first resize element, associated with the representation of the content from the second computer system, such as interaction with the first resize element 718 as shown in FIG. 7C. For example, the first computer system is configured to display distinct resize elements in the environment that are associated with the representation to clearly visually delineate the distinct operations associated with the resize elements. In some embodiments, as discussed in more detail below, the first resize element and the second resize element are displayed at different locations in the environment relative to the representation. Additionally, in some embodiments, the first resize element and the second resize element are displayed individually/independently in response to detecting user input, as discussed below. For example, the first resize element and the second resize element are not displayed concurrently in the environment. In some embodiments, as similarly discussed above with reference to interaction with the resize element, interacting with the first resize element or the second resize element includes a selection of the first resize element or the second resize element displayed with the representation of the content from the second computer system in the environment, optionally followed by movement of the first resize element or the second resize element in the environment. In some embodiments, as similarly discussed above, the interaction with the first resize element or the second resize element is provided via one or more air gestures performed by a hand of the user, such as an air pinch gesture while the attention of the user is directed to the first resize element or the second resize element, optionally followed by an air drag gesture. Resizing a representation of content from the second computer system in a three-dimensional environment, without changing a resolution of the representation, in response to detecting input corresponding to a request to resize the representation of content based on whether the input is a first type of input or a second type of input helps avoid unintentional change of the resolution of the representation of content from the second computer system, which negates user input for correcting such change, and/or facilitates input for interacting with the second computer system via components of the first computer system, which avoids interrupting the use of the first computer system, thereby improving user-device interaction.

In some embodiments, the first resize element is displayed at a location corresponding to an edge (e.g., a right or left side) of the representation of the content from the second computer system in the environment, such as displaying the second resize element 720 adjacent to an edge of the virtual object 710 as shown in FIG. 7E. For example, the first computer system displays the first resize element adjacent to the edge of the representation in the environment. In some embodiments, as similarly discussed above, the first computer system displays the first resize element at the location corresponding to the edge of the representation of the content from the second computer system in response to detecting the attention (e.g., including gaze) of the user directed to the edge of the representation of the content from the second computer system in the environment.

In some embodiments, the second resize element is displayed at a location corresponding to a corner (e.g., an upper or lower corner) of the representation of the content from the second computer system in the environment, such as displaying the first resize element 718 adjacent to a corner of the virtual object 710 as shown in FIG. 7B. For example, the first computer system displays the second resize element adjacent to the corner of the representation of the content from the second computer system in the environment. In some embodiments, as similarly discussed above, the first computer system displays the second resize element at the location corresponding to the corner of the representation in response to detecting the attention (e.g., including gaze) of the user directed to the corner of the representation of the content from the second computer system in the environment. Resizing a representation of content from the second computer system in a three-dimensional environment, without changing a resolution of the representation, in response to detecting input corresponding to a request to resize the representation of content based on whether the input is a first type of input or a second type of input helps avoid unintentional change of the resolution of the representation of content from the second computer system, which negates user input for correcting such change, and/or facilitates input for interacting with the second computer system via components of the first computer system, which avoids interrupting the use of the first computer system, thereby improving user-device interaction.

In some embodiments, prior to detecting the first set of one or more inputs, the representation of the content from the second computer system includes a first object, such as representation of first user interface 711a shown in FIG. 7A. For example, the first object is a user interface that is displayed in and/or included in the representation of the content from the second computer system. In some embodiments, the first object is displayed on the one or more second display generation components of the second computer system. In some embodiments, the user interface is associated with a respective application that is running on the second computer system. For example, the first computer system displays the first object in the representation of the content from the second computer system based on data provided by the second computer system corresponding to the display of the first object (e.g., the user interface).

In some embodiments, in response to detecting the first set of one or more inputs, in accordance with a determination that changing the size of the representation of the content from the second computer system relative to the viewpoint of the user corresponds to increasing the size of the representation relative to the viewpoint of the user, the first computer system increases a size of the first object in the representation of the content from the second computer system in the environment relative to the viewpoint of the user based on the first set of one or more inputs, such as increasing a size of the representation of the first user interface 711a when increasing the size of the virtual object 710 as shown in FIG. 7D. For example, as similarly discussed above, the first computer system detects interaction with the second resize element (e.g., the scaling element) that is displayed adjacent to a corner of the representation of the content from the second computer system in the environment. In some embodiments, the first computer system detects movement of the second resize element in a first direction corresponding to an increase in the size of the representation of the content from the second computer system and/or with a first magnitude (e.g., of speed and/or distance), which optionally determines the amount by which the representation of the content from the second computer system is increased in the environment relative to the viewpoint of the user. In some embodiments, when the first computer system increases the size of the representation of the content from the second computer system in the environment relative to the viewpoint of the user, the first computer system scales the representation of the content from the second computer system, including the first object that is displayed in the representation of the content from the second computer system. For example, the first computer system increases the size of the first object by an amount that is the same as or proportional to the amount that the representation of the content from the second computer system is increased in the environment relative to the viewpoint of the user. In some embodiments, the first computer system concurrently increases the sizes of the representation of the content from the second computer system and the first object in the environment relative to the viewpoint of the user. In some embodiments, as similarly discussed above, the first computer system increases the size of the first object in the environment without causing the size of the first object to increase at the second computer system (e.g., the user interface of the first object is not increased in size on the one or more second displays of the second computer system). Resizing a representation of content from the second computer system, including the content itself that is included in the representation, in a three-dimensional environment, without changing a resolution of the representation, in response to detecting input corresponding to a request to resize the representation of content if the input is a second type of input helps avoid unintentional change of the resolution of the representation of content from the second computer system, which negates user input for correcting such change, and/or facilitates input for interacting with the second computer system via components of the first computer system, which avoids interrupting the use of the first computer system, thereby improving user-device interaction.

In some embodiments, the first type of input includes selection of a respective option that is selectable to change the simulated resolution of the representation of the content from the second computer system in the environment (e.g., a selection of an aspect ratio option as similarly discussed above), such as selection of the first option 723a or the second option 723b as shown in FIG. 7M. In some embodiments, the second type of input includes an air gesture performed with a first portion (e.g., a first hand) and a second portion (e.g., a second hand) of a user of the first computer system, such as the air pinch and drag gesture provided by first hand 707 and second hand 703 as shown in FIG. 7P. For example, the second type of input includes a two-handed air gesture provided by the user of the first computer system (e.g., a two-handed air pinch gesture where both hands are concurrently performing an air pinch gesture, and where the air pinch from a first hand was optionally detected within a time threshold (e.g., 0.01, 0.05, 0.1, 0.2, 0.5, 0.75, 1, 2, 3, or 5 seconds) of detecting an air pinch from the second hand). In some embodiments, the first computer system (e.g., concurrently) detects the first portion of the user and the second portion of the user perform air pinch gestures, followed by movement of one or both of the first portion and the second portion of the user while maintaining the pinch hand shapes. In some embodiments, a direction of the movement of the first portion and/or the second portion of the user relative to each other determines whether the first computer system increases or decreases the size of the representation of the content from the second computer system in the environment in response to detecting the two-handed air gesture. For example, movement of one or both of the hands of the user that causes the hands to be farther apart relative to the viewpoint of the user after detecting the air pinch gestures from the two hands causes the first computer system to increase the size of the representation of the content from the second computer system in the environment relative to the viewpoint of the user, whereas movement of one or both of the hands of the user that causes the hands to be closer together relative to the viewpoint of the user after detecting the air pinch gestures from the two hands causes the first computer system to decrease the size of the representation of the content from the second computer system in the environment relative to the viewpoint of the user. In some embodiments, a magnitude (e.g., of speed and/or distance) of the movement of the hand(s) of the user apart or closer together determines an amount by which the size of the representation of content from the second computer system is changed in the environment relative to the viewpoint of the user. For example, if the first computer system detects the first hand of the user and/or the second hand of the user move (e.g., closer together or farther apart) by a first magnitude (e.g., a first net/total magnitude), the first computer system changes the size of the representation of content from the second computer system by a first amount in the environment relative to the viewpoint of the user, and if the first computer system detects the first hand of the user and/or the second hand of the user move by a second magnitude (e.g., a second net/total magnitude), smaller than the first magnitude, the first computer system changes the size of the representation of the content from the second computer system by a second amount, smaller than the first amount, in the environment relative to the viewpoint of the user. In some embodiments, in response to detecting a release of the air gesture by one or both of the first portion and the second portion of the user, the first computer system ceases and/or concludes changing the size of the representation of the content from the second computer system in the environment relative to the viewpoint of the user. Resizing a representation of content from the second computer system in a three-dimensional environment, without changing a resolution of the representation, in response to detecting input corresponding to a request to resize the representation of content based on whether the input is a selection of a respective option or a two-handed air gesture helps avoid unintentional change of the resolution of the representation of content from the second computer system, which negates user input for correcting such change, and/or facilitates input for interacting with the second computer system via components of the first computer system, which avoids interrupting the use of the first computer system, thereby improving user-device interaction.

In some embodiments, prior to (e.g., and/or when) detecting the first set of one or more inputs, the representation of the content from the second computer system includes a first object (e.g., a user interface or other content as similarly discussed above) having a first size from a current viewpoint of a user of the computer system, such as the representation of the first user interface 711a in FIG. 7F. For example, when the first computer system detects the first set of one or more inputs discussed above, the first object occupies a first amount/portion of the representation of the content from the second computer system in the environment from the viewpoint of the user. In some embodiments, the first size of the first object in the representation of the content from the second computer system is dictated by the second computer system. For example, the first computer system displays the first object at the first size in the representation of the content from the second computer system based on display data provided by the second computer system (e.g., the first amount/portion of the representation of the content from the second computer system that is occupied by the first object in the representation of the content from the second computer system corresponds to and/or is proportional to an amount/portion of a display area of the one or more second display generation components in which the user interface of the first object is displayed by the second computer system). In some embodiments, the first object is displayed at the first size in the representation of the content from the second computer system in response to detecting prior input provided by the user (e.g., a resizing input) directed to the first object for displaying the first object at the first size in the representation of the content from the second computer system from the current viewpoint of the user.

In some embodiments, increasing the amount of space in the representation of content that is available for displaying content items includes maintaining display of the first object at the first size in the representation of the content from the second computer system from the current viewpoint of the user of the computer system, such as maintaining the size of the representation of the first user interface 711a as shown from FIG. 7F to FIG. 7G. For example, when the first computer system changes the simulated resolution of the representation of the content from the second computer system in accordance with the determination that the first set of one or more inputs includes the first type of input in response to detecting the first set of one or more inputs, the first computer system maintains display of the first object at the first size in the representation of the content from the second computer system in the environment from the current viewpoint of the user. In some embodiments, if the representation of the content from the second computer systems includes and/or contains additional objects, such as a second object having a second size, the first computer system maintains display of the additional objects at their respective sizes within the representation of the content from the second computer system when the simulated resolution of the representation of the content from the second computer system is changed in the environment. Maintaining a size of a content item that is included in a representation of content from the second computer system in a three-dimensional environment when changing a resolution of the representation in the three-dimensional environment helps avoid unintentional resizing of the content item in the representation of content from the second computer system, which negates user input for correcting such change, and/or facilitates input for interacting with the content of the second computer system via components of the first computer system, which avoids interrupting the use of the first computer system, thereby improving user-device interaction.

In some embodiments, prior to (e.g., and/or when) detecting the first set of one or more inputs, the representation of the content from the second computer system includes a first object (e.g., a user interface or other content as similarly discussed above) at a first location (e.g., and/or is displayed at a first size as similarly discussed above) in the representation of the content from the second computer system, such as the representation of the first user interface 711a in FIG. 7O. For example, when the first computer system detects the first set of one or more inputs discussed above, the first object is positioned at a first location within the representation of the content from the second computer system in the environment from the viewpoint of the user. In some embodiments, the first location of the first object in the representation of the content from the second computer system is dictated by the second computer system. For example, the first computer system displays the first object at the first size in the representation of the content from the second computer system based on display data provided by the second computer system (e.g., the first amount/portion of the representation of the content from the second computer system that is occupied by the first object in the representation of the content from the second computer system corresponds to and/or is proportional to an amount/portion of a display area of the one or more second display generation components in which the user interface of the first object is displayed by the second computer system). In some embodiments, the first object is displayed at the first location in the representation of the content from the second computer system in response to detecting prior input provided by the user (e.g., a movement input) directed to the first object for displaying the first object at the first location in the representation of the content from the second computer system from the viewpoint of the environment.

In some embodiments, changing the simulated resolution of the representation of the content includes displaying the first object at a second location, different from the first location, in the representation of the content from the second computer system without increasing a size of the first object in the representation of the content from the second computer system from a current viewpoint of a user of the computer system, such as shifting the representation of the first user interface 711a in the virtual object 710 as shown from FIG. 7O to FIG. 7P. For example, when the first computer system changes the simulated resolution of the representation of the content from the second computer system in accordance with the determination that the first set of one or more inputs includes the first type of input in response to detecting the first set of one or more inputs, the first computer system moves the first object within the representation of the content from the second computer system from the first location to the second location from the current viewpoint of the user, while maintaining display of the first object at the first size in the representation of the content from the second computer system in the environment. In some embodiments, moving the first object to the second location in the representation of the content from the second computer system accommodates and/or enables the first object to remain displayed at the same size and/or to remain visible in the representation of the content from the second computer system after the simulated resolution of the representation of the content from the second computer system is changed. For example, if changing the simulated resolution of the representation of the content from the second computer system causes the location of the first object to change relative to the viewpoint of the user, the first computer moves the first object within the representation of the content from the second computer system to maintain the first object at the same location in the environment relative to the current viewpoint of the user. In some embodiments, if the representation of the content from the second computer systems includes and/or contains additional objects, such as a second object having a second size, the first computer system optionally moves the additional objects within the representation of the content from the second computer system while maintaining display of the additional objects at their respective sizes within the representation of the content from the second computer system when the simulated resolution of the representation of the content from the second computer system is changed in the environment. In some embodiments, as similarly discussed above, the first computer system moves the first object to the second location in the representation of the content from the second computer system from the viewpoint of the user without causing the second computer system to move and/or update display of the user interface included in the first object that is displayed via the one or more second display generation components of the second computer system. Moving a content item within a representation of content from the second computer system while maintaining a size of the content item in the representation of content from the second computer system in a three-dimensional environment when changing a resolution of the representation in the three-dimensional environment helps avoid unintentional resizing of the content item in the representation of content from the second computer system, which negates user input for correcting such change, and/or facilitates input for interacting with the content of the second computer system via components of the first computer system, which avoids interrupting the use of the first computer system, thereby improving user-device interaction.

In some embodiments, prior to (e.g., and/or when) detecting the first set of one or more inputs, the representation of the content from the second computer system includes a first object having a first size from a current viewpoint of a user of the computer system (e.g., as similarly discussed above), such as the representation of the first user interface 711a in FIG. 7T. In some embodiments, changing the simulated resolution of the representation of the content in accordance with the determination that the first set of one or more inputs includes the first type of input corresponds to decreasing the simulated resolution of the representation, such as decreasing the simulated resolution of the virtual object 710 as shown in FIG. 7U. For example, the first computer system decreases the amount of space in the representation of content that is available for displaying content items.

In some embodiments, in accordance with a determination that the first size of the first object is greater than a threshold size associated with the amount of space in the representation of the content from the second computer system that is available for displaying content items, the first computer system displays the first object at a second size from the current viewpoint of the user of the computer system, smaller than the first size, that is within the threshold size in the representation of the content from the second computer system, such as decreasing the size of the representation of the first user interface 711a in the virtual object 710 as shown in FIG. 7U. In some embodiments, the threshold size associated with the amount of space in the representation of the content from the second computer system that is available for displaying content items is based on the size of the representation of the content from the second computer system in the environment. For example, as similarly discussed above, the representation of the content from the second computer system corresponds to a virtual instance of the second computer system and therefore includes a virtual display including the first object. In some embodiments, the threshold size corresponds to a size of the virtual display of the representation of the content from the second computer system. In some embodiments, the threshold size corresponds to a proportion (e.g., 10, 30, 50, or 75%) of the size of the virtual display of the representation of the content from the second computer system to the amount of space in the representation of the content from the second computer system that is available for displaying content items. In some embodiments, the amount of space in the representation of the content from the second computer system that is available for displaying the content items corresponds to the size of the virtual display minus the first size of the first object. In some embodiments, if decreasing the simulated resolution of the representation of the content from the second computer system causes the first size of the first object to exceed the threshold size, which is based on and/or corresponds to the decreased amount of space in the representation of the content from the second computer system that is available for displaying content items, the first computer system decreases the size of the first object to stay within the threshold size in the representation of the content from the second computer system. For example, the first computer system decreases the size of the first object in the representation of the content from the second computer system to maintain visibility and/or display of the first object in the representation of the content from the second computer system from the current viewpoint of the user in the environment. In some embodiments, the second size of the first object causes the first object to occupy a same amount/portion of the representation of the content from the second computer system as the first size of the first object in the representation of the content from the second computer system prior to detecting the first set of one or more inputs.

In some embodiments, in accordance with a determination that the first size of the first object is within the threshold size, the first computer system maintains display of the first object at the first size in the representation of the content from the second computer system from the current viewpoint of the user of the computer system, such as maintaining the size of the representation of the first user interface 711a in the virtual object 710 from FIG. 7M to FIG. 7N. For example, decreasing the simulated resolution of the representation of the content from the second computer system does not cause the first size of the first object to exceed the threshold size because the decreased amount of space in the representation of the content from the second computer system that is available for displaying content items still accommodates display of the first object at the first size. Decreasing a size of a content item that is included in a representation of content from the second computer system in a three-dimensional environment when decreasing a resolution of the representation in the three-dimensional environment if the current size of the first object is larger than a threshold size associated with the updated resolution of the representation enables the content item to automatically remain displayed and/or visible in the representation when the resolution is decreased and/or facilitates input for interacting with the content of the second computer system via components of the first computer system, which avoids interrupting the use of the first computer system, thereby improving user-device interaction.

In some embodiments, in response to detecting the first set of one or more inputs, in accordance with a determination that the first set of one or more inputs includes a second type of input (e.g., the second type of input described above, such as input resizing/scaling the representation of the content from the second computer system), different from the first type of input, such as the double pinch gesture provided by the hand 703 as shown in FIG. 7O, the first computer system decreases a size of the representation of the content from the second computer system (e.g., without changing/decreasing an amount of space in the representation of content that is available for displaying content items) and decreases a size of the first object based on the first set of one or more inputs, such as decreasing the sizes of the virtual object 710 and the representation of the first user interface 711a as shown in FIG. 7P. For example, as similarly discussed above, the first computer system resizes/scales the representation of the content from the second computer system and the first object in the environment in accordance with the second type of input. In some embodiments, the first computer system decreases the size of the first object irrespective of whether the first size of the first object is greater than or less than the threshold size associated with the amount of space in the representation of the content from the second computer system that is available for displaying content items when the size of the representation of the content from the second computer system is decreased. Specifically, the threshold size is applicable when changing the resolution of the representation of the content from the second computer system, which is performed when the first computer system detects the first type of input, as discussed above. Decreasing a size of a content item that is included in a representation of content from the second computer system in a three-dimensional environment when decreasing a size of the representation in the three-dimensional environment irrespective of whether the current size of the first object is larger than a threshold size associated with a resolution of the representation enables the content item to be automatically resized when the size of the representation is decreased and/or facilitates input for interacting with the content of the second computer system via components of the first computer system, which avoids interrupting the use of the first computer system, thereby improving user-device interaction.

In some embodiments, changing the simulated resolution of the representation of the content from the second computer system includes changing an aspect ratio of the representation of the content from the second computer system in the environment (e.g., as similarly described above), such as increasing the aspect ratio of the virtual object 710 as shown in FIG. 7G. For example, the first computer system changes a ratio of the width to the height of the representation of the content from the second computer system in the environment. In some embodiments, increasing the simulated resolution of the representation of the content from the second computer system corresponds to increasing the aspect ratio of the representation of the content from the second computer system, and decreasing the simulated resolution of the representation of the content from the second computer system corresponds to decreasing the aspect ratio of the representation of the content from the second computer system in the environment. Changing an aspect ratio of a representation of content from the second computer system in a three-dimensional environment in response to detecting input corresponding to a request to resize the representation of content based on whether the input is a first type of input reduces the number of inputs needed to change the aspect ratio of the representation of content from the second computer system and/or facilitates input for interacting with the second computer system via components of the first computer system, which avoids interrupting the use of the first computer system, thereby improving user-device interaction.

In some embodiments, while changing the simulated resolution of the representation of the content from the second computer system based on the first set of one or more inputs (and/or while detecting the first set of one or more inputs) in accordance with the determination that the first set of one or more inputs includes the first type of input in response to detecting the first set of one or more inputs (e.g., and before detecting termination of the first set of one or more inputs), the first computer system reduces a visual fidelity of the representation of the content from the second computer system in the environment, such as reducing the visual fidelity of the virtual object 710 while increasing the simulated resolution of the virtual object 710 as shown in FIG. 7I. For example, the first computer system applies a fading effect to the representation of the content from the second computer system, including any content/objects displayed within the representation (e.g., such as the first object discussed above), during the changing of the simulated resolution of the representation of the content from the second computer system in the environment. In some embodiments, reducing the visual fidelity of the representation of the content from the second computer system includes increasing a translucency of the representation of the content from the second computer system, including any content/objects displayed within the representation (e.g., such as the first object discussed above), in the environment, such that, during the change of the simulated resolution of the representation of the content from the second computer system, portions of the environment (e.g., including a physical environment of the first computer system) are visible through the representation of the content from the second computer system from the viewpoint of the user. In some embodiments, reducing the visual fidelity of the representation of the content from the second computer system includes decreasing a brightness of the representation of the content from the second computer system, including any content/objects displayed within the representation (e.g., such as the first object discussed above). In some embodiments, reducing the visual fidelity of the representation of the content from the second computer system includes blurring the representation, including any content/objects displayed within the representation (e.g., such as the first object discussed above). In some embodiments, reducing the visual fidelity of the representation of the content from the second computer system includes (e.g., temporarily) ceasing display of the representation of the content from the second computer system and/or any content/objects displayed within the representation (e.g., such as the first object discussed above) in the environment. Reducing a visual fidelity of a representation of content from the second computer system within a three-dimensional environment during the changing of the resolution of the representation in the three-dimensional environment in response to detecting an input corresponding to a request to resize the representation in the three-dimensional environment helps promote user comfort by avoiding eye strain and/or discomfort associated with the change in the resolution of the representation in the three-dimensional environment, thereby improving user-device interaction.

In some embodiments, in response to detecting termination of the first set of one or more inputs, the first computer system increases the visual fidelity of the representation of the content from the second computer system in the environment, such as increasing the visual fidelity of the virtual object 710 in response to detecting termination of the input provided by the hand 703 as shown in FIG. 7J. For example, the first computer system restores display of the representation of the content from the second computer system in the environment after conclusion of the change in the simulated resolution of the representation of the content from the second computer system. In some embodiments, the first computer system reverses the reduction of the visual fidelity of the representation of the content from the second computer system in response to detecting termination of the first set of one or more inputs. For example, if the first set of one or more inputs includes an air gesture, such as an air pinch and drag gesture, provided by a hand of the user, the first computer system reverses the application of the visual effect after detecting a release of the air pinch gesture by the hand. In some embodiments, the first computer system increases the visual fidelity of the representation of the content from the second computer system after the simulated resolution of the representation of the content from the second computer system is changed (e.g., after the increase or decrease in the simulated resolution of the representation of the content from the second computer system completes in response to the first computer system detecting the first type of input). In some embodiments, increasing the visual fidelity of the representation of the content from the second computer system includes increasing the opacity of the representation of the content from the second computer system, including any content/objects displayed within the representation (e.g., such as the first object discussed above), in the environment. In some embodiments, increasing the visual fidelity of the representation of the content from the second computer system includes increasing the brightness of the representation of the content from the second computer system, including any content/objects displayed within the representation (e.g., such as the first object discussed above), in the environment. In some embodiments, increasing the visual fidelity of the representation of the content from the second computer system includes unblurring the representation, including any content/objects displayed within the representation (e.g., such as the first object discussed above), in the environment. In some embodiments, increasing the visual fidelity of the representation of the content from the second computer system includes redisplaying the representation and/or any content/objects displayed within the representation (e.g., such as the first object discussed above) in the environment. Increasing a visual fidelity of a representation of content from the second computer system within a three-dimensional environment after the changing of the resolution of the representation in the three-dimensional environment in response to detecting an input corresponding to a request to resize the representation in the three-dimensional environment helps promote user comfort by avoiding eye strain and/or discomfort associated with the change in the resolution of the representation in the three-dimensional environment and/or facilitates discovery that the change in the simulated resolution is complete, thereby improving user-device interaction.

In some embodiments, prior to (e.g., and/or when) detecting the first set of one or more inputs, a value of the simulated resolution of the representation of the content from the second computer system is a first value, such as the simulated resolution of the virtual object 710 in FIG. 7F. For example, when the first computer system detects the first set of one or more inputs, the representation of the content from the second computer system is displayed with a first aspect ratio and/or with a first amount of space in the representation of content that is available for displaying content items. In some embodiments, the first value of the simulated resolution of the representation of the content from the second computer system corresponds to an initial (e.g., default) simulated resolution of the representation of the content from the second computer system, such as when the representation of the content from the second computer system is first/initially displayed in the environment. In some embodiments, the first value of the simulated resolution of the representation of the content from the second computer system corresponds to a user-selected simulated resolution, such as in response to detecting prior input provided by the user (e.g., input corresponding to a request to change the size of the representation of the content from the second computer system, such as similarly discussed above with reference to the first set of one or more inputs).

In some embodiments, changing the simulated resolution of the representation of the content from the second computer system based on the first set of one or more inputs includes changing the value of the simulated resolution to a second value, different from the first value, in accordance with the first set of one or more inputs, such as the simulated resolution of the virtual object 710 in FIG. 7G that corresponds to the movement of the second resize element 720. For example, the first computer system continuously (e.g., smoothly) changes the simulated resolution of the representation of the content from the second computer system through a range of values for the simulated resolution of the representation of the content from the second computer system. In some embodiments, the second value of the simulated resolution of the representation of the content from the second computer system includes a second aspect ratio and/or a second amount of space in the representation of content that is available for displaying content items. In some embodiments, the second value of the simulated resolution of the representation of the content from the second computer system directly corresponds to and/or is directly determined according to the first set of one or more inputs. For example, as similarly discussed above, the first set of one or more inputs that includes the first type of input includes interaction with a resize element associated with the representation. Accordingly, in some embodiments, the second value of the simulated resolution is determined according to the respective direction and/or magnitude (e.g., of speed and/or direction) with which the resize element is moved by the user in the environment. For example, if the resize element is moved by a first magnitude (e.g., of speed and/or distance) and/or in a first direction in the environment in response to detecting the first set of one or more inputs, the first computer system changes the value of the simulated resolution from the first value to the second value that corresponds to and/or is (optionally directly) proportional to the first magnitude and/or the first direction of the movement of the resize element. Changing a resolution of a representation of content from the second computer system in a three-dimensional environment to a value that is determined based on the input corresponding to a request to resize the representation of content provides the user with increased control over the particular value of the simulated resolution to which the simulated resolution is changed in the environment, thereby improving user-device interaction.

In some embodiments, prior to (e.g., and/or when) detecting the first set of one or more inputs, a value of the simulated resolution of the representation of the content from the second computer system is a first value, such as the simulated resolution of the virtual object 710 in FIG. 7U. For example, when the first computer system detects the first set of one or more inputs, the representation of the content from the second computer system is displayed with a first aspect ratio and/or with a first amount of space in the representation of content that is available for displaying content items, as similarly discussed above.

In some embodiments, changing the simulated resolution of the representation of the content from the second computer system based on the first set of one or more inputs includes changing the value of the simulated resolution to a respective value of a set of values of simulated resolution (e.g., a set of discrete/predefined values of simulated resolution), such as the values of simulated resolution indicated by options 723a-723c in FIG. 7M. In some embodiments, in accordance with a determination that the first set of one or more inputs corresponds to a request to change the value to a first respective value that is within a threshold of (e.g., is closest to or is equal to, such as being within 3, 5, 10, 15 or 30% of) a second value in the set of values, the respective value is the second value. In some embodiments, in accordance with a determination that the first set of one or more inputs corresponds to a request to change the value to a second respective value that is within the threshold of (e.g., is closest to or is equal to) a third value, different from the second value, in the set of values, the respective value is the third value, such as the movement of the second resize element 720 provided by the hand 703 in FIG. 7V being within the threshold of the simulated resolution of the virtual object 710 shown in FIG. 7W. For example, the first computer system selects the value of the simulated resolution of the representation of the content from the second computer system from a set of discrete values of simulated resolution of the representation of the content from the second computer system based on the first set of one or more inputs. In some embodiments, the second value of the simulated resolution of the representation of the content from the second computer system includes a second aspect ratio and/or a second amount of space in the representation of content that is available for displaying content items. In some embodiments, the third value of the simulated resolution of the representation of the content from the second computer system includes a third aspect ratio and/or a third amount of space in the representation of content that is available for displaying content items. In some embodiments, the first computer system selects a particular value from the set of values, such as the second value or the third value above, based on a value to which the change in the simulated resolution of the representation of the content from the second computer system according to the first set of one or more inputs is closest to (e.g., within the threshold of). For example, if the first set of one or more inputs that includes the first type of input corresponds to a request to change the simulated resolution of the representation of the content from the second computer system to a first respective value, and the first respective value is closest to or is equal to the second value, the first computer system displays the representation of the content from the second computer system with the second value of the simulated resolution. In some embodiments, if the first respective value is closest to or is equal to the third value, the first computer system displays the representation of the content from the second computer system with the third value of the simulated resolution in the environment. Accordingly, in some embodiments, the first computer system does not select a value for the simulated resolution of the representation of the content from the second computer system directly in accordance with the magnitude (e.g., of speed and/or distance) of movement associated with the first set of one or more inputs, such as the magnitude of the movement of the resize element as discussed above and/or the magnitude of the movement of the hand(s) of the user as discussed above. Rather, as discussed above, the first computer system optionally selects the value for the simulated resolution of the representation of the content from the second computer system based on the magnitude of the movement associated with the first set of one or more inputs relative to the set of values of simulated resolution. Changing a resolution of a representation of content from the second computer system in a three-dimensional environment to a value that is selected from a set of discrete values based on the input corresponding to a request to resize the representation of content reduces the number of inputs needed to display the representation with a particular value of the simulated resolution in the environment, thereby improving user-device interaction.

In some embodiments, prior to detecting the first set of one or more inputs, a respective portion of the representation of the content from the second computer system (e.g., one side or one surface of the representation) has a first amount of curvature, such as the curvature of the surface of the virtual object 710 as shown in FIG. 7F. In some embodiments, displaying the respective portion of the representation of the content from the second computer system with the first amount of curvature has one or more characteristics of displaying virtual objects with a first amount of curvature as described with reference to method 900.

In some embodiments, in response to detecting the first set of one or more inputs, in accordance with a determination that the representation of the content from the second computer system has a first size (e.g., a first length and/or width, such as a first area and/or a first aspect ratio) in the environment relative to a viewpoint of a user of the first computer system, such as the size of the virtual object 710 relative to the viewpoint of the user 702 in FIG. 7G, the first computer system changes a curvature of the respective portion of the representation of the content from the second computer system from the first amount of curvature to a second amount of curvature that is different from the first amount of curvature, such as increasing the curvature of the surface of the virtual object 710 as shown in FIG. 7G. For example, the first computer system changes the curvature of the representation of the content from the second computer system, including any objects/content displayed in the representation (e.g., such as the first object discussed above), in the environment based on the size of the representation of the content from the second computer system relative to the viewpoint of the user. For example, if resizing the representation of the content from the second computer system in response to detecting the first set of one or more inputs causes the size of the representation to increase (e.g., to the first size), the first computer system increases the curvature of the representation of the content from the second computer system in the environment (e.g., to the second amount of curvature). In some embodiments, if resizing the representation of the content from the second computer system in response to detecting the first set of one or more inputs causes the size of the representation to decrease (e.g., to the first size), the first computer system decreases the curvature of the representation of the content from the second computer system in the environment (e.g., to the second amount of curvature). In some embodiments, the first computer system concurrently changes the curvature of the representation of the content from the second computer system while changing the simulated resolution of the representation in the environment in response to detecting the first set of one or more inputs (e.g., in accordance with the determination that the first set of one or more inputs includes the first type of input as previously discussed above). In some embodiments, in response to detecting the first set of one or more inputs, in accordance with a determination that the representation of the content from the second computer system has a second size (e.g., a second length and/or width, such as a second area and/or a second aspect ratio) in the environment relative to the viewpoint of the user of the first computer system, the first computer system changes the curvature of the representation of the content from the second computer system from the first amount of curvature to a third amount of curvature, different from the first amount of curvature and the second amount of curvature. In some embodiments, changing the curvature of the respective portion of the representation of the content from the second computer system based on the size of the representation relative to the viewpoint of the user has one or more characteristics of changing the curvature of virtual objects based on the size of the virtual objects relative to the viewpoint of the user as described with reference to method 900. Changing a curvature of a surface of a representation of content from a second computer system in a three-dimensional environment when changing a size of the representation based on the size of the representation relative to the viewpoint of the user enables content included on the surface of the representation to remain visibly displayed in the three-dimensional environment for larger sizes of the representation relative to the viewpoint of the user and/or enables the curvature of the surface of the representation to be changed automatically for given user input the adjusts the size of the representation relative to the viewpoint of the user, thereby improving user-device interaction.

In some embodiments, the determination that the representation of the content from the second computer system has the first size relative to the viewpoint of the user is based on a determination that the representation of the content from the second computer system occupies a first amount of a field of view (e.g., a viewport) of the user in the environment from the viewpoint of the user, such as the amount of the field of view of the user 702 occupied by the virtual object 710 in FIG. 7G. For example, the amount of the field of view of the user that the representation of the content from the second computer system occupies is based on a width of the representation in the environment, such as an aspect ratio of the representation and/or a scale (e.g., including magnification) of the representation of the content from the second computer system. In some embodiments, the greater amount of the field of view of the user that the representation of the content from the second computer system occupies from the viewpoint of the user, the greater the amount of curvature of the representation of the content from the second computer system in the environment. In some embodiments, the field of view of the user in the environment corresponds to a physical range of human vision of the user (e.g., a field of view as determined by one or both eyes of the user). Accordingly, in some embodiments, the representation of the content from the second computer system occupying the first amount of the field of view of the user corresponds to the representation of the content from the second computer system occupying a first amount of the range of vision of the user in one or more dimensions. In some embodiments, the field of view of the user in the environment corresponds to an angular field of view of one or more cameras in communication with the display generation component for display generation components having virtual passthrough, while the field of view of the user in the environment corresponds to an angular field of view of the user through partially or fully transparent portions of the display generation component for display generation components having optical passthrough. In some embodiments, changing the curvature of the representation of the content from the second computer system based on the amount of the field of view of the user that the representation of the content from the second computer system occupies has one or more characteristics of changing curvature of virtual objects based on the amount of the field of view of the user that the virtual objects occupy as described with reference to method 900. Changing a curvature of a surface of a representation of content from a second computer system in a three-dimensional environment when changing a size of the representation based on the amount of the field of view of the user occupied by the representation from the viewpoint of the user enables content included on the surface of the representation to remain visibly displayed in the three-dimensional environment for greater occupancies of the representation in the field of view of the user and/or enables the curvature of the surface of the representation to be changed automatically for given user input the adjusts the occupancy of the representation in the field of view of the user, thereby improving user-device interaction.

It should be understood that the particular order in which the operations in method 800 have been described is merely exemplary and is not intended to indicate that the described order is the only order in which the operations could be performed. One of ordinary skill in the art would recognize various ways to reorder the operations described herein. In some embodiments, aspects/operations of method 800 may be interchanged, substituted, and/or added between these methods. For example, various object manipulation techniques and/or object movement techniques of method 800 is optionally interchanged, substituted, and/or added between these methods. For brevity, these details are not repeated here.

FIG. 9 is a flowchart illustrating an exemplary method 900 of facilitating changing a curvature of a virtual object based on a size of the virtual object relative to a viewpoint of a user in a three-dimensional environment in accordance with some embodiments. In some embodiments, the method 900 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 900 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 900 are, optionally, combined and/or the order of some operations is, optionally, changed.

In some embodiments, method 900 is performed at a computer system (e.g., computer system 101 in FIG. 7A) in communication with one or more display generation components (e.g., display generation component 120) and one or more input devices (e.g., image sensors 114a-114c). In some embodiments, the computer system has one or more of the characteristics of the computer system of method 800. In some embodiments, the one or more display generation components have one or more of the characteristics of the one or more display generation components of method 800. In some embodiments, the one or more input devices have one or more of the characteristics of the one or more input devices of method 800.

In some embodiments, while displaying, via the one or more display generation components, a virtual object (e.g., generated by the computer system) in an environment (e.g., a three-dimensional environment), such as virtual object 710 in three-dimensional environment 700 in FIG. 7A, wherein a respective portion of the virtual object (e.g., one side or one surface of the virtual object) has a first amount of curvature, such as the curvature of the surface of the virtual object 710 in FIG. 7A, the computer system detects (902), via the one or more input devices, a first set of one or more inputs corresponding to a request to initiate a process to adjust one or more spatial properties of the virtual object in the environment, such as interaction with second resize element 720 provided by hand 703 as shown in FIG. 7F. In some embodiments, the three-dimensional environment has one or more of the characteristics of the three-dimensional environment described with reference to the method 800. In some embodiments, the virtual object is generated by the computer system and/or is or includes content, such as a window of a web browsing application displaying content (e.g., text, images, or video), a window displaying a photograph or video clip, a media player window for controlling playback of content items on the computer system, a contact card in a contacts application displaying contact information (e.g., phone number email address, and/or birthday) and/or a virtual boardgame of a gaming application. In some embodiments, the virtual object is or includes a representation of content from a second computer system that is optionally visible in the field of view of the user in the environment. For example, the virtual object is a virtual instance of the second computer system, as similarly discussed with reference to method 800. In some embodiments, the second computer system has one or more characteristics of the second computer system in method 800. In some embodiments, the one or more spatial properties of the virtual object include a location, a size, and/or an orientation of the virtual object in the environment relative to a viewpoint of the user. For example, the virtual object is displayed at a first location in the three-dimensional environment that is in the field of view of the user of the computer system from a current viewpoint of the user in the three-dimensional environment. Additionally, in some embodiments, the virtual object is displayed at a first size and/or with a first orientation in the three-dimensional environment from the current viewpoint of the user.

In some embodiments, detecting the first set of one or more inputs includes detecting an air pinch gesture performed by a hand of the user of the computer system—such as the thumb and index finger of the hand of the user starting more than a threshold distance (e.g., 0.1, 0.2, 0.5, 1, 2, or 5 cm) apart and coming together and touching at the tips—that is directed toward the virtual object, such as the air pinch gesture 703 as shown in FIG. 7F. For example, the computer system detects an input corresponding to a request to move the virtual object relative to the viewpoint of the user in the three-dimensional environment. In some embodiments, the first set of one or more inputs includes movement of the hand of the user in space relative to the viewpoint of the user while maintaining the air pinch gesture (e.g., the first set of one or more inputs includes an air pinch and drag gesture). In some embodiments, the computer system detects the air pinch gesture directed toward a movement element (e.g., a grabber or handlebar element) associated with the virtual object that is selectable to initiate movement of the virtual object in the three-dimensional environment. In some embodiments, the first set of one or more inputs includes and/or corresponds to a request to change a size of the virtual object in the environment relative to the viewpoint of the user. For example, the computer system detects an air gesture provided by the hand of the user directed to a resize affordance that is displayed with the virtual object, such as the resizing affordances described in method 800. In some embodiments, the resize affordance is displayed adjacent to and/or at a corner or side/edge of the virtual object in the three-dimensional environment. In some embodiments, the first set of one or more inputs includes movement of the resize affordance in the three-dimensional environment, such as via an air pinch and drag gesture provided by the hand of the user. In some embodiments, the first set of one or more inputs includes and/or corresponds to a selection of a resize option that is displayed with the virtual object in the environment. For example, the computer system detects an air pinch gesture provided by a hand of the user directed toward a resize option that is selectable to designate/select a simulated resolution (e.g., an aspect ratio) of the virtual object, such as the resizing options discussed with reference to method 800. In some embodiments, the first set of one or more inputs has one or more characteristics of the inputs discussed in method 800.

In some embodiments, in response to detecting the first set of one or more inputs (904), in accordance with a determination that the virtual object has a first size (e.g., a first length and/or width, such as a first area and/or a first aspect ratio) in the environment relative to a viewpoint of a user of the computer system, such as the size of the virtual object 710 in the three-dimensional environment 700 relative to the viewpoint of the user 702, the computer system changes (906) a curvature (e.g., a two-dimensional front-facing surface) of the respective portion of the virtual object from the first amount of curvature to a second amount of curvature that is different from the first amount of curvature, such as increasing the curvature of the surface of the virtual object 710 as shown in FIG. 7G. For example, the computer system updates one or more spatial properties of the virtual object, including changing a curvature of a front-facing surface of the virtual object based on the size of the virtual object relative to the viewpoint of the user in the three-dimensional environment. In some embodiments, the first set of one or more inputs described above does not correspond to or include a request to specifically change the curvature of the virtual object in the environment. For example, the first set of one or more inputs does not include a designation/selection of a curvature of the virtual object (e.g., the computer system selectively automatically changes the curvature of the virtual object when changing the one or more spatial properties of the virtual object in the environment). In some embodiments, changing the curvature of the surface of the virtual object corresponds to bending/curling the surface of the virtual object, such that the surface visually appears to curve inward at a center of the surface, producing a concave shape relative to the viewpoint of the user. In some embodiments, the computer system concurrently changes the curvature of the surface of the virtual object while updating one or more other spatial properties of the virtual object, such as the location, size, and/or orientation of the virtual object relative to the viewpoint of the user in the three-dimensional environment. In some embodiments, the surface of the virtual object is a surface on/in which content is displayed in the environment relative to the viewpoint of the user. For example, if the virtual object is a virtual instance of a second computer system as similarly discussed above, the representation of the content of the second computer system is displayed on/in the surface. Accordingly, in some embodiments, when the computer system changes the curvature of the surface of the virtual object in response to detecting the first set of one or more inputs, the computer system changes a curvature of the content that is displayed on/in the surface of the virtual object. For example, if the virtual object is or includes a user interface (e.g., a virtual window) that is displayed on the surface of the virtual object, when the computer system changes the curvature of the surface of the virtual object, the computer system changes the curvature of the user interface that is displayed on the surface (e.g., by a same or proportional amount). In some embodiments, when the surface of the virtual object is curved in the environment in response to detecting the first set of one or more inputs, a vector extending from the viewpoint of the user is normal to or is nearly normal to (e.g., any) point on the surface of the virtual object. Changing a curvature of a surface of a virtual object in a three-dimensional environment when changing one or more visual characteristics of the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that adjusts the size of the virtual object relative to the viewpoint of the user, thereby improving user-device interaction.

In some embodiments, in response to detecting the first set of one or more inputs, the computer system changes the one or more spatial properties of the virtual object in the environment based on the first set of one or more inputs, such as increasing an aspect ratio of the virtual object 710 as shown in FIG. 7G. For example, the computer system updates a location, a size, and/or an orientation of the virtual object in the three-dimensional environment in accordance with the first set of one or more inputs. In some embodiments, changing the one or more spatial properties of the virtual object includes moving the virtual object relative to the viewpoint of the user in the environment in accordance with the first set of one or more inputs (e.g., in accordance with the movement of the hand of the user). In some embodiments, changing the one or more spatial properties of the virtual object includes changing (e.g., increasing or decreasing) the size of the virtual object in the environment, such as in accordance with the movement of the resizing affordance discussed above. In some embodiments, changing the one or more spatial properties of the virtual object includes changing (e.g., increasing or decreasing) the aspect ratio of the virtual object in the environment, such as in accordance with the movement of the resizing affordance or the selection of the resizing option discussed above. In some embodiments, changing the one or more spatial properties of the virtual object includes rotating (e.g., tilting) the virtual object in the environment from the viewpoint of the user, such as when the virtual object is moved (e.g., laterally and/or vertically) in the environment, to allow a portion (e.g., front-facing surface) of the virtual object to remain facing toward the location of the viewpoint of the user in the environment. As discussed above, the computer system optionally (e.g., concurrently) changes the one or more spatial properties of the virtual object when changing the curvature of the virtual object in the environment. Changing a curvature of a surface of a virtual object in a three-dimensional environment when changing one or more visual characteristics of the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that adjusts the size of the virtual object relative to the viewpoint of the user, thereby improving user-device interaction.

In some embodiments, in response to detecting the first set of one or more inputs, in accordance with a determination that the virtual object has a second size (e.g., a second length and/or width, such as a second area and/or a second aspect ratio), different from the first size, in the environment relative to the viewpoint of the user, such as the size of the virtual object 710 relative to the viewpoint of the user 702 in FIG. 7J, the computer system changes the curvature of the respective portion of the virtual object from the first amount of curvature to a third amount of curvature, different from the first amount of curvature and the second amount of curvature, in the environment, such as increasing the curvature of the surface of the virtual object 710 as shown in FIG. 7J. In some embodiments, if the first size of the virtual object in the environment is larger than the second size of the virtual object relative to the viewpoint of the user when the first set of one or more inputs is detected, the second amount of curvature of the virtual object is greater than the third amount of curvature. In some embodiments, if the first size of the virtual object in the environment is smaller than the second size of the virtual object relative to the viewpoint of the user when the first set of one or more inputs is detected, the second amount of curvature of the virtual object is smaller than the third amount of curvature. In some embodiments, the third amount of curvature is different from the first amount of curvature and the second amount of curvature in terms of a radius of curvature (e.g., measured in degrees relative to a center point on the surface of the virtual object, relative to the viewpoint of the user, or other reference point). For example, the radius of curvature of the virtual object is a radius of curvature of the front-facing surface of the virtual object from the viewpoint of the user in the three-dimensional environment. Changing a curvature of a surface of a virtual object in a three-dimensional environment when changing one or more visual characteristics of the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that adjusts the size of the virtual object relative to the viewpoint of the user, thereby improving user-device interaction.

In some embodiments, the determination that the virtual object has the first size relative to the viewpoint of the user is based on a determination that the virtual object occupies a first amount of an available field of view of the one or more display generation components (e.g., the viewport) into the environment, such as the amount of the available field of view of the display generation component 120 occupied by the virtual object 710 in FIG. 7G. For example, the computer system changes the curvature of the virtual object based on an available amount of the viewport of the user that is occupied by the virtual object from the viewpoint of the user when the first set of one or more inputs is detected. In some embodiments, the field of view of the one or more display generation components corresponds to an optical field of view of the user as determined by the eye(s) of the user, rather than one or more cameras of the computer system. In some embodiments, in accordance with a determination that the virtual object has a second size, different from the first size, relative to the viewpoint of the user because the virtual object is occupying a second amount, different from the first amount, of the available field of view of the one or more display generation components into the environment, the computer system changes the curvature of the virtual object from the first amount of curvature to a third amount of curvature, different from the first amount of curvature and the second amount of curvature, in response to detecting the first set of one or more inputs. Changing a curvature of a surface of a virtual object in a three-dimensional environment when changing one or more spatial properties of the virtual object based on an available amount of a field of view of the computer system occupied by the virtual object from the viewpoint of the user enables content included on the surface of the virtual object to remain visibly displayed in the three-dimensional environment for larger occupancies of the virtual object in the field of view and/or enables the curvature of the surface of the virtual object to be changed automatically for given user input the adjusts the occupancy of the virtual object in the field of view, thereby improving user-device interaction.

In some embodiments, the first set of one or more inputs includes a selection of a resize element associated with the virtual object in the environment, such as the selection of the second resize element 720 provided by the hand 703 as shown in FIG. 7F. For example, the computer system detects interaction with a resize element that is displayed with the virtual object in the environment. In some embodiments, the selection of the resize element corresponds to an air gesture, such as an air pinch or air tap gesture, while attention of the user is directed to the resize element in the environment. In some embodiments, the selection of the resize element is followed by movement of the resize element, such as via movement of the hand of the user while the hand of the user remains in the pinch hand shape (e.g., an air pinch and drag gesture). In some embodiments, the selection of the resize element has one or more characteristics of interacting with resize elements associated with the representation of content from the second computer system as described with reference to method 800. Changing a curvature of a surface of a virtual object in a three-dimensional environment in response to detecting selection of a resize element associated with the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input the adjusts the size of the virtual object relative to the viewpoint of the user, thereby improving user-device interaction.

In some embodiments, the resize element is selectable to change a simulated resolution of the virtual object in the environment, as similarly described with reference to the second resize element 720 in FIG. 7E. For example, the resize element is displayed with and/or adjacent to a side/edge (e.g., left or right side) of the virtual object in the environment from the viewpoint of the user. In some embodiments, the resize element corresponds to a respective option included in a plurality of selectable options displayed within a menu user interface object in the environment. In some embodiments, the plurality of selectable options is selectable to change the simulated resolution of the virtual object to a value corresponding to the selected option. In some embodiments, the simulated resolution of the virtual object has one or more characteristics of the simulated resolution of the representation of content from the second computer system in method 800. In some embodiments, in response to detecting the selection of the resize element in the environment, the computer system (e.g., concurrently) changes the simulated resolution of the virtual object and changes the curvature of the virtual object based on the size of the virtual object as similarly discussed above. In some embodiments, changing the simulated resolution of the virtual object in response to detecting interaction with the resize element has one or more characteristics of changing the simulated resolution of the representation of content from the second computer system as described in method 800. Changing a curvature of a surface of a virtual object in a three-dimensional environment in response to detecting selection of an option for changing a simulated resolution of the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input the adjusts the size of the virtual object relative to the viewpoint of the user, thereby improving user-device interaction.

In some embodiments, the resize element is selectable to initiate a process to change a size of the virtual object in the environment, such as first resize element 718 in FIG. 7B. For example, the resize element is displayed with and/or adjacent to a corner of the virtual object in the environment, and the resize element is movable in the environment relative to the viewpoint of the user to change the size of the virtual object in the environment (optionally without changing the simulated resolution of the virtual object). In some embodiments, changing the size of the virtual object in response to moving the resize element in the environment includes and/or corresponds to scaling the virtual object in the environment relative to the viewpoint of the user. For example, if the first set of one or more inputs includes movement of the resize element in the environment (e.g., in accordance with an air pinch and drag gesture directed to the resize element), the computer system changes the size of the virtual object and changes the size of content included in the virtual object (e.g., a user interface of the virtual object and/or the content of a virtual instance of the second computer system discussed above). In some embodiments, the size of the virtual object is changed in the environment (e.g., in response to detecting movement of the resize element discussed above) without changing a location of the virtual object in the environment (e.g., without moving the virtual object relative to the viewpoint of the user). In some embodiments, the computer system concurrently changes the size of the virtual object and the content of the virtual object in the environment in accordance with detecting movement of the resize element (e.g., by a same or similar degree or amount in the environment). In some embodiments, scaling the virtual object includes and/or corresponds to changing a magnification of the virtual object and/or the content of the virtual object in the environment in accordance with the movement of the resize element. In some embodiments, scaling the virtual object in the environment in response to detecting interaction with the resize element has one or more characteristics of scaling and/or resizing the representation of content from the second computer system as described in method 800. Changing a curvature of a surface of a virtual object in a three-dimensional environment in response to detecting selection of a scaling option associated with the virtual object based on a size of the virtual object relative to the viewpoint of the user enables content included on the surface of the virtual object to remain visibly displayed in the three-dimensional environment for different scales of the virtual object relative to the viewpoint of the user and/or enables the curvature of the surface of the virtual object to be changed automatically for given user input the adjusts the scale of the virtual object relative to the viewpoint of the user, thereby improving user-device interaction.

In some embodiments, the first set of one or more inputs includes a request to change a size of the virtual object in the environment, such as the input directed to the first resize element 718 provided by the hand 703 as shown in FIG. 7C. For example, the computer system detects a request to resize and/or scale the virtual object in the environment, such as via interaction with one or more of the resize elements discussed above. In some embodiments, in response to detecting the request to change the size of the virtual object, the computer system (e.g., concurrently) changes the size of the virtual object and changes the curvature of the virtual object based on the change in the size of the virtual object in the environment. For example, in response to detecting the first set of one or more inputs, if the size of the virtual object is increased in the environment relative to the viewpoint of the user, the computer system increases the amount of curvature of the virtual object in the environment. In some embodiments, if the size of the virtual object is decreased in the environment relative to the viewpoint of the user in response to detecting the first set of one or more inputs, the computer system decreases the amount of curvature of the virtual object in the environment. Changing a curvature of a surface of a virtual object in a three-dimensional environment in response to detecting a request to resize the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that adjusts the size of the virtual object relative to the viewpoint of the user, thereby improving user-device interaction.

In some embodiments, the first set of one or more inputs corresponding to the request to initiate a process to adjust one or more spatial properties of the virtual object in the environment is a request to change a simulated resolution (e.g., as described further in method 800) of the virtual object in the environment, such as the input directed to the second resize element 720 provided by the hand 703 as shown in FIG. 7F. For example, changing the size of the virtual object in the environment includes changing a simulated resolution of the virtual object in the environment, as similarly discussed above. In some embodiments, as similarly described with reference to changing the simulated resolution of the representation of content from the second computer system in method 800, changing the simulated resolution of the virtual object includes changing an aspect ratio of the virtual object in the environment. Accordingly, in some embodiments, when the computer system changes the size of the virtual object in response to detecting the first set of one or more inputs, the computer system changes the aspect ratio of the virtual object (e.g., the ratio of the width to the height of the virtual object in the environment), which causes the computer system to change the curvature of the virtual object in the environment. In some embodiments, in response to detecting the first set of one or more inputs, if the simulated resolution (e.g., including the aspect ratio) of the virtual object is increased in the environment, the computer system increases the amount of curvature of the virtual object in the environment. In some embodiments, if the simulated resolution (e.g., including the aspect ratio) of the virtual object is decreased in the environment in response to detecting the first set of one or more inputs, the computer system decreases the amount of curvature of the virtual object in the environment. Changing a curvature of a surface of a virtual object in a three-dimensional environment in response to detecting a request to change a simulated resolution of the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that adjusts the simulated resolution of the virtual object relative to the viewpoint of the user, thereby improving user-device interaction.

In some embodiments, the virtual object corresponds to a representation of content from a second computer system, different from the computer system, such as the virtual object 710 being a representation of content from electronic device 760 in FIG. 7A. For example, the virtual object corresponds to a virtual instance of the second computer system as similarly discussed above. In some embodiments, the representation of the content from the second computer system has one or more characteristics of the representation of content from the second computer system in method 800.

In some embodiments, the request to change the simulated resolution of the virtual object is a request to change a simulated resolution of the representation of the content from the second computer system in the environment, such as the input directed to the second resize element 720 provided by the hand 703 corresponding to a request to increase the simulated resolution of the virtual object 710 in FIG. 7F. For example, the computer system changes an amount of space in the representation of content from the second computer system that is available for displaying content items, which optionally includes changing the aspect ratio of the representation in the environment. In some embodiments, changing the simulated resolution of the representation of the content from the second computer system in the environment has one or more characteristics of changing the simulated resolution of the representation of the content from the second computer system as described in method 800. Changing a curvature of a surface of a representation of content from a second computer system in a three-dimensional environment in response to detecting a request to change a simulated resolution of the representation based on a size of the representation relative to the viewpoint of the user enables content included on the surface of the representation to remain visibly displayed in the three-dimensional environment for larger sizes of the representation relative to the viewpoint of the user and/or enables the curvature of the surface of the representation to be changed automatically for given user input that adjusts the simulated resolution of the representation relative to the viewpoint of the user, thereby improving user-device interaction.

In some embodiments, the virtual object corresponds to a virtual canvas associated with a content creation application running on the computer system, such as the virtual object 710 corresponding to a virtual drawing canvas in FIG. 7A. For example, the virtual canvas corresponds to a content creation canvas, such as a drawing/sketching canvas, a note-taking canvas, an image editing canvas, and/or an animation canvas. In some embodiments, the content creation application corresponds to a web-browsing application, an animation application, an image or video editor application, and/or a document editor application. In some embodiments, the virtual canvas includes a rectangular shape in the environment. In some embodiments, the virtual canvas is a two-dimensional object in the environment. In some embodiments, content of the virtual canvas (e.g., drawings, sketches, images, shapes, text, and/or handwriting) is included and/or displayed on a front-facing surface of the virtual canvas in the environment from the viewpoint of the user. In some embodiments, the virtual canvas is able to be interacted with via directed or indirect air gestures provided by the user that are detected by the computer system. For example, the content of the virtual canvas (e.g., drawings, sketches, images, shapes, text, and/or handwriting) is able to be added to, removed from, and/or moved within the virtual canvas via air gestures provided by the hand(s) of the user, such as air pinch gestures, air tap gestures, and/or air pinch and drag gestures.

In some embodiments, the request to change the simulated resolution of the virtual object is a request to change a simulated resolution of the virtual canvas in the environment, such as the input directed to the second resize element 720 provided by the hand 703 corresponding to a request to increase the simulated resolution of the virtual object 710 in FIG. 7F. For example, changing the size of the virtual canvas in the environment includes changing a simulated resolution of the virtual canvas in the environment, as similarly discussed above. In some embodiments, changing the simulated resolution of the virtual canvas includes changing an aspect ratio of the virtual canvas in the environment. Accordingly, in some embodiments, when the computer system changes the size of the virtual canvas in response to detecting the first set of one or more inputs, the computer system changes the aspect ratio of the virtual canvas (e.g., the ratio of the width to the height of the virtual canvas in the environment), which causes the computer system to change the curvature of the virtual canvas in the environment. In some embodiments, in response to detecting the first set of one or more inputs, if the simulated resolution (e.g., including the aspect ratio) of the virtual canvas is increased in the environment, the computer system increases the amount of curvature of the virtual canvas in the environment. In some embodiments, if the simulated resolution (e.g., including the aspect ratio) of the virtual canvas is decreased in the environment in response to detecting the first set of one or more inputs, the computer system decreases the amount of curvature of the virtual canvas in the environment. Changing a curvature of a surface of a virtual canvas in a three-dimensional environment in response to detecting a request to change a simulated resolution of the virtual canvas based on a size of the virtual canvas relative to the viewpoint of the user enables content included on the surface of the virtual canvas to remain visibly displayed in the three-dimensional environment for larger sizes of the virtual canvas relative to the viewpoint of the user and/or enables the curvature of the surface of the virtual canvas to be changed automatically for given user input that adjusts the simulated resolution of the virtual canvas relative to the viewpoint of the user, thereby improving user-device interaction.

In some embodiments, the first set of one or more inputs corresponding to the request to initiate a process to adjust one or more spatial properties of the virtual object in the environment is a request to scale the virtual object in the environment, such as the interaction with the first resize element 718 provided by the hand 703 increasing the size of the virtual object 710 as shown in FIG. 7D. For example, the computer system scales (e.g., changes a magnification of) the virtual object in the environment in response to detecting the first set of one or more inputs, as similarly discussed above. In some embodiments, the computer system scales the virtual object without changing a simulated resolution of the virtual object in the environment. For example, as described with reference to scaling the representation of the content from the second computer system in method 800, scaling the virtual object is performed in response to detecting interaction with (e.g., movement of) a scaling element and changing the simulated resolution of the virtual object is performed in response to detecting interaction with (e.g., movement of and/or selection of) a resize element, different from the scaling element, that is displayed with the virtual object in the environment. Changing a curvature of a surface of a virtual object in a three-dimensional environment in response to detecting a request to change a scale of the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that adjusts the scale of the virtual object relative to the viewpoint of the user, thereby improving user-device interaction.

In some embodiments, the request to scale the virtual object in the environment includes a multiple selection input (e.g., a double tap, double air tap, triple tap, or triple air tap) directed to the virtual object, such as the double air pinch gesture provided by the hand 703 as shown in FIG. 7O. For example, the multiple selection input is performed by a hand of the user directed to a portion of (e.g., a surface of) the virtual object in the environment. In some embodiments, the multiple selection input corresponds to a double air pinch gesture performed by a hand (e.g., the same hand) of the user. For example, the computer system detects a first air pinch gesture followed by a second air pinch gesture (e.g., in rapid succession) performed by the hand, optionally while the attention (e.g., including gaze) of the user is directed toward the virtual object in the environment. In some embodiments, the multiple selection input corresponds to a double air tap gesture performed by a hand (e.g., the same hand) of the user. For example, the computer system detects a first air tap gesture followed by a second air tap gesture (e.g., in rapid succession) performed by the hand extending toward the virtual object, optionally while the attention (e.g., including gaze) of the user is directed toward the virtual object in the environment.

In some embodiments, in response to detecting the first set of one or more inputs corresponding to the request to initiate a process to adjust one or more spatial properties of the virtual object in the environment, the virtual object is displayed at a predefined size in the environment, such as displaying the virtual object 710 at a default size (e.g., 100% scale) in the three-dimensional environment 700 as shown in FIG. 7P. For example, in response to detecting the multiple selection input directed to the virtual object, the computer system resets a scale of the virtual object in the environment from the viewpoint of the user. In some embodiments, when the first set of one or more inputs is detected, the virtual object is displayed at a respective size and/or with a respective scale in the environment. In some embodiments, in response to detecting the first set of one or more inputs, if the respective size of the virtual object is different from the predefined size, the computer system changes the size of the virtual object to be the predefined size (e.g., and/or a predefined scale, such as 90, 95, 100, 105, or 110% scale) in the environment. In some embodiments, if the respective size of the virtual object is equal to the predefined size, the computer system maintains display of the virtual object at the respective size in the environment in response to detecting the double tap input directed to the virtual object. In some embodiments, displaying the virtual object at the predefined size in the environment causes the computer system to change the amount of curvature of the virtual object in the environment. For example, the computer system decreases the amount of curvature of the virtual object (e.g., to visually appear to be flat and/or without curvature from the viewpoint of the user) in the environment when the scale of the virtual object is reset in response to detecting the double tap input. Changing a curvature of a surface of a virtual object in a three-dimensional environment in response to detecting a request to change a scale of the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that adjusts the scale of the virtual object relative to the viewpoint of the user, thereby improving user-device interaction.

In some embodiments, the first set of one or more inputs corresponding to the request to initiate a process to adjust one or more spatial properties of the virtual object in the environment includes an air gesture provided by a first portion (e.g., a first hand) and a second portion (e.g., a second hand) of the user, such as the air pinch gesture provided by first hand 707 and second hand 703 as shown in FIG. 7P. For example, the first set of one or more inputs includes a two-handed air gesture provided by the user of the computer system. In some embodiments, the computer system (e.g., concurrently) detects the first portion of the user and the second portion of the user perform an air pinch gesture, followed by movement of one or both of the first portion and the second portion of the user while maintaining the pinch hand shape. In some embodiments, a direction of the movement of the first portion and/or the second portion of the user relative to each other determines whether the computer system increases or decreases the size of the virtual object in the environment in response to detecting the two-handed air gesture. For example, movement of one or both of the hands of the user that causes the hands to be farther apart relative to the viewpoint of the user after detecting the air pinch gestures from the two hands causes the computer system to increase the size of the virtual object in the environment relative to the viewpoint of the user, whereas movement of one or both of the hands of the user that causes the hands to be closer together relative to the viewpoint of the user after detecting the air pinch gestures from the two hands causes the computer system to decrease the size of the virtual object in the environment relative to the viewpoint of the user. In some embodiments, a magnitude (e.g., of speed and/or distance) of the movement of the hand(s) of the user apart or closer together determines an amount by which the size of the virtual object is changed in the environment relative to the viewpoint of the user. For example, if the computer system detects the first hand of the user and/or the second hand of the user move (e.g., closer together or farther apart) by a first magnitude (e.g., a first net/total magnitude), the computer system changes the size of the virtual object by a first amount in the environment relative to the viewpoint of the user, and if the computer system detects the first hand of the user and/or the second hand of the user move by a second magnitude (e.g., a second net/total magnitude), smaller than the first magnitude, the computer system changes the size of the virtual object by a second amount, smaller than the first amount, in the environment relative to the viewpoint of the user. In some embodiments, in response to detecting a release of the air gesture by one or both of the first portion and the second portion of the user, the computer system ceases and/or concludes changing the size of the virtual object in the environment relative to the viewpoint of the user. In some embodiments, as similarly discussed above, the computer system changes the curvature of the virtual object in the environment while and/or in response to detecting the air gesture provided by the first portion and the second portion of the user (e.g., based on the size of the virtual object relative to the viewpoint of the user). Changing a curvature of a surface of a virtual object in a three-dimensional environment in response to detecting a request to change a scale of the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that adjusts the scale of the virtual object relative to the viewpoint of the user, thereby improving user-device interaction.

In some embodiments, in response to detecting the first set of one or more inputs corresponding to the request to initiate a process to adjust one or more spatial properties of the virtual object in the environment, the computer system changes a size of the virtual object in the environment, such as increasing a scale of the virtual object 710 (e.g., to 140% scale) in the three-dimensional environment 700 as shown in FIG. 7R. For example, as similarly discussed above, the computer system changes a scale (e.g., a magnification) of the virtual object in the environment based on the first set of one or more inputs.

In some embodiments, in accordance with a determination that the first set of one or more inputs corresponding to the request to initiate a process to adjust one or more spatial properties of the virtual object in the environment corresponds to a request to display the virtual object at a first respective size (e.g., including a first respective scale) that is beyond a size limit for the virtual object (e.g., the first respective size is beyond a minimum or a maximum size for the virtual object in the environment), such as the requested scale of the virtual object 710 (e.g., 90% scale) in the three-dimensional environment 700 in FIG. 7S based on the movements of the first hand 707 and/or the second hand 703, the computer system displays, via the one or more display generation components, the virtual object at the first respective size in the environment relative to the viewpoint of the user in accordance with the first set of one or more inputs corresponding to the request to initiate a process to adjust one or more spatial properties of the virtual object in the environment, such as displaying the virtual object 710 at the requested scale in the three-dimensional environment as shown in FIG. 7S. In some embodiments, the size limit is determined based on visibility of the virtual object in the environment from the viewpoint of the user. For example, the size limit corresponds to a threshold scale for maintaining visibility and/or legibility of the content of the virtual object in the environment from the viewpoint of the user. In some embodiments, the size limit is determined based on one or more settings (e.g., default, system, and/or user-selected settings) for the display of the virtual object in the environment. In some embodiments, the size limit is determined based on content type of the virtual object and/or computing power/capability. In some embodiments, the size limit corresponds to a minimum size/scale of the virtual object, such as 60, 65, 70, 75, 80, 85, 90, or 95%. In some embodiments, the size limit corresponds to a maximum size/scale of the virtual object, such as 150, 160, 170, 180, 190, 200, 250, 300, or 500%. In some embodiments, in response to detecting the first set of one or more inputs that includes the request to display the virtual object at the first respective size that is beyond the size limit (e.g., greater than the maximum size or less than the minimum size), the computer system momentarily (e.g., temporarily) displays the virtual object at the first respective size in the environment. In some embodiments, the computer system displays the virtual object at the first respective size for the duration of the first set of one or more inputs. For example, the computer system displays the virtual object at the first respective size until detecting termination/conclusion of the first set of one or more inputs, such as a release of the air pinch gesture or other input directed to the virtual object in the environment.

In some embodiments, the computer system changes the size of the virtual object (e.g., gradually and/or over a respective time period, such as 0.5, 0.75, 1, 2, 3, 4, or 5 seconds) from the first respective size to a second respective size, different from the first respective size, that is within the size limit in the environment, such as increasing the scale of the virtual object to a minimum scale (e.g., 100% scale) in the three-dimensional environment 700 as shown in FIG. 7T. For example, in response to detecting termination of the first set of one or more inputs (e.g., a release of the air pinch gesture as discussed above), the computer system gradually increases or decreases the size of the virtual object to the second respective size to no longer exceed the size limit for the virtual object in the environment. In some embodiments, the computer system changes the curvature of the virtual object based on the second respective size of the virtual object rather than based on the first respective size of the virtual object that is beyond the size limit. In some embodiments, the computer system changes the curvature of the virtual object based on the first respective size of the virtual object initially, and when the size of the virtual object is changed to the second respective size in the environment relative to the viewpoint of the user, the computer system updates the curvature of the virtual object to be based on the second respective size (e.g., increases or decreases the curvature further). In some embodiments, the computer system gradually changes the size of the virtual object according to a spring-based model in the environment. In some embodiments, when the computer system changes the size of the virtual object in the environment according to the spring-based model, the computer system changes the size of the virtual object from the first respective size to the second respective size in a pulling or “rubberbanding” motion (e.g., as in a mass attached to a spring), such as displaying the virtual object at a size that is beyond a target size (e.g., the size limit) and reversing the change in the size of the virtual object back to the target size (e.g., the second respective size that is within the size limit) in the environment. In some embodiments, the computer system detects an amount of displacement/difference measured between the first respective size of the virtual object in the environment and the size limit of the virtual object in the environment and animates a transition of the size of the virtual object from the first respective size to the second respective size with a magnitude of change based on the displacement/difference, such that the greater the displacement, the greater the change in the size of the virtual object when the first set of one or more inputs is terminated (e.g., when the computer system detects a release of the air pinch gesture or the end of a button press or touch input). In some embodiments, the relationship between the displacement and the size/scale of the virtual object is linear, exponential, logarithmic, and/or some other non-linear relationship between the displacement and the size/scale. In some embodiments, the curvature of the virtual object is changed in a similar manner as discussed above with reference to changing the size of the virtual object in the environment relative to the viewpoint of the user according to the spring-based model. Gradually resizing a virtual object in a three-dimensional environment when a requested change in size of the virtual object is beyond a threshold size in the three-dimensional environment enables the virtual object to automatically remain visibly displayed from the viewpoint of the user, while providing the eyes of the user time to adjust to the updated size of the virtual object, which helps prevent user discomfort while viewing the virtual object, thereby improving user-device interaction.

In some embodiments, in response to detecting the first set of one or more inputs, the computer system changes a size of the virtual object in the environment to a respective size of a set of sizes (e.g., a set of discrete/predefined sizes/scales) of the virtual object, such as one of the aspect ratios of the virtual object 710 indicated by the options 723a-723c in FIG. 7M. For example, as similarly discussed above, the computer system changes a scale (e.g., a magnification) of the virtual object in the environment based on the first set of one or more inputs.

In some embodiments, in accordance with a determination that the first set of one or more inputs corresponds to a request to change the size of the virtual object to a first respective size that is within a threshold of (e.g., is closest to or is equal to) a first size in the set of sizes, such as a selection of the first option 723a provided by the hand 703 in FIG. 7M, the respective size is the first size, such as the size of the virtual object 710 in the three-dimensional environment 700 in FIG. 7A. In some embodiments, in accordance with a determination that the first set of one or more inputs corresponds to a request to change the value to a second respective size that is within the threshold of (e.g., is closest to or is equal to, such as being within 3, 5, 10, 15 or 30% of) a second size, different from the first size, in the set of sizes, such as a selection of the second option 723b provided by the hand 703 in FIG. 7M, the respective size is the second size, such as the size of the virtual object 710 in FIG. 7N (e.g., indicated by indication 724). For example, the computer system selects the size/scale of the virtual object from a set of discrete sizes of the virtual object based on the first set of one or more inputs. In some embodiments, the first size of the virtual object includes a first scale of the content of the virtual object in the environment. In some embodiments, the second size of the virtual object includes a second scale of the content of the virtual object in the environment. In some embodiments, the computer system selects a particular size from the set of sizes, such as the first size or the second size above, based on a size to which the requested change in the size of the virtual object according to the first set of one or more inputs is closest to (e.g., within the threshold of). For example, if the first set of one or more inputs that includes the request to change the size of the virtual object corresponds to a request to change the size of the virtual object to a first respective size, and the first respective size is closest to or is equal to the first size, the computer system displays the virtual object at the first size relative to the viewpoint of the user in the environment. In some embodiments, if the first respective size is closest to or is equal to the second size, the computer system displays the virtual object at the second size relative to the viewpoint of the user in the environment. Accordingly, in some embodiments, the computer system does not select a value for the size of the virtual object directly in accordance with the magnitude (e.g., of speed and/or distance) of movement associated with the first set of one or more inputs, such as the magnitude of the movement of the resize element as discussed above and/or the magnitude of the movement of the hand(s) of the user as discussed above. Rather, as discussed above, the computer system optionally selects the value for the size of the virtual object based on the magnitude of the movement associated with the first set of one or more inputs relative to the set of sizes for the virtual object. Accordingly, in some embodiments, the change in the curvature of the virtual object is based on the selected size, including scale, in the set of sizes for the virtual object in the environment based on the first set of one or more inputs. Changing a size of a virtual object in a three-dimensional environment to a particular size that is selected from a set of discrete sizes based on the input corresponding to a request to resize the virtual object in the three-dimensional environment reduces the number of inputs needed to display the virtual object with a particular size in the three-dimensional environment, thereby improving user-device interaction.

In some embodiments, the first set of one or more inputs includes a request to move the virtual object within the environment relative to the viewpoint of the user, such as the input directed to movement element 712 associated with the virtual object 710 provided by the hand 703 as shown in FIG. 7Z. For example, as similarly discussed above, when the computer system changes the curvature of the virtual object in the environment, the computer system has moved and/or is moving the virtual object relative to the viewpoint of the user in the environment. In some embodiments, the request to move the virtual object within the environment includes interaction with a movement element (e.g., a handle or grabber bar) displayed with the virtual object in the environment. For example, the computer system detects a selection of the movement element, such as via an air pinch gesture performed by a hand of the user, followed by movement of hand of the user while the hand remains in the pinch hand shape, causing the virtual object to be moved in the environment relative to the viewpoint of the user. In some embodiments, the computer system moves the virtual object in the environment relative to the viewpoint of the user in accordance with and/or based on a respective direction and/or respective magnitude (e.g., of speed and/or distance) of the movement of the hand of the user. In some embodiments, the movement of the virtual object relative to the viewpoint of the user causes the size of the virtual object to change in the environment, which causes the computer system to change the curvature of the virtual object. For example, if the first set of one or more inputs includes a request to move the virtual object away from the viewpoint of the user in the environment, which causes a distance between the virtual object and the viewpoint to increase, the computer system increases the size of the virtual object in the environment, which causes the curvature of the virtual object to be increased. In some embodiments, if the first set of one or more inputs includes a request to move the virtual object toward the viewpoint of the user in the environment, which causes the distance between the virtual object and the viewpoint to decrease, the computer system decreases the size of the virtual object in the environment, which causes the curvature of the virtual object to be decreased. In some embodiments, the request to move the virtual object within the environment relative to the viewpoint of the user does not include movement of the viewpoint of the user relative to the virtual object in the environment. Changing a curvature of a surface of a virtual object in a three-dimensional environment when moving the virtual object relative to the viewpoint of the user based on a size of the virtual object relative to the viewpoint of the user enables content included on the surface of the virtual object to remain visibly displayed in the three-dimensional environment for different locations of the virtual object relative to the viewpoint of the user and/or enables the curvature of the surface of the virtual object to be changed automatically for given user input that adjusts the location of the virtual object relative to the viewpoint of the user, thereby improving user-device interaction.

In some embodiments, while displaying the virtual object in the environment, the computer system detects, via the one or more input devices, a second set of one or more inputs, such as the input provided by the hand 703 directed to the movement element 712 as shown in FIG. 7X. For example, the second set of one or more inputs includes one or more air gestures performed by a hand of the user. In some embodiments, the second set of one or more inputs includes a request to initiate movement of the virtual object in the environment relative to the viewpoint of the user. For example, the second set of one or more inputs includes interaction with a movement element (e.g., a grabber bar) associated with the virtual object and that is selectable to initiate movement of the virtual object in the environment relative to the viewpoint of the user. In some embodiments, the second set of one or more inputs includes movement of the viewpoint of the user relative to the virtual object in the environment. For example, the computer system detects movement of a head and/or a location of the user in the physical environment of the computer system, which cause the location of the viewpoint of the user to change in the environment. In some embodiments, the movement of the viewpoint of the user is detected via one or more external sensors in communication with the computer system and/or via one or more motion sensors in communication with the computer system, such as an inertial measurement unit and/or one or more cameras (e.g., utilizing visual inertial odometry). In some embodiments, the second set of one or more inputs has one or more characteristics of the first set of one or more inputs discussed above.

In some embodiments, in response to detecting the second set of one or more inputs, in accordance with a determination that the second set of one or more inputs includes a selection of the virtual object, without including a request to move the virtual object within the environment (e.g., and irrespective of whether the location of the viewpoint of the user has changed in the environment), the computer system forgoes changing the curvature of the respective portion of the virtual object in the environment (e.g., the computer system maintains the curvature of the respective portion of the virtual object in the environment), such as forgoing changing the curvature of the surface of the virtual object 710 as shown in FIG. 7X. For example, the computer system detects a selection of the movement element associated with the virtual object in the environment, without detecting movement of the movement element relative to the viewpoint of the user (e.g., the computer system detects an air pinch gesture directed to the grabber bar performed by the hand of the user, without detecting movement of the hand). In some embodiments, before and/or while detecting the selection of the virtual object, the computer system detects movement of the viewpoint of the user relative to the virtual object, as similarly discussed above. In some embodiments, the movement of the viewpoint of the user causes the distance between the viewpoint and the virtual object in the environment to change, which optionally causes the apparent size of the virtual object relative to the updated viewpoint of the user to change accordingly. For example, if the movement of the viewpoint of the user causes a distance between the virtual object and the viewpoint to increase, the apparent size of the virtual object decreases in the environment relative to the updated viewpoint of the user. In some embodiments, if the movement of the viewpoint of the user causes the distance between the virtual object and the viewpoint to decrease, the apparent size of the virtual object increases in the environment relative to the updated viewpoint of the user. In either case, because the second set of one or more inputs does not include a request to move the virtual object within the environment (e.g., does not include movement of the hand of the user as discussed above), the computer system forgoes changing the curvature of the virtual object in the environment (e.g., despite the change in the apparent size of the virtual object relative to the updated viewpoint of the user). Forgoing changing a curvature of a surface of a virtual object in a three-dimensional environment in response to detecting a selection of the virtual object, irrespective of movement of the viewpoint of the user, enables content included on the surface of the virtual object to remain visibly displayed in the three-dimensional environment for different locations of the virtual object relative to the viewpoint of the user and/or helps avoid unintentional changing of the curvature of the surface of the virtual object in the three-dimensional environment, thereby improving user-device interaction and conserving computing resources associated with correcting such change.

In some embodiments, the first set of one or more inputs includes a selection of a movement element (e.g., a handle or grabber bar) associated with the virtual object in the environment, such as selection of the movement element 712 provided by the hand 703 as shown in FIG. 7X. For example, as similarly discussed above, the virtual object is displayed with a movement element in the environment that is selectable to initiate movement of the virtual object relative to the viewpoint of the user. In some embodiments, the movement element is displayed below and/or in front of the virtual object from the viewpoint of the user in the environment. In some embodiments, the first set of one or more inputs includes the selection of the movement element, followed by movement of the movement element in the environment, which moves the virtual object accordingly. For example, the computer system detects an air pinch gesture performed by a hand of the user directed to the movement element, optionally followed by movement of the hand of the user while maintaining the pinch hand shape. In some embodiments, the computer system changes the curvature of the virtual object in response to detecting the selection of the movement element associated with the virtual object in the environment, without requiring (e.g., before detecting) movement of the movement element in the environment relative to the viewpoint of the user. Changing a curvature of a surface of a virtual object in a three-dimensional environment in response to detecting selection of a movement element associated with the virtual object based on a size of the virtual object relative to the viewpoint of the user enables content included on the surface of the virtual object to remain visibly displayed in the three-dimensional environment for different sizes of the virtual object relative to the viewpoint of the user and/or enables the curvature of the surface of the virtual object to be changed automatically for given user input that initiates adjustment of the location of the virtual object relative to the viewpoint of the user, thereby improving user-device interaction.

In some embodiments, while displaying the virtual object in the environment with a respective amount of curvature (e.g., the first amount of curvature or the second amount of curvature discussed above), the computer system detects, via the one or more input devices, a second set of one or more inputs that includes movement of the viewpoint of the user relative to the virtual object in the environment, such as movement of the viewpoint of the user 702 as indicated by arrow 735 in top-down view 705 in FIG. 7W, and after the movement of the viewpoint of the user, selection of the movement element associated with the virtual object in the environment, such as the selection of the movement element 712 provided by the hand 703 as shown in FIG. 7X. For example, the second set of one or more inputs includes one or more air gestures performed by a hand of the user. In some embodiments, the second set of one or more inputs includes a request to initiate movement of the virtual object in the environment relative to the viewpoint of the user. For example, the second set of one or more inputs includes interaction with a movement element (e.g., a grabber bar) associated with the virtual object and that is selectable to initiate movement of the virtual object in the environment relative to the viewpoint of the user. In some embodiments, the second set of one or more inputs includes movement of the viewpoint of the user relative to the virtual object in the environment. For example, the computer system detects movement of a head and/or a location of the user in the physical environment of the computer system, which cause the location of the viewpoint of the user to change in the environment. In some embodiments, the selection of the movement element is detected after detecting the movement of the viewpoint of the user. In some embodiments, the selection of the movement element is detected while detecting the movement of the viewpoint of the user. In some embodiments, the second set of one or more inputs has one or more characteristics of the first set of one or more inputs discussed above.

In some embodiments, in response to detecting the second set of one or more inputs, in accordance with a determination that the movement of the viewpoint of the user causes the virtual object to have a second size in the environment relative to an updated viewpoint of the user, such as the size of the virtual object 710 relative to the updated viewpoint of the user 702 in FIG. 7X, the computer system changes the curvature of the respective portion of the virtual object in the environment from the first amount of curvature to a third amount of curvature, different from the respective amount of curvature, such as increasing the curvature of the surface of the virtual object 710 in the three-dimensional environment 700 as shown in FIG. 7Y. In some embodiments, the movement of the viewpoint of the user causes the distance between the viewpoint and the virtual object in the environment to change, which optionally causes the apparent size of the virtual object relative to the updated viewpoint of the user to change accordingly. For example, if the movement of the viewpoint of the user causes a distance between the virtual object and the viewpoint to increase, the apparent size of the virtual object decreases in the environment relative to the updated viewpoint of the user. In some embodiments, if the movement of the viewpoint of the user causes the distance between the virtual object and the viewpoint to decrease, the apparent size of the virtual object increases in the environment relative to the updated viewpoint of the user. In either case, because the second set of one or more inputs includes a selection of the movement element associated with the virtual object within the environment, without necessarily including movement of the movement element, as discussed above, the computer system changes the curvature of the virtual object in the environment based on the change in the apparent size of the virtual object relative to the updated viewpoint of the user. In some embodiments, the third amount of curvature is different from the respective amount of curvature in terms of a radius of curvature (e.g., measured in degrees relative to a center point on the surface of the virtual object, relative to the viewpoint of the user, or other reference point). For example, the radius of curvature of the virtual object is a radius of curvature of the front-facing surface of the virtual object from the viewpoint of the user in the three-dimensional environment. Changing a curvature of a surface of a virtual object in a three-dimensional environment after detecting movement of a viewpoint of the user in response to detecting selection of a movement element associated with the virtual object based on a size of the virtual object relative to the updated viewpoint of the user enables content included on the surface of the virtual object to remain visibly displayed in the three-dimensional environment for different sizes of the virtual object relative to the updated viewpoint of the user and/or enables the curvature of the surface of the virtual object to be changed automatically for changes in location of the viewpoint of the user, thereby improving user-device interaction.

In some embodiments, after changing the curvature of the virtual object to the second amount of curvature in accordance with the determination that the virtual object has the first size relative to the viewpoint of the user in response to detecting the selection of the movement element associated with the virtual object in the environment, the computer system detects, via the one or more input devices, movement of the viewpoint of the user relative to the virtual object, such as the movement of the viewpoint of the user 702 as indicated by the arrow 735 in the top-down view 705 in FIG. 7Y. For example, as similarly discussed above, after detecting the first set of one or more inputs, the computer system detects movement of a head and/or a location of the user in the physical environment of the computer system, which cause the location of the viewpoint of the user to change in the environment.

In some embodiments, in response to detecting the movement of the viewpoint of the user, in accordance with a determination that the movement of the viewpoint of the user is detected while the movement element associated with the virtual object is selected, such as the movement element 712 being selected via input provided by the hand 703 in FIG. 7Y, and that a size of the virtual object relative to an updated viewpoint of the user is a second size, different from the first size, such as the size of the virtual object 710 relative to the updated viewpoint of the user 702 in FIG. 7Z, the computer system changes the curvature of the respective portion of the virtual object from the second amount of curvature to a third amount of curvature that is different from the second amount of curvature, such as increasing the curvature of the virtual object 710 in the three-dimensional environment 700 as shown in FIG. 7Z. In some embodiments, the movement of the viewpoint of the user causes the distance between the viewpoint and the virtual object in the environment to change, which optionally causes the apparent size of the virtual object relative to the updated viewpoint of the user to change accordingly (e.g., to the second size). For example, if the movement of the viewpoint of the user causes a distance between the virtual object and the viewpoint to increase, the apparent size of the virtual object decreases in the environment relative to the updated viewpoint of the user. In some embodiments, if the movement of the viewpoint of the user causes the distance between the virtual object and the viewpoint to decrease, the apparent size of the virtual object increases in the environment relative to the updated viewpoint of the user. In either case, because the movement of the viewpoint is accompanied by a selection of the movement element associated with the virtual object within the environment, without necessarily including movement of the movement element, as discussed above, the computer system changes the curvature of the virtual object in the environment based on the change in the apparent size of the virtual object relative to the updated viewpoint of the user. In some embodiments, a direction of the change in curvature of the virtual object is based on the direction of the movement of the viewpoint of the user. For example, as discussed above, because movement of the viewpoint of the user away from the virtual object causes the apparent size of the virtual object to decrease, the computer system decreases the curvature of the respective portion of the virtual object in the three-dimensional environment in response to detecting the movement of the viewpoint of the user while the movement element is selected. Similarly, because movement of the viewpoint of the user toward the virtual object causes the apparent size of the virtual object to increase, the computer system optionally increases the curvature of the respective portion of the virtual object in the three-dimensional environment in response to detecting the movement of the viewpoint of the user while the movement element is selected. In some embodiments, a magnitude (e.g., of speed and/or radius) of the change in curvature of the virtual object is based on the magnitude (e.g., of speed and/or distance) of the movement of the viewpoint of the user. For example, if the computer system detects the movement of the viewpoint of the user with a first magnitude (e.g., of speed and/or distance), the computer system changes the curvature of the respective portion of the virtual object in the three-dimensional environment by a first respective magnitude based on the first magnitude in response to detecting the movement of the viewpoint of the user while the movement element is selected. Similarly, if the computer system detects the movement of the viewpoint of the user with a second magnitude (e.g., of speed and/or distance), greater than the first magnitude, the computer system changes the curvature of the respective portion of the virtual object in the three-dimensional environment by a second respective magnitude, greater than the first respective magnitude, based on the second magnitude in response to detecting the movement of the viewpoint of the user while the movement element is selected. Changing a curvature of a surface of a virtual object in a three-dimensional environment in response to detecting movement of a viewpoint of the user while detecting selection of a movement element associated with the virtual object based on a size of the virtual object relative to the updated viewpoint of the user enables content included on the surface of the virtual object to remain visibly displayed in the three-dimensional environment for different sizes of the virtual object relative to the updated viewpoint of the user and/or enables the curvature of the surface of the virtual object to be changed automatically for changes in location of the viewpoint of the user, thereby improving user-device interaction.

In some embodiments, prior to (e.g., and/or when) detecting the first set of one or more inputs, the virtual object has a respective size that is smaller than the first size, such as the size of the virtual object 710 relative to the viewpoint of the user 702 in FIG. 7F, and the first amount of curvature corresponds to the respective portion of the virtual object being flat relative to the viewpoint of the user in the environment, such as the surface of the virtual object 710 being flat relative to the viewpoint of the user 702 in FIG. 7F. For example, when the computer system detects the first set of one or more inputs, the front-facing surface of the virtual object appears to be flat (e.g., has no curvature or is planar). In some embodiments, as similarly discussed above, the first set of one or more inputs includes a request to increase the size of the virtual object in the environment, such as from the respective size to the first size relative to the viewpoint of the user in the environment.

In some embodiments, in response to detecting the first set of one or more inputs, in accordance with the determination that the virtual object has the first size relative to the viewpoint of the user, the second amount of curvature corresponds to the respective portion of the virtual object being curved relative to the viewpoint of the user in the environment, such as the surface of the virtual object 710 being curved relative to the viewpoint of the user 702 in FIG. 7G. For example, in response to detecting the first set of one or more inputs, the computer system increases the size of the virtual object relative to the viewpoint of the user in the environment (e.g., from the respective size to the first size), and increases the amount of curvature of the virtual object in the environment. In some embodiments, the second amount of curvature is greater than the first amount of curvature. In some embodiments, as similarly discussed above, the computer system concurrently increases the size of the virtual object relative to the viewpoint of the user and increases the amount of curvature of the virtual object in the environment. Increasing a curvature of a surface of a virtual object in a three-dimensional environment when increasing a size of the virtual object based on the size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that increases the size of the virtual object relative to the viewpoint of the user, thereby improving user-device interaction.

In some embodiments, while displaying the virtual object in the environment, the computer system detects, via the one or more input devices, a second set of one or more inputs, such as the input provided by the hand 703 directed to the second resize element 720 as shown in FIG. 7H. For example, the second set of one or more inputs includes and/or corresponds to a request to change the size of the virtual object relative to the viewpoint of the user in the environment. In some embodiments, as similarly discussed above, the second set of one or more inputs includes one or more air pinch gestures directed to the virtual object, such as an air pinch and drag gesture directed to a resize element associated with the virtual object in the environment, or a two-handed air pinch and drag gesture directed to the virtual object in the environment. In some embodiments, the second set of one or more inputs has one or more characteristics of the first set of one or more inputs.

In some embodiments, in response to detecting the second set of one or more inputs, in accordance with a determination that the virtual object has a second size, larger than the first size, relative to the viewpoint of the user, such as the size of the virtual object 710 relative to the viewpoint of the user 702 in FIG. 7J, the computer system changes the curvature of the respective portion of the virtual object to a third amount of curvature, different from the first amount of curvature, wherein the third amount of curvature corresponds to the respective portion of the virtual object being curved relative to the viewpoint of the user in the environment, such as increasing the curvature of the surface of the virtual object 710 as shown in FIG. 7J. For example, in response to detecting the second set of one or more inputs, the computer system increases the size of the virtual object (e.g., to the second size) relative to the viewpoint of the user in the environment, which causes the computer system to change the curvature of the virtual object in the environment. In some embodiments, the third amount of curvature is greater than the first amount of curvature and the second amount of curvature. In some embodiments, the third amount of curvature is equal to the second amount of curvature but is greater than the first amount of curvature. For example, even though the computer system increases the size of the virtual object relative to the viewpoint of the user in the environment, the computer system forgoes increasing the curvature of the virtual object beyond the second amount of curvature (e.g., the second amount of curvature corresponds to a maximum amount of curvature for the virtual object) in the environment. In some embodiments, the third amount of curvature is different from the first amount of curvature in terms of a radius of curvature (e.g., measured in degrees relative to a center point on the surface of the virtual object, relative to the viewpoint of the user, or other reference point). For example, the radius of curvature of the virtual object is a radius of curvature of the front-facing surface of the virtual object from the viewpoint of the user in the three-dimensional environment. Increasing a curvature of a surface of a virtual object in a three-dimensional environment when increasing a size of the virtual object based on the size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that increases the size of the virtual object relative to the viewpoint of the user, thereby improving user-device interaction.

In some embodiments, in response to detecting the first set of one or more inputs and in accordance with a determination that the virtual object has the first size relative to the viewpoint of the user, in accordance with a determination that a characteristic (e.g., magnitude and/or a target) of the first set of one or more inputs is a first characteristic (e.g., a first magnitude and/or a first target), such as the selection of the first option 723a indicating a first aspect ratio of the virtual object 710 provided by the hand 703 in FIG. 7M, the second amount of curvature is a first predefined amount of curvature from a plurality of available predefined amounts of curvature for the virtual object, such as the curvature of the surface of the virtual object 710 in FIG. 7A. In some embodiments, in accordance with a determination that the characteristics of the first set of one or more inputs is a second characteristic (e.g., a second magnitude and/or a second target), different from the first characteristic, such as the selection of the second option 723b indicating a second aspect ratio of the virtual object 710 provided by the hand 703 in FIG. 7M, the second amount of curvature is a second predefined amount of curvature, different from the first predefined amount of curvature, such as the curvature of the surface of the virtual object 710 in FIG. 7N (e.g., indicated by indication 724). For example, if the first set of one or more inputs includes a selection of an interaction element associated with the virtual object, such as a resize element or movement element as discussed above, optionally followed by movement of the interaction element with a respective magnitude (e.g., of speed and/or distance) in the environment, the computer system changes the curvature of the virtual object to a discrete value of curvature (e.g., from a set of discrete values of curvature for the virtual object) in the environment. In some embodiments, the particular value of curvature of the virtual object that is selected when changing the curvature of the virtual object in response to detecting the selection input is based on the magnitude or target of the first set of one or more (e.g., according to the curvature within the set of discrete values of curvature that the requested curvature according to the first set of one or more inputs is closest to (e.g., within a threshold of, such as 3, 5, 10, 15, or 30% of)). For example, if the movement of the interaction element associated with the virtual object has a first magnitude (e.g., of speed and/or distance) that corresponds to a change in the amount of curvature of the virtual object to a first respective amount of curvature, and the first respective amount of curvature is closest to or equal to the first predefined amount of curvature, the computer system changes the curvature of the virtual object to the first predefined amount of curvature. In some embodiments, if the first respective amount of curvature is closest to or equal to the second predefined amount of curvature, the computer system changes the curvature of the virtual object to the second predefined amount of curvature. Accordingly, in some embodiments, the computer system does not select a value for the amount of curvature of the virtual object directly in accordance with the magnitude (e.g., of speed and/or distance) of movement associated with the first set of one or more inputs, such as the magnitude of the movement of the interaction element as discussed above and/or the magnitude of the movement of the hand(s) of the user as discussed above. Rather, as discussed above, the computer system optionally selects the value for the amount of curvature of the virtual object based on the magnitude of the movement associated with the first set of one or more inputs relative to the set of discrete values of curvature. Changing a curvature of a surface of a virtual object in a three-dimensional environment in response to detecting a selection input directed to the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that adjusts the size of the virtual object relative to the viewpoint of the user, thereby improving user-device interaction.

In some embodiments, in response to detecting the first set of one or more inputs and in accordance with a determination that the virtual object has the first size relative to the viewpoint of the user, in accordance with a determination that a characteristic (e.g., magnitude and/or a target) of the first set of one or more inputs is a first characteristic (e.g., a first magnitude and/or a first target), such as the magnitude of the movement of the second resize element 720 provided by the hand 703 in FIG. 7H, the second amount of curvature is a first respective amount of curvature corresponding to the first characteristic, such as the amount of curvature of the surface of the virtual object 710 shown in FIG. 7I. In some embodiments, in accordance with a determination that the characteristics of the first set of one or more inputs is a second characteristic (e.g., a second magnitude and/or a second target), different from the first characteristic, such as the magnitude of the movement of the second resize element 720 provided by the hand in FIG. 7I, the second amount of curvature is a second respective amount of curvature, different from the first respective amount of curvature, corresponding to the second characteristic, such as the amount of curvature of the surface of the virtual object 710 shown in FIG. 7J. For example, if the first set of one or more inputs includes movement of an interaction element associated with the virtual object, such as a resize element or movement element as discussed above, the computer system continuously changes the curvature of the virtual object to a value of curvature in accordance with the movement of the interaction element (e.g., based on a direction and/or magnitude (e.g., of speed and/or distance) of the movement of the interaction element) in the environment. For example, the second amount of curvature of the respective portion of the virtual object directly corresponds to and/or is directly determined according to the first set of one or more inputs. In some embodiments, the second respective amount of curvature is different from the first respective amount of curvature in terms of a radius of curvature (e.g., measured in degrees relative to a center point on the surface of the virtual object, relative to the viewpoint of the user, or other reference point). For example, the radius of curvature of the virtual object is a radius of curvature of the front-facing surface of the virtual object from the viewpoint of the user in the three-dimensional environment. In some embodiments, a difference between the first amount of curvature and the second amount of curvature is based on the movement input, such as a displacement of the virtual object in the environment relative to the viewpoint of the user or a displacement of a resize element to which the movement input is directed in the environment, as discussed in more detail below. In some embodiments, the particular value of curvature of the virtual object that is selected when changing the curvature of the virtual object in response to detecting the selection input is based on the size of the virtual object relative to the viewpoint of the user, as similarly discussed above. For example, if the virtual object has a second size, greater than the first size, relative to the viewpoint of the user when the selection input is detected, the computer system changes the curvature of the virtual object from the first amount of curvature to a third amount of curvature, greater than the first amount of curvature and the second amount of curvature, wherein the third amount of curvature is a determined based on the movement input directed to the virtual object. Changing a curvature of a surface of a virtual object in a three-dimensional environment in response to detecting a movement input directed to the virtual object based on a size of the virtual object relative to the viewpoint of the user enables content included on the surface of the virtual object to remain visibly displayed in the three-dimensional environment for larger sizes of the virtual object relative to the viewpoint of the user and/or enables the curvature of the surface of the virtual object to be changed automatically for given user input that adjusts the location of the virtual object relative to the viewpoint of the user, thereby improving user-device interaction.

In some embodiments, in accordance with a determination that the movement input corresponds to movement of an interaction element (e.g., a movement element, such as a grabber bar, or a resize element, such as a scale element, as discussed above) associated with the virtual object (e.g., displayed with, such as adjacent to a portion of the virtual object) in a first direction in the environment relative to the viewpoint of the user, such as the direction of the movement of the second resize element 720 provided by the hand 703 in FIG. 7F, the second amount of curvature corresponds to an increase in the curvature of the respective portion of the virtual object, such as increasing the curvature of the surface of the virtual object 710 as shown in FIG. 7G. In some embodiments, in accordance with a determination that the movement input corresponds to movement of the movement element associated with the virtual object in a second direction, different from (e.g., opposite) the first direction, in the environment relative to the viewpoint of the user, such as the direction of the movement of the second resize element 720 provided by the hand 703 in FIG. 7T, the second amount of curvature corresponds to a decrease in the curvature of the respective portion of the virtual object (e.g., a decrease in a radius of curvature (e.g., measured in degrees), as similarly described above), such as decreasing the curvature of the surface of the virtual object 710 as shown in FIG. 7U. For example, the computer system changes the curvature of the virtual object based on the direction of the movement of the interaction element associated with the virtual object in the environment relative to the viewpoint of the user. In some embodiments, as similarly discussed above, the interaction element corresponds to a movement element associated with the virtual object in the environment. In some embodiments, the first direction of the movement of the movement element relative to the viewpoint of the user causes the virtual object to be moved toward the viewpoint of the user in the environment, which causes the computer system to increase the amount of curvature of the virtual object in the environment. In some embodiments, the second direction of the movement of the movement element relative to the viewpoint of the user causes the virtual object to be moved away from the viewpoint of the user in the environment, which causes the computer system to decrease the amount of curvature of the virtual object in the environment. In some embodiments, as similarly discussed above, the interaction element corresponds to a resize element associated with the virtual object in the environment. In some embodiments, the first direction of the movement of the resize element relative to the viewpoint of the user causes the size of the virtual object to be increased relative to the viewpoint of the user in the environment, which causes the computer system to increase the amount of curvature of the virtual object in the environment. In some embodiments, the second direction of the movement of the resize element relative to the viewpoint of the user causes the size of the virtual object to be decreased relative to the viewpoint of the user in the environment, which causes the computer system to decrease the amount of curvature of the virtual object in the environment. Changing a curvature of a surface of a virtual object in a three-dimensional environment in response to detecting a movement input directed to the virtual object based on a direction of the movement input relative to the viewpoint of the user enables content included on the surface of the virtual object to remain visibly displayed in the three-dimensional environment based on the movement input relative to the viewpoint of the user and/or enables the curvature of the surface of the virtual object to be changed automatically for given user input that adjusts the location and/or size of the virtual object relative to the viewpoint of the user, thereby improving user-device interaction.

In some embodiments, the first direction of the movement of the interaction element associated with the virtual object in the environment causes a size of the virtual object to increase relative to the environment, such as the size of the virtual object 710 increasing in FIG. 7G. In some embodiments, the second direction of the movement of the interaction element associated with the virtual object in the environment causes the size of the virtual object to decrease relative to the environment, such as the size of the virtual object 710 decreasing in FIG. 7U. For example, as similarly discussed above, the computer system changes the curvature of the virtual object based on whether the size of the virtual object is increased or decreased in the environment relative to the viewpoint of the user in response to detecting the first set of one or more inputs. In some embodiments, if the interaction element corresponds to the resize element discussed above, the movement of the resize element causes the size of the virtual object to change based on the direction of the movement of the resize element in the environment. For example, movement of the resize element in the first direction relative to the viewpoint of the user causes the size of the virtual object to increase in the environment, which causes the curvature of the virtual object to be increased in the environment. In some embodiments, movement of the resize element in the second direction relative to the viewpoint of the user causes the size of the virtual object to decrease in the environment, which causes the curvature of the virtual object to be decreased in the environment. Changing a curvature of a surface of a virtual object in a three-dimensional environment in response to detecting a movement of a resize element associated with the virtual object based on a direction of the movement of the resize element relative to the viewpoint of the user enables content included on the surface of the virtual object to remain visibly displayed in the three-dimensional environment based on the size of the virtual object relative to the viewpoint of the user and/or enables the curvature of the surface of the virtual object to be changed automatically for given user input that adjusts the size of the virtual object relative to the viewpoint of the user, thereby improving user-device interaction.

In some embodiments, the first direction of the movement of the interaction element associated with the virtual object in the environment causes a distance between the virtual object and the viewpoint of the user to decrease in the environment, such as the decreased distance between the virtual object 710 and the viewpoint of the user 702 indicated in the top-down view 705 in FIG. 7X. In some embodiments, the second direction of the movement of the interaction element associated with the virtual object in the environment causes the distance between the virtual object and the viewpoint of the user to increase in the environment, such as the increased distance between the virtual object 710 and the viewpoint of the user 702 indicated in the top-down view 705 in FIG. 7Z. For example, as similarly discussed above, the computer system changes the curvature of the virtual object based on whether the virtual object is moved closer to or farther from the viewpoint of the user in the environment relative to the viewpoint of the user in response to detecting the first set of one or more inputs. In some embodiments, if the interaction element corresponds to the movement element discussed above, the movement of the movement element causes the location of the virtual object relative to the viewpoint of the user to change based on the direction of the movement of the movement element in the environment. For example, movement of the movement element in the first direction relative to the viewpoint of the user causes the distance between the viewpoint of the user and the virtual object to decrease in the environment relative to the viewpoint of the user, which causes the curvature of the virtual object to be increased in the environment. In some embodiments, movement of the movement element in the second direction relative to the viewpoint of the user causes the distance between the viewpoint of the user and the virtual object to increase in the environment relative to the viewpoint of the user, which causes the curvature of the virtual object to be decreased in the environment. Changing a curvature of a surface of a virtual object in a three-dimensional environment in response to detecting a movement of a movement element associated with the virtual object based on a direction of the movement of the movement element relative to the viewpoint of the user enables content included on the surface of the virtual object to remain visibly displayed in the three-dimensional environment based on the location of the virtual object relative to the viewpoint of the user and/or enables the curvature of the surface of the virtual object to be changed automatically for given user input that adjusts the location of the virtual object relative to the viewpoint of the user, thereby improving user-device interaction.

In some embodiments, in accordance with a determination that the movement input corresponds to movement of an interaction element (e.g., a movement element, such as a handle, a grabber bar, or a resize element, such as a scale element, as discussed above) associated with (e.g., displayed with, such as adjacent to a portion of) the virtual object by a first amount in the environment from the viewpoint of the user, such as the magnitude of the movement of the second resize element 720 from FIG. 7H to FIG. 7I, the second amount of curvature is a first respective amount of curvature, such as the amount of curvature of the surface of the virtual object 710 in FIG. 7I. In some embodiments, in accordance with a determination that the movement input corresponds to movement of the interaction element associated with the virtual object by a second amount, larger than the first amount, in the environment from the viewpoint of the user, such as the magnitude of the movement of the second resize element 720 from FIG. 7H to FIG. 7J, the second amount of curvature is a second respective amount of curvature, larger than the first respective amount of curvature, such as the amount of curvature of the surface of the virtual object 710 in FIG. 7J. For example, the computer system changes the curvature of the virtual object by an amount that is based on the magnitude (e.g., of speed and/or distance) of the movement input directed to the virtual object in the environment. In some embodiments, the magnitude of the movement of the interaction element associated with the virtual object determines an amount by which the size of the virtual object is changed in the environment relative to the viewpoint of the user, which determines the amount by which the curvature is changed in the environment. For example, the movement of the interaction element by the first amount in the environment causes the size of the virtual object to increase by a first amount relative to the viewpoint of the user in the environment, which causes the computer system to increase the curvature of the virtual object by the first respective amount in the environment. In some embodiments, the movement of the interaction element by the second amount in the environment causes the size of the virtual object to increase by a second amount, larger than the first amount, relative to the viewpoint of the user in the environment, which causes the computer system to increase the curvature of the virtual object by the second respective amount, greater than the first respective amount, in the environment. Changing a curvature of a surface of a virtual object in a three-dimensional environment in response to detecting a movement input directed to the virtual object based on a magnitude of the movement input relative to the viewpoint of the user enables content included on the surface of the virtual object to remain visibly displayed in the three-dimensional environment based on the movement input relative to the viewpoint of the user and/or enables the curvature of the surface of the virtual object to be changed automatically for given user input that adjusts the location and/or size of the virtual object relative to the viewpoint of the user, thereby improving user-device interaction.

In some embodiments, while displaying the virtual object in the environment, the computer system detects, via the one or more input devices, a second set of one or more inputs corresponding to a request to decrease a size of the virtual object in the environment, such as the air pinch and drag gesture provided by the first hand 707 and the second hand 703 directed to the virtual object 710 in FIG. 7R. For example, the computer system detects one or more air gestures performed by a hand of the user directed to the virtual object for decreasing the size of the virtual object in the environment relative to the viewpoint of the user. In some embodiments, as similarly discussed above, the computer system detects interaction with a resize element displayed with the virtual object, such as selection of the resize element (e.g., via an air pinch gesture), followed by movement of the resize element (e.g., via an air drag gesture) in a respective direction and/or with a respective magnitude (e.g., of speed and/or distance) for decreasing the size (e.g., including scale) of the virtual object in the environment. In some embodiments, as similarly discussed above, the computer system detects a two-handed air pinch and drag gesture (e.g., performed concurrently by the two hands of the user) for decreasing the size of the virtual object in the environment. In some embodiments, the second set of one or more inputs has one or more characteristics of the first set of one or more inputs discussed above.

In some embodiments, in response to detecting the second set of one or more inputs, the computer system decreases the size of the virtual object in the environment based on the second set of one or more inputs, such as decreasing the size of the virtual object 710 in the three-dimensional environment 700 as shown from FIG. 7R to FIG. 7S, including, during a first portion of the second set of one or more inputs, such as a first portion of the movement of the first hand 707 and/or the second hand 703, changing the curvature of the respective portion of the virtual object (e.g., decreasing the curvature of the virtual object) towards a third amount of curvature (e.g., curvature of the virtual object 710 in FIG. 7S) at a first rate (e.g., a first amount of change in curvature per unit magnitude of movement associated with the second set of one or more inputs). In some embodiments, during a second portion of the second set of one or more inputs, after the first portion, of the second set of one or more inputs, such as a subsequent portion of the movement of the first hand 707 and/or the second hand 703, the computer system changes the curvature of the respective portion of the virtual object towards the third amount of curvature at a second rate (e.g., a second amount of change in curvature per unit magnitude of movement associated with the second set of one or more inputs), lower than the first rate, as similarly described with reference to decreasing the curvature of the virtual object 710 in FIG. 7S. For example, the computer system changes the curvature of the virtual object non-linearly relative to the decrease in size of the virtual object in the environment. Particularly, in some embodiments, the computer system decreases the curvature faster (e.g., at the first rate) when first decreasing the size of the virtual object (e.g., during the first portion of the second set of one or more inputs) and decreases the curvature slower (e.g., at the second rate) when decreasing the size of the virtual object during the second portion of the second set of one or more inputs. In some embodiments, the first portion and the second portion of the second set of one or more inputs are based on a duration of the second set of one or more inputs. For example, the first portion of the second set of one or more inputs corresponds to a first portion (e.g., a first duration) of the second set of one or more inputs and the second portion corresponds to a subsequent portion (e.g., a second duration) of the second set of one or more inputs. In some embodiments, the first portion and the second portion of the second set of one or more inputs are based on the corresponding decrease in size of the virtual object. For example, the first portion of the second set of one or more inputs is defined as the portion of the second set of one or more inputs that causes the size of the virtual object to be decreased to a first respective size, and the second portion of the second set of one or more inputs is defined as the portion of the second set of one or more inputs that causes the size of the virtual object to be decreased below the first respective size. In some embodiments, the size of the virtual object is decreased linearly in response to detecting the second set of one or more inputs despite the curvature of the virtual object being changed nonlinearly as discussed above. Changing a curvature of a surface of a virtual object in a three-dimensional environment in a nonlinear fashion in response to detecting input for decreasing a size of the virtual object in the three-dimensional environment relative to the viewpoint of the user enables content included on the surface of the virtual object to remain visibly displayed in the three-dimensional environment based on the change in size of the virtual object relative to the viewpoint of the user, while providing the eyes of the user time to adjust to the updated curvature of the virtual object, which helps prevent user discomfort while viewing the virtual object, thereby improving user-device interaction.

In some embodiments, while displaying the virtual object with the second amount of curvature in the environment in accordance with the determination that the virtual object has the first size relative to the viewpoint of the user in response to detecting the selection of the movement element associated with the virtual object in the environment, the computer system detects, via the one or more input devices, movement of the viewpoint of the user relative to the virtual object, such as the movement of the viewpoint of the user 702 as indicated by the arrow 735 in the top-down view 705 in FIG. 7W. For example, as similarly discussed above, after detecting the first set of one or more inputs, the computer system detects movement of a head and/or a location of the user in the physical environment of the computer system, which cause the location of the viewpoint of the user to change in the environment.

In some embodiments, in response to detecting the movement of the viewpoint of the user, the computer system changes a size of the virtual object in the environment relative to an updated viewpoint of the user without changing the curvature of the respective portion of the virtual object, such as increasing the apparent size of the virtual object 710 relative to the updated viewpoint of the user 702 in the three-dimensional environment 700 in FIG. 7X. For example, the computer system detects the movement of the viewpoint of the user without detecting other input directed to the virtual object, such as a selection input or a movement input directed to the virtual object in the environment. In some embodiments, the movement of the viewpoint of the user causes the distance between the viewpoint and the virtual object in the environment to change, which optionally causes the apparent size of the virtual object relative to the updated viewpoint of the user to change accordingly. For example, if the movement of the viewpoint of the user causes a distance between the virtual object and the viewpoint to increase, the apparent size of the virtual object decreases in the environment relative to the updated viewpoint of the user. In some embodiments, if the movement of the viewpoint of the user causes the distance between the virtual object and the viewpoint to decrease, the apparent size of the virtual object increases in the environment relative to the updated viewpoint of the user. In either case, because the second set of one or more inputs does not include a request to interact with (e.g., select and/or move) the virtual object within the environment (e.g., does not include input provided by the hand of the user), the computer system forgoes changing the curvature of the virtual object in the environment (e.g., despite the change in the apparent size of the virtual object relative to the updated viewpoint of the user). Forgoing changing a curvature of a surface of a virtual object in a three-dimensional environment after detecting movement of the viewpoint of the user enables content included on the surface of the virtual object to remain visibly displayed in the three-dimensional environment for different locations of the virtual object relative to the viewpoint of the user and/or helps avoid unintentional changing of the curvature of the surface of the virtual object in the three-dimensional environment, thereby improving user-device interaction and conserving computing resources associated with correcting such change.

In some embodiments, after changing the size of the virtual object in the environment relative to the updated viewpoint of the user in response to detecting the movement of the viewpoint of the user, the computer system detects, via the one or more input devices, an input corresponding to selection of an interaction element (e.g., a movement element, such as a grabber bar, or a resize element, such as a scale element, as discussed above) associated with (e.g., displayed with, such as adjacent to a portion of) the virtual object in the environment, such as a selection of the movement element 712 provided by the hand 703 in FIG. 7X. For example, after detecting the movement of the viewpoint of the user discussed above, the computer system detects one or more air gestures performed by a hand of the user. In some embodiments, the selection of the interaction element includes a request to initiate movement of the virtual object and/or initiate resizing of the virtual object in the environment relative to the viewpoint of the user. For example, the computer system detects an air pinch gesture directed to a movement element (e.g., a handle or grabber bar) associated with the virtual object or a resize element associated with the virtual object in the environment. In some embodiments, the selection of the movement element is detected while detecting the movement of the viewpoint of the user. In some embodiments, the selection of the interaction element associated with the virtual object has one or more characteristics of interaction with interaction elements associated with the virtual object discussed above.

In some embodiments, in response to detecting the input, in accordance with a determination that the virtual object has a second size relative to the updated viewpoint of the user in the environment (e.g., the second size of the virtual object relative to the updated viewpoint of the user is based on the movement of the viewpoint discussed above), such as the size of the virtual object 710 in FIG. 7X relative to the updated viewpoint of the user 702, the computer system changes the curvature of the respective portion of the virtual object from the second amount of curvature to a third amount of curvature, different from the second amount of curvature, such as increasing the curvature of the surface of the virtual object 710 as shown in FIG. 7Y. For example, in response to detecting a selection of the interaction element associated with the virtual object with the environment, without necessarily including movement of the interaction element, the computer system changes the curvature of the virtual object in the environment based on the change in the apparent size of the virtual object (e.g., the second size of the virtual object) relative to the updated viewpoint of the user. In some embodiments, as similarly discussed above, if the second size relative to the updated viewpoint of the user is greater than the first size discussed above, the computer system increases the curvature of the virtual object in the environment in response to detecting the input. In some embodiments, if the second size relative to the updated viewpoint of the user is smaller than the first size discussed above, the computer system decreases the curvature of the virtual object in the environment in response to detecting the input. Changing a curvature of a surface of a virtual object in a three-dimensional environment after detecting movement of a viewpoint of the user in response to detecting selection of an interaction element associated with the virtual object based on a size of the virtual object relative to the updated viewpoint of the user enables content included on the surface of the virtual object to remain visibly displayed in the three-dimensional environment for different sizes of the virtual object relative to the updated viewpoint of the user and/or enables the curvature of the surface of the virtual object to be changed automatically for changes in location of the viewpoint of the user, thereby improving user-device interaction.

In some embodiments, while displaying the virtual object with the second amount of curvature in accordance with the determination that the virtual object has the first size relative to the viewpoint of the user in response to detecting the first set of one or more inputs, the computer system detects, via the one or more input devices, movement of the viewpoint of the user relative to the virtual object, such as the movement of the viewpoint of the user 702 as indicated by the arrow 735 in the top-down view 705 in FIG. 7W. For example, as similarly discussed above, after detecting the first set of one or more inputs, the computer system detects movement of a head and/or a location of the user in the physical environment of the computer system, which cause the location of the viewpoint of the user to change in the environment.

In some embodiments, in response to detecting the movement of the viewpoint of the user, in accordance with a determination that the movement of the viewpoint of the user is detected while an interaction element (e.g., a movement element, such as a grabber bar, or a resize element, such as a scale element, as discussed above) associated with the virtual object (e.g., displayed with the virtual object, such as adjacent to a portion of the virtual object) in the environment is selected (e.g., is being interacted-with), such as the selection of the movement element 712 provided by the hand 703 in FIG. 7Y during the movement of the viewpoint of the user 702, the computer system changes the curvature of the respective portion of the virtual object from the second amount of curvature to a third amount of curvature that is different from the second amount of curvature, such as decreasing the curvature of the surface of the virtual object 710 as shown in FIG. 7Z. In some embodiments, as similarly discussed above, the movement of the viewpoint of the user causes a distance between the viewpoint of the user and the virtual object in the environment to change, which optionally causes an apparent size of the virtual object relative to the updated viewpoint of the user to change accordingly. For example, if the movement of the viewpoint of the user causes a distance between the virtual object and the viewpoint to increase, the apparent size of the virtual object decreases in the environment relative to the updated viewpoint of the user. In some embodiments, if the movement of the viewpoint of the user causes the distance between the virtual object and the viewpoint to decrease, the apparent size of the virtual object increases in the environment relative to the updated viewpoint of the user. In either case, because the movement of the viewpoint is accompanied by a selection of the interaction element associated with the virtual object (e.g., the movement element or resize element discussed above) within the environment, without necessarily including movement of the interaction element, the computer system changes the curvature of the virtual object in the environment based on the change in the apparent size of the virtual object relative to the updated viewpoint of the user. For example, if the size of the virtual object increases relative to the updated viewpoint of the user during the detection of the movement of the viewpoint of the user, the computer system increases the curvature of the virtual object (e.g., while concurrently detecting the movement of the viewpoint of the user), and if the size of the virtual object decreases relative to the updated viewpoint of the user during the detection of the movement of the viewpoint of the user, the computer system decreases the curvature of the virtual object.

In some embodiments, in accordance with a determination that the movement of the viewpoint of the user is detected while the interaction element associated with the virtual object in the environment is not selected (e.g., is not being interacted-with), the computer system forgoes changing the curvature of the respective portion of the virtual object (e.g., the computer system updates an apparent size of the virtual object in the environment relative to the viewpoint of the user based on the movement of the viewpoint and/or maintains the curvature of the respective portion of the virtual object), such as forgoing changing the curvature of the surface of the virtual object 710 as shown in FIG. 7X. For example, because the interaction element is not selected in the environment while the movement of the viewpoint of the user is detected, the apparent size of the virtual object changes relative to the updated viewpoint of the user based on the movement of the viewpoint without the curvature of the virtual object being changed based on the updated apparent size of the virtual object. Changing a curvature of a surface of a virtual object in a three-dimensional environment in response to detecting movement of a viewpoint of the user while detecting selection of an interaction element associated with the virtual object based on a size of the virtual object relative to the updated viewpoint of the user enables content included on the surface of the virtual object to remain visibly displayed in the three-dimensional environment for different sizes of the virtual object relative to the updated viewpoint of the user and/or enables the curvature of the surface of the virtual object to be changed automatically for changes in location of the viewpoint of the user, thereby improving user-device interaction.

In some embodiments, prior to detecting the first set of one or more inputs, the virtual object is associated with one or more interaction elements (e.g., a movement element, such as a grabber bar, and/or one or more resize elements, including a scale element, as discussed above) that are displayed at one or more first locations in the environment relative to the viewpoint of the user, such as the second resize element 720 in FIG. 7U. For example, as similarly discussed above, the one or more interaction elements are displayed with (e.g., adjacent to) respective portions of the virtual object in the environment from the viewpoint of the user. In some embodiments, as similarly discussed herein, the movement element associated with the virtual object, which is selectable (e.g., via an air gesture) to initiate movement of the virtual object within the environment relative to the viewpoint of the user, is displayed below the virtual object and/or in front of the virtual object relative to the viewpoint of the user. In some embodiments, a first resize element, which is selectable to change a simulated resolution of the virtual object, as discussed above, is displayed adjacent to a side/edge of the virtual object (e.g., a right or left side) from the viewpoint of the user. In some embodiments, a second resize element, which is selectable to change a scale of the virtual object relative to the viewpoint of the user, as discussed above, is displayed adjacent to a corner of the virtual object from the viewpoint of the user in the environment.

In some embodiments, in response to detecting the first set of one or more inputs, in accordance with the determination that the virtual object has the first size in the environment relative to the viewpoint of the user, such as the size of the virtual object 710 relative to the viewpoint of the user 702 in FIG. 7V, the computer system updates display, via the one or more display generation components, of the one or more interaction elements to be at one or more second locations, different from the one or more first locations, in the environment relative to the viewpoint of the user, such as the movement of the second resize element 720 in the three-dimensional environment 700 as shown in FIG. 7V. For example, when the computer system changes the curvature of the virtual object in response to detecting the first set of one or more inputs as discussed above, the computer system moves the one or more interaction elements in the environment relative to the viewpoint of the user. In some embodiments, the computer system updates the location(s) of the one or more interaction elements in the environment relative to the viewpoint of the user to maintain a spatial relationship between the one or more interaction elements and the virtual object in the environment when the curvature of the virtual object is changed. For example, the computer system moves the first and/or second resize elements discussed above to maintain them displayed adjacent to a side and/or a corner, respectively, of the virtual object from the viewpoint of the user when the curvature of the virtual object is changed. In some embodiments, one or more locations in the one or more second locations correspond to and/or overlap with one or more locations in the one or more first locations discussed above, such as a location of the movement element relative to the viewpoint of the user in the environment. In some embodiments, the one or more second locations are determined based on the amount of curvature of the respective portion of the virtual object in the environment. For example, if the curvature of the respective portion of the virtual object has a first respective amount of curvature in the environment, the one or more second locations are one or more first respective locations, and if the curvature of the respective portion of the virtual object has a second respective amount of curvature, different from the first respective amount of curvature, in the environment, the one or more second locations are one or more second respective locations, different from the one or more first respective locations. Changing locations at which interaction elements that are associated with a virtual object are displayed in a three-dimensional environment relative to the viewpoint of the user when changing a curvature of a surface of the virtual object in the three-dimensional environment enables the interaction elements to remain visibly displayed in the three-dimensional environment for different curvatures of the virtual object relative to the viewpoint of the user and/or enables the locations of the interaction elements associated with the virtual object to be changed automatically for given user input that adjusts the curvature of the virtual object relative to the viewpoint of the user, thereby improving user-device interaction.

In some embodiments, the respective portion of the virtual object is displayed with a simulated three-dimensional material (e.g., a simulated surface material, such as a simulated laminate or coating on the respective portion of the virtual object), such as the simulated coating of the surface of the virtual object 710 described with reference to FIG. 7G, and prior to (e.g., and/or when) detecting the first set of one or more inputs, the simulated three-dimensional material has a first simulated three-dimensional structure based on the first amount of curvature, such as the simulated three-dimensional structure of the coating of the surface of the virtual object 710 in FIG. 7F. For example, when the computer system detects the first set of one or more inputs discussed above, the first simulated three-dimensional structure causes the front-facing surface of the virtual object to visually appear to be smooth (e.g., in addition to optionally being flat) in the environment from the viewpoint of the user. In some embodiments, the first simulated three-dimensional structure of the simulated three-dimensional material causes the edges/sides and/or corners of the virtual object to visually appear to be smooth as well in the environment from the viewpoint of the user.

In some embodiments, in response to detecting the first set of one or more inputs, in accordance with the determination that the virtual object has the first size in the environment relative to the viewpoint of the user, the computer system changes the simulated three-dimensional material of the respective portion of the virtual object from the first simulated three-dimensional structure to a second simulated three-dimensional structure, different from the first simulated three-dimensional structure, such as the simulated three-dimensional structure of the coating of the surface of the virtual object 710 in FIG. 7G, wherein the second simulated three-dimensional structure is based on the second amount of curvature. For example, when the computer system changes the curvature of the virtual object as previously discussed above, the computer system changes (e.g., deforms) the simulated three-dimensional material of the front-facing surface of the virtual object based on the curvature of the virtual object to enable the front-facing surface to continue to visually appear to be smooth in the environment from the viewpoint of the user. In some embodiments, the second simulated three-dimensional structure of the simulated three-dimensional material enables the edges/sides and/or corners of the virtual object to continue to visually appear to be smooth in the environment from the viewpoint of the user when the curvature of the virtual object is changed in the environment. In some embodiments, the computer system concurrently changes the simulated three-dimensional material of the respective portion of the virtual object while changing the curvature of the virtual object in the environment in response to detecting the first set of one or more inputs discussed above. In some embodiments, in accordance with a determination that the computer system does not change the curvature of the virtual object in response to detecting the first set of one or more inputs (e.g., because the virtual object has a second size, smaller than the first size, in the environment relative to the viewpoint of the user), the computer system forgoes changing the simulated three-dimensional material of the respective portion of the virtual object in the environment. Changing a simulated three-dimensional material of a virtual object in a three-dimensional environment relative to the viewpoint of the user when changing a curvature of a surface of the virtual object in the three-dimensional environment enables the surface of the virtual object to continue to visually appear to be smooth relative to the viewpoint of the user, which helps maintain visibility of content of the virtual object in the three-dimensional environment for different curvatures of the virtual object relative to the viewpoint of the user, thereby improving user-device interaction.

In some embodiments, the user of the computer system is participating in a communication session with one or more participants when the first set of one or more inputs is detected, such as a second user represented by representation 704 in FIG. 7BB. In some embodiments, the communication session is a real-time (e.g., or nearly real-time) communication session that includes audio (e.g., real-time voice audio from the user of the computer system and/or the one or more participants, and/or audio content from media shared between the user and the one or more participants), video (e.g., real-time video of the environment of the user and/or the one or more participants, and/or video content from media shared between the user and the one or more participants) and/or other shared content (e.g., images, applications, and/or interactive media (e.g., video game media), including the first object). In some embodiments, the computer system optionally initiates and/or receives a request to join the communication session with one or more second computer systems associated with the one or more participants. In some embodiments, in response to initiating and/or receiving the request to join the communication session, the computer systems initiate display of the three-dimensional environment to facilitate communication between the user of the computer system and the one or more participants (e.g., via their respective computer systems). In some embodiments, while the user is participating in the communication session with the one or more participants, the computer system displays one or more visual representations of the one or more participants, such as a visual representation of a second user of a second computer system. In some embodiments, the visual representation of the second user corresponds to a virtual avatar. For example, the virtual avatar corresponds to the second user (e.g., having one more visual characteristics corresponding to one or more physical characteristics of the user, such as the user's height, posture, skin color, eye color, hair color, relative physical dimensions, facial features and/or position within the three-dimensional environment). In some embodiments, the computer system displays the visual representation of the second user with a visual appearance having a degree of visual prominence relative to the three-dimensional environment. The degree of visual prominence optionally corresponds to a form of the representation of the second user (e.g., an avatar having a human-like form and/or appearance or an abstracted avatar including less human-like form (e.g., corresponding to a generic two-dimensional or three-dimensional object, such as a virtual coin or a virtual sphere)). For example, the degree of visual prominence optionally includes and/or corresponds to a simulated blurring effect, a level of opacity, a simulated lighting effect, a saturation, and/or a brightness of a portion or all of the avatar. In some embodiments, the three-dimensional environment includes the visual representation at a location visible from the viewpoint of the user (e.g., inside of the viewport of the user). In some embodiments, the visual representation is located outside the field of view of the user from the viewpoint of the user. For example, the first visual representation is located behind the viewpoint of the user within the three-dimensional environment (e.g., outside of the viewport of the user).

In some embodiments, while displaying the virtual object in the environment, wherein the respective portion of the virtual object has a respective amount of curvature (e.g., the first amount of curvature, the second amount of curvature, or other amount of curvature) and the virtual object is shared in the communication session (e.g., the content of the virtual object is viewable by and/or interactable between the user and the one or more participants in the real-time communication session), as indicated by option 738 in FIG. 7CC, the computer system detects, via the one or more input devices, a second set of one or more inputs corresponding to a request to initiate a process to adjust the one or more spatial properties of the virtual object in the environment, such as the input provided by the hand 703 directed to the movement element 712 in FIG. 7CC. For example, the second set of one or more inputs includes one or more air gestures performed by a hand of the user. In some embodiments, the second set of one or more inputs includes a request to initiate movement of the virtual object in the environment relative to the viewpoint of the user. For example, the second set of one or more inputs includes interaction with a movement element (e.g., a grabber bar) associated with the virtual object and that is selectable to initiate movement of the virtual object in the environment relative to the viewpoint of the user. In some embodiments, the second set of one or more inputs includes movement of the viewpoint of the user relative to the virtual object in the environment. For example, the computer system detects movement of a head and/or a location of the user in the physical environment of the computer system, which cause the location of the viewpoint of the user to change in the environment. In some embodiments, the second set of one or more inputs includes a request to resize the virtual object in the environment relative to the viewpoint of the user, such as via interaction with a resize element associated with the virtual object, as similarly discussed above. In some embodiments, the second set of one or more inputs has one or more characteristics of the first set of one or more inputs discussed above.

In some embodiments, in response to detecting the second set of one or more inputs, in accordance with a determination that a spatial parameter associated with the one or more participants in the communication session has a first value, such as the number of participants in the communication session including the user 702 in the top-down 705 in FIG. 7Z, the computer system changes the curvature of the respective portion of the virtual object from the respective amount of curvature to a third amount of curvature that is different from the respective amount of curvature, such as increasing the curvature of the surface of the virtual object 710 as shown in FIG. 7AA. In some embodiments, the spatial parameter associated with the one or more participants in the communication session includes and/or corresponds to a number of participants in the communication session. For example, the first value of the spatial parameter indicates that a first number of total participants, including the user of the computer system, are in the communication session. In some embodiments, the spatial parameter associated with the one or more participants in the communication session includes and/or corresponds to a spatial distribution of the one or more participants relative to the viewpoint of the user. For example, the first value of the spatial parameter indicates that the one or more participants (e.g., one or more visual representations of the one or more participants) have a first spatial distribution relative to the viewpoint of the user in the environment (e.g., the one or more visual representations of the one or more participants are located at one or more first locations relative to the viewpoint of the user and/or are located one or more first distances from the viewpoint of the user in the environment). In some embodiments, the spatial distribution relative to the viewpoint of the user in the environment includes a distance between the one or more participants relative to the viewpoint of the user, such as a distance between a first participant (e.g., other than the user of the computer system) and a second participant, different from the first participant, in the environment relative to the viewpoint of the user. In some embodiments, the computer system changes the curvature of the virtual object based on the spatial parameter associated with the one or more participants in the communication session (e.g., in addition to changing the curvature based on the size of the virtual object, such as the scale and/or aspect ratio of the virtual object, relative to the viewpoint of the user), as discussed below.

In some embodiments, in accordance with a determination that the spatial parameter has a second value, different from the first value, such as the number of participants in the communication session including the user 702 and the second user in the top-down 705 in FIG. 7CC, the computer system changes the curvature of the respective portion of the virtual object from the respective amount of curvature to a fourth amount of curvature that is different from the respective amount of curvature and the third amount of curvature, such as decreasing the curvature of the surface of the virtual object 710 as shown in FIG. 7DD. For example, the second value of the spatial parameter indicates that a second number, different from the first number, of total participants, including the user of the computer system, are in the communication session. In some embodiments, the second value of the spatial parameter indicates that the one or more participants (e.g., one or more visual representations of the one or more participants) have a second spatial distribution, different from the first spatial distribution, relative to the viewpoint of the user in the environment (e.g., the one or more visual representations of the one or more participants are located at one or more second locations relative to the viewpoint of the user and/or are located one or more second distances from the viewpoint of the user in the environment). In some embodiments, the third amount of curvature is greater than the fourth amount of curvature. In some embodiments, the third amount of curvature is smaller than the fourth amount of curvature. In some embodiments, the fourth amount of curvature is different from the respective amount of curvature and the third amount of curvature in terms of a radius of curvature (e.g., measured in degrees relative to a center point on the surface of the virtual object, relative to the viewpoint of the user, or other reference point). For example, the radius of curvature of the virtual object is a radius of curvature of the front-facing surface of the virtual object from the viewpoint of the user in the three-dimensional environment. In some embodiments, as similarly discussed above, the computer system concurrently changes the curvature of the virtual object based on the spatial parameter while updating the one or more spatial properties (e.g., size, location, and/or orientation) of the virtual object in the environment in response to detecting the second set of one or more inputs. In some embodiments, in accordance with a determination that, when the second set of one or more inputs is detected, the virtual object is not shared (e.g., is a private object, as discussed in more detail below), the computer system optionally changes the curvature of the respective portion of the virtual object independent of (e.g., without regard to) the value of the spatial parameter as discussed above. For example, the computer system changes the curvature of the virtual object based on the size of the virtual object in the environment relative to the viewpoint of the user as previously described herein. Changing a curvature of a surface of a virtual object that is shared in a communication session in a three-dimensional environment when changing one or more spatial properties of the virtual object based on a spatial parameter associated with the participants in the communication session enables content included on the surface of the virtual object to remain visibly displayed in the three-dimensional environment for the different participants in the communication session and/or enables the curvature of the surface of the virtual object to be changed automatically for given user input that adjusts the size of the virtual object for the different participants in the communication session, thereby improving user-device interaction and overall user experience during the communication session.

In some embodiments, the first value of the spatial parameter corresponds to the one or more participants participating in the communication session being a first number of participants (e.g., a first total number of participants in the communication session, including the user of the computer system). In some embodiments, the second value of the spatial parameter corresponds to the one or more participants participating in the communication session being a second number of participants, greater than the first number of participants (e.g., a second total number of participants in the communication session, including the user of the computer system), such as the two participants including the user 702 and the second user (e.g., represented by representation 704) in the top-down 705 in FIG. 7CC. In some embodiments, the third amount of curvature is greater than the fourth amount of curvature, such as the curvature of the surface of the virtual object 710 being greater in FIG. 7DD than in FIG. 7CC. For example, for greater numbers of participants in the real-time communication session, the computer system decreases the curvature of the virtual object in the environment. In some embodiments, the decreased curvature of the virtual object enables the content of the virtual object, such as the content of the virtual instance of the second computer system discussed above, to remain visible and/or interactive to the different participants in the communication session, including the user of the computer system, from the unique locations of the viewpoints of the participants in the communication session. In some embodiments, an increased number of participants in the communication session causes the content of the virtual object to be viewed and/or interacted with from a larger range of different viewing angles associated with the participants. Accordingly, in some embodiments, decreasing the curvature of the virtual object enables the content of the virtual object to remain visible to more of the participants in the communication session from their unique viewpoints. Changing a curvature of a surface of a virtual object that is shared in a communication session in a three-dimensional environment when changing one or more spatial properties of the virtual object based on a number of participants in the communication session enables content included on the surface of the virtual object to remain visibly displayed in the three-dimensional environment for the different participants in the communication session and/or enables the curvature of the surface of the virtual object to be changed automatically for given user input that adjusts the size of the virtual object for the different participants in the communication session, thereby improving user-device interaction and overall user experience during the communication session.

In some embodiments, the first value of the spatial parameter corresponds to a spatial distribution of the one or more participants relative to the viewpoint of the user being a first spatial distribution, such as a distance between the viewpoint of the user 702 and the representation 704 in the three-dimensional environment 700 in the top-down view 705 in FIG. 7DD. For example, as similarly discussed above, the one or more participants are located at one or more first locations relative to the viewpoint of the user in the environment. In some embodiments, a first participant of the one or more participants is located a first distance from the viewpoint of the user in the first spatial distribution. In some embodiments, in the first spatial distribution, a first participant is located a first distance from a second participant of the one or more participants in the environment relative to the viewpoint of the user.

In some embodiments, the second value of the spatial parameter corresponds to the spatial distribution being a second spatial distribution that is more spread out than the first spatial distribution (e.g., an average distance between participants in the second spatial distribution is greater than the average distance between participants in the first spatial distribution), such as the increased distance between the viewpoint of the user 702 and the representation 704 in the three-dimensional environment 700 in the top-down view 705 in FIG. 7EE. For example, as similarly discussed above, the one or more participants are located at one or more second locations relative to the viewpoint of the user in the environment. In some embodiments, the first participant of the one or more participants is located a second distance from the viewpoint of the user in the second spatial distribution. In some embodiments, in the second spatial distribution, the first participant is located a second distance from the second participant of the one or more participants in the environment relative to the viewpoint of the user.

In some embodiments, the third amount of curvature is greater than the fourth amount of curvature, such as the curvature of the surface of the virtual object 710 being less in FIG. 7FF than in FIG. 7EE. For example, for a greater spatial distribution of the participants in the real-time communication session, the computer system decreases the curvature of the virtual object in the environment. In some embodiments, the decreased curvature of the virtual object enables the content of the virtual object, such as the content of the virtual instance of the second computer system discussed above, to remain visible and/or interactive to the different participants in the communication session, including the user of the computer system, from the unique locations of the viewpoints of the participants in the communication session. Changing a curvature of a surface of a virtual object that is shared in a communication session in a three-dimensional environment when changing one or more spatial properties of the virtual object based on a spatial distribution of participants in the communication session enables content included on the surface of the virtual object to remain visibly displayed in the three-dimensional environment for the different participants in the communication session and/or enables the curvature of the surface of the virtual object to be changed automatically for given user input that adjusts the size of the virtual object for the different participants in the communication session, thereby improving user-device interaction and overall user experience during the communication session.

In some embodiments, while displaying the virtual object in the environment (e.g., with a respective amount of curvature in the environment) and while the spatial parameter has a respective value, the computer system detects an event that causes a value of the spatial parameter to change from the respective value to a third value, different from the respective value, such as movement of the viewpoint of the second user which causes the representation 704 to move relative to the viewpoint of the user 702 as indicated by arrow 735 in the top-down view 705 in FIG. 7DD. For example, the computer system detects a change associated with one or more participants in the communication session. In some embodiments, detecting the event includes detecting a change in the number of total participants in the communication session. For example, the computer system detects one or more participants leave the communication session and/or detects one or more participants join the communication session. In some embodiments, detecting the event includes detecting a change in the spatial distribution of the participants in the communication session. For example, the computer system detects a change in distance between respective visual representations corresponding to respective participants in the environment relative to the viewpoint of the user and/or a change in distance between respective visual representations and the viewpoint of the user in the environment. In some embodiments, detecting the event includes detecting user input provided by the user of the computer system. For example, the computer system detects movement of the viewpoint of the user, which causes the spatial distribution of the participants to change in the environment, thereby changing the spatial parameter discussed above.

In some embodiments, in response to detecting the event, the computer system associates the value of the spatial parameter with the third value, without changing the curvature of the respective portion of the virtual object in the environment (e.g., the computer system maintains the respective portion of the virtual object with the respective amount of curvature above), such as forgoing changing the curvature of the surface of the virtual object 710 as shown in FIG. 7EE when the representation 704 is moved relative to the viewpoint of the user 702 in the top-down view 705. For example, as discussed above, the number of participants in the communication session changes and/or the spatial distribution of the participants in the communication session changes. In some embodiments, associating the value of the spatial parameter with the third value is accompanied by (e.g., occurs concurrently with) an updating of the environment from the viewpoint of the user. For example, in response to detecting the event discussed above, the number of visual representations (e.g., virtual avatars) in the environment changes from the viewpoint of the user and/or locations of the visual representations in the environment change from the viewpoint of the user.

In some embodiments, while displaying the virtual object in the environment (e.g., and with the respective amount of curvature discussed above) and while the spatial parameter has the third value, the computer system detects, via the one or more input devices, a third set of one or more inputs corresponding to a request to initiate a process to adjust the one or more spatial properties of the virtual object in the environment, such as the input provided by the hand 703 directed to the movement element 712 as shown in FIG. 7EE. For example, the third set of one or more inputs includes one or more air gestures performed by a hand of the user. In some embodiments, the third set of one or more inputs includes a request to initiate movement of the virtual object in the environment relative to the viewpoint of the user. For example, the third set of one or more inputs includes interaction with a movement element (e.g., a handle or grabber bar) associated with the virtual object and that is selectable to initiate movement of the virtual object in the environment relative to the viewpoint of the user. In some embodiments, the third set of one or more inputs includes movement of the viewpoint of the user relative to the virtual object in the environment. For example, the computer system detects movement of a head and/or a location of the user in the physical environment of the computer system, which cause the location of the viewpoint of the user to change in the environment. In some embodiments, the third set of one or more inputs includes a request to resize the virtual object in the environment relative to the viewpoint of the user, such as via interaction with a resize element associated with the virtual object, as similarly discussed above. In some embodiments, the third set of one or more inputs has one or more characteristics of the first set of one or more inputs and/or the second set of one or more inputs discussed above.

In some embodiments, in response to detecting the third set of one or more inputs, the computer system changes the curvature of the respective portion of the virtual object in the environment to a fifth amount of curvature, different from the respective amount of curvature, based at least on the third value of the spatial parameter, such as decreasing the curvature of the surface of the virtual object 710 in the three-dimensional environment 700 as shown in FIG. 7FF. For example, the computer system updates the curvature of the virtual object in response to detecting the third set of one or more inputs based on the updated total number of participants and/or the updated spatial distribution of the participants in the communication session. In some embodiments, as similarly discussed above, if the third value of the spatial parameter corresponds to an increased number of participants and/or a greater spatial distribution of participants in the communication session, the computer system decreases the curvature of the virtual object in the environment. In some embodiments, as similarly discussed above, if the third value of the spatial parameter corresponds to a decreased number of participants and/or a smaller spatial distribution of participants in the communication session, the computer system increases the curvature of the virtual object in the environment. In some embodiments, the computer system changes the curvature of the virtual object to the fifth amount of curvature also based on the size of the virtual object, as similarly discussed above, relative to the viewpoint of the user. Changing a curvature of a surface of a virtual object that is shared in a communication session in a three-dimensional environment when changing one or more spatial properties of the virtual object based on a spatial parameter associated with the participants in the communication session enables content included on the surface of the virtual object to remain visibly displayed in the three-dimensional environment for the different participants in the communication session and/or enables the curvature of the surface of the virtual object to be changed automatically for given user input that adjusts the size of the virtual object for the different participants in the communication session, thereby improving user-device interaction and overall user experience during the communication session.

In some embodiments, while displaying the virtual object in the environment (e.g., with a respective amount of curvature in the environment) and while the spatial parameter has a respective value, the computer system detects an event that causes a value of the spatial parameter to change, such as the number of participants in the communication session changing as indicated in the top-down view 705 in FIG. 7BB. For example, the computer system detects a change associated with one or more participants in the communication session. In some embodiments, detecting the event includes detecting a change in the number of total participants in the communication session (e.g., detecting one or more participants join or leave the communication session), as similarly discussed above. In some embodiments, detecting the event includes detecting a change in the spatial distribution of the participants in the communication session (e.g., detecting a viewpoint of one or more of the participants move, optionally, relative to the virtual object), as similarly discussed above.

In some embodiments, in response to detecting the event, the computer system changes the value of the spatial parameter, such as displaying the representation 704 of the second user in the three-dimensional environment 700 in FIG. 7BB. For example, as discussed above, the number of participants in the communication session changes and/or the spatial distribution of the participants in the communication session changes. In some embodiments, changing the value of the spatial parameter is accompanied by (e.g., occurs concurrently with) an updating of the environment from the viewpoint of the user. For example, in response to detecting the event discussed above, the number of visual representations (e.g., virtual avatars) in the environment changes from the viewpoint of the user and/or locations of the visual representations in the environment change from the viewpoint of the user.

In some embodiments, in accordance with a determination that the value of the spatial parameter is changed to a first respective value, the computer system changes the curvature of the respective portion of the virtual object to a fifth amount of curvature. In some embodiments, in accordance with a determination that the value of the spatial parameter is changed to a second respective value, different from the first respective value, the computer system changes the curvature of the respective portion of the virtual object to a sixth amount of curvature, different from the fifth amount of curvature, such as the changing the curvature of the virtual object 710 as shown in FIG. 7DD based on the increased number of participants in the communication session. For example, the computer system (e.g., automatically, optionally without the need to interact with the virtual object) updates the curvature of the virtual object in response to detecting the change in the total number of participants and/or the spatial distribution of the participants in the communication session. In some embodiments, as similarly discussed above, if the updated spatial parameter corresponds to an increased number of participants and/or a greater spatial distribution of participants in the communication session, the computer system decreases the curvature of the virtual object in the environment (e.g., because it is easier for a larger number of participants or a more spatially distributed set of participants to view and/or interact with the content of the virtual object that has a smaller amount of curvature). In some embodiments, as similarly discussed above, if the updated spatial parameter corresponds to a decreased number of participants and/or a smaller spatial distribution of participants in the communication session, the computer system increases the curvature of the virtual object in the environment (e.g., because it is easier for a smaller number of participants or a less spatially distributed set of participants to view and/or interact with the content of the virtual object that has a larger amount of curvature). In some embodiments, the computer system changes the curvature of the virtual object in the environment without detecting user input (e.g., without detecting a set of one or more inputs corresponding to a request to initiate adjustment of the one or more spatial properties of the virtual object in the environment). Changing a curvature of a surface of a virtual object that is shared in a communication session in a three-dimensional environment when changing a spatial parameter associated with the participants in the communication session enables content included on the surface of the virtual object to remain visibly displayed in the three-dimensional environment for the different participants in the communication session and/or enables the curvature of the surface of the virtual object to be changed automatically when a number of participants and/or a spatial distribution of the participants changes in the communication session, thereby improving user-device interaction and overall user experience during the communication session.

In some embodiments, a sharing status of the virtual object in the communication session (e.g., whether the virtual object is a shared object in the environment) is a first sharing status, such as the virtual object 710 being a private object as described with reference to FIG. 7BB. In some embodiments, while displaying the virtual object in the environment (e.g., with a respective amount of curvature in the environment) and while the virtual object has the first sharing status in the communication session, the computer system detects an event (e.g., a user input or other indication) that causes the sharing status of the virtual object in the communication session to change from the first sharing status to a second sharing status, different from the first sharing status, such as the selection of the share option 738 associated with the virtual object 710 provided by the hand 703 in FIG. 7BB. In some embodiments, the first sharing status of the virtual object corresponds to the virtual object being a shared object in the communication session, as similarly discussed above. In some embodiments, changing the sharing status to the second sharing status corresponds to the virtual object being unshared in the communication session. For example, the virtual object is transitioned to being a private object in the environment, such that the content of the virtual object is viewable and/or interactive to the user of the computer system, without being viewable and/or interactive to the one or more participants in the communication session. In some embodiments, the first sharing status of the virtual object corresponds to the virtual object being a private object in the communication session, such that changing the sharing status to the second sharing status corresponds to the virtual object being shared in the communication session. In some embodiments, the first sharing status of the virtual object corresponds to the virtual object being displayed in the environment while the communication session is a non-spatial communication session. For example, a non-spatial communication session is a real-time communication session in which the environment does not include virtual avatars or other three-dimensional representations of users that visually provide the user indications of the locations in the virtual space that are occupied by other users within the communication session. Accordingly, in some embodiments, changing the sharing status to the second sharing status corresponds to the virtual object being displayed in a spatial communication session (e.g., the spatial real-time communication session being initiated with the one or more participants discussed above). In some embodiments, the first sharing status of the virtual object corresponds to the virtual object being displayed in the environment while the communication session is a spatial communication session, such as a real-time communication session in which the environment includes virtual avatars or other three-dimensional representations that visually provide the user of the computer system with indications of the locations in the virtual space that are occupied by other users (e.g., the one or more participants) within the communication session. In some embodiments, changing the sharing status to the second sharing status corresponds to the virtual object being displayed in a non-spatial communication session (e.g., the non-spatial communication session being initiated with the one or more participants). In some embodiments, changing the sharing status of the virtual object to the second sharing status includes terminating the communication session with the one or more participants. For example, the computer system detects user input provided by the user to leave the communication session (e.g., via a selection of an option for leaving the communication session) or detects an indication that the communication session has been terminated for all participants (e.g., by the initiator of the communication session).

In some embodiments, in response to detecting the event, the computer system changes the sharing status of the virtual object from the first sharing status to the second sharing status (e.g., in the manner discussed above), without changing the curvature of the respective portion of the virtual object in the environment (e.g., the computer system maintains display of the respective portion of the virtual object with the respective amount of curvature discussed above), such as forgoing changing the curvature of the surface of the virtual object 710 as shown in FIG. 7CC when the virtual object 710 is shared with the second user. In some embodiments, changing the sharing status of the virtual object from the first sharing status to the second sharing status is accompanied by (e.g., occurs concurrently with) updating the environment from the viewpoint of the user. For example, in response to detecting the event discussed above, display of visual representations (e.g., virtual avatars) in the environment changes from the viewpoint of the user (e.g., the visual representations are displayed or are no longer displayed) and/or display of the virtual object changes from the viewpoint of the user (e.g., the virtual object is displayed with an indication of the virtual object being shared or private in the communication session).

In some embodiments, while displaying the virtual object in the environment (e.g., with the respective amount of curvature discussed above) and while the virtual object has the second sharing status, the computer system detects, via the one or more input devices, a third set of one or more inputs corresponding to a request to initiate a process to adjust the one or more spatial properties of the virtual object in the environment, such as the input provided by the hand 703 directed to the movement element 712 as shown in FIG. 7CC. For example, the third set of one or more inputs includes one or more air gestures performed by a hand of the user. In some embodiments, the third set of one or more inputs includes a request to initiate movement of the virtual object in the environment relative to the viewpoint of the user. For example, the third set of one or more inputs includes interaction with a movement element (e.g., a handle or grabber bar) associated with the virtual object and that is selectable to initiate movement of the virtual object in the environment relative to the viewpoint of the user. In some embodiments, the third set of one or more inputs includes movement of the viewpoint of the user relative to the virtual object in the environment. For example, the computer system detects movement of a head and/or a location of the user in the physical environment of the computer system, which cause the location of the viewpoint of the user to change in the environment. In some embodiments, the third set of one or more inputs includes a request to resize the virtual object in the environment relative to the viewpoint of the user, such as via interaction with a resize element associated with the virtual object, as similarly discussed above. In some embodiments, the third set of one or more inputs has one or more characteristics of the first set of one or more inputs and/or the second set of one or more inputs discussed above.

In some embodiments, in response to detecting the third set of one or more inputs, the computer system changes the curvature of the respective portion of the virtual object in the environment to a fifth amount of curvature, different from the respective amount of curvature, such as decreasing the curvature of the surface of the virtual object 710 in the three-dimensional environment 700 as shown in FIG. 7DD. For example, because the sharing status of the virtual object has been updated in the communication session, the computer system updates the curvature of the virtual object in response to detecting the third set of one or more inputs based on the factors previously discussed above, such as the size of the virtual object relative to the viewpoint of the user, a simulated resolution of the virtual object, and/or a location of the virtual object in the environment. In some embodiments, detecting the event that causes the sharing status of the virtual object to change also causes the spatial parameter associated with the participants in the communication session discussed above to change. For example, sharing or ceasing sharing of the virtual object in the communication session causes the number of participants who are able to view and/or interact with the virtual object to increase or decrease, respectively. Similarly, entering or exiting/ending the communication session in the environment optionally causes the spatial distribution of the participants in the communication session to increase or decrease, respectively. However, in some embodiments, despite whether the number of participants and/or the spatial distribution of participants in the communication session has changed, the computer system changes the curvature of the virtual object in the environment based on the size of the virtual object relative to the viewpoint of the user (e.g., in response to and/or when detecting the third set of one or more inputs), and thus independent of the spatial parameter discussed above. Changing a curvature of a surface of a virtual object that is shared in a communication session in a three-dimensional environment when changing one or more spatial properties of the virtual object based on a sharing status of the virtual object in the communication session enables content included on the surface of the virtual object to remain visibly displayed in the three-dimensional environment for the different participants in the communication session and/or enables the curvature of the surface of the virtual object to be changed automatically for changes in the sharing status of the virtual object in the communication session, thereby improving user-device interaction and overall user experience during the communication session.

It should be understood that the particular order in which the operations in method 900 have been described is merely exemplary and is not intended to indicate that the described order is the only order in which the operations could be performed. It should be understood that the particular order in which the operations in methods 800 and/or 900 have been described is merely exemplary and is not intended to indicate that the described order is the only order in which the operations could be performed. One of ordinary skill in the art would recognize various ways to reorder the operations described herein. In some embodiments, aspects/operations of methods 800, and/or 900 may be interchanged, substituted, and/or added between these methods. For example, the three-dimensional environment in methods 800 and/or 900, the virtual content and/or virtual objects in methods 800 and/or 900, and/or the interactions with virtual content and/or the user interfaces in methods 800 and/or 900 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a first computer system in communication with one or more display generation components and one or more input devices:
while displaying, via the one or more display generation components, a representation of content from a second computer system, different from the first computer system, in an environment, detecting, via the one or more input devices, a first set of one or more inputs corresponding to a request to change a size of the representation of the content in the environment; and
in response to detecting the first set of one or more inputs:
in accordance with a determination that the first set of one or more inputs includes a first type of input, changing a simulated resolution of the representation of the content in the environment based on the first set of one or more inputs, wherein changing a simulated resolution of the representation of the content increases an amount of space in the representation of content that is available for displaying content items.

2. The method of claim 1, wherein the first type of input includes interaction with a resize element associated with the representation of the content from the second computer system in the environment.

3. The method of claim 2, wherein the resize element is displayed in the environment in response to detecting attention of a user of the first computer system directed toward a respective portion of the representation of the content from the second computer system in the environment.

4. The method of claim 3, wherein the respective portion of the representation of the content from the second computer system includes a respective edge of the representation of the content from the second computer system.

5. The method of claim 3, wherein displaying the resize element in the environment in response to detecting the attention of the user directed toward the respective portion of the representation of the content from the second computer system includes:
in accordance with a determination that the attention of the user is directed toward a first portion of the representation of the content from the second computer system in the environment, displaying, via the one or more display generation components, the resize element at a first location in the environment that is based on the first portion; and
in accordance with a determination that the attention of the user is directed toward a second portion, different from the first portion, of the representation of the content from the second computer system in the environment, displaying the resize element at a second location, different from the first location, in the environment that is based on the second portion.

6. The method of claim 1, wherein the first type of input includes selection of a respective option that is selectable to change the simulated resolution of the representation of the content from the second computer system in the environment.

7. The method of claim 6, wherein the respective option is displayed within a menu of selectable options, and the menu is displayed in the environment in response to detecting input directed to the representation of the content from the second computer system.

8. The method of claim 6, wherein:
the representation of the content from the second computer system is concurrently displayed with a respective user interface object in the environment;
a menu that includes one or more selectable options is displayed, via the one or more display generation components, in the environment in response to detecting input directed to the respective user interface object; and
the respective option is displayed within the menu that includes the one or more selectable options.

9. The method of claim 1, further comprising:
in response to detecting the first set of one or more inputs:
in accordance with a determination that the first set of one or more inputs includes a second type of input, different from the first type of input, changing a size of the representation of the content from the second computer system relative to a viewpoint of a user of the first computer system in the environment, without changing the simulated resolution of the representation of the content from the second computer system in the environment, based on the first set of one or more inputs.

10. The method of claim 9, wherein:
the first type of input includes interaction with a first resize element associated with the representation of the content from the second computer system in the environment; and
the second type of input includes interaction with a second resize element, different from the first resize element, associated with the representation of the content from the second computer system.

11. The method of claim 10, wherein:
the first resize element is displayed at a location corresponding to an edge of the representation of the content from the second computer system in the environment; and
the second resize element is displayed at a location corresponding to a corner of the representation of the content from the second computer system in the environment.

12. The method of claim 9, wherein, prior to detecting the first set of one or more inputs, the representation of the content from the second computer system includes a first object, the method further comprising:
in response to detecting the first set of one or more inputs:
in accordance with a determination that changing the size of the representation of the content from the second computer system relative to the viewpoint of the user corresponds to increasing the size of the representation relative to the viewpoint of the user, increasing a size of the first object in the representation of the content from the second computer system in the environment relative to the viewpoint of the user based on the first set of one or more inputs.

13. The method of claim 9, wherein:
the first type of input includes selection of a respective option that is selectable to change the simulated resolution of the representation of the content from the second computer system in the environment; and
the second type of input includes an air gesture performed with a first portion and a second portion of a user of the first computer system.

14. The method of claim 1, wherein:
prior to detecting the first set of one or more inputs, the representation of the content from the second computer system includes a first object having a first size from a current viewpoint of a user of the computer system; and
increasing the amount of space in the representation of content that is available for displaying content items includes maintaining display of the first object at the first size in the representation of the content from the second computer system from the current viewpoint of the user of the computer system.

15. The method of claim 1, wherein:
prior to detecting the first set of one or more inputs, the representation of the content from the second computer system includes a first object at a first location in the representation of the content from the second computer system; and
changing the simulated resolution of the representation of the content includes displaying the first object at a second location, different from the first location, in the representation of the content from the second computer system without increasing a size of the first object in the representation of the content from the second computer system from a current viewpoint of a user of the computer system.

16. The method of claim 1, wherein:
prior to detecting the first set of one or more inputs, the representation of the content from the second computer system includes a first object having a first size from a current viewpoint of a user of the computer system; and
changing the simulated resolution of the representation of the content in accordance with the determination that the first set of one or more inputs includes the first type of input corresponds to decreasing the simulated resolution of the representation, including:
in accordance with a determination that the first size of the first object is greater than a threshold size associated with the amount of space in the representation of the content from the second computer system that is available for displaying content items, displaying the first object at a second size from the current viewpoint of the user of the computer system, smaller than the first size, that is within the threshold size in the representation of the content from the second computer system; and
in accordance with a determination that the first size of the first object is within the threshold size, maintaining display of the first object at the first size in the representation of the content from the second computer system from the current viewpoint of the user of the computer system.

17. The method of claim 16, further comprising:
in response to detecting the first set of one or more inputs:
in accordance with a determination that the first set of one or more inputs includes a second type of input, different from the first type of input, decreasing a size of the representation of the content from the second computer system and decreasing a size of the first object based on the first set of one or more inputs.

18. The method claim 1, wherein changing the simulated resolution of the representation of the content from the second computer system includes changing an aspect ratio of the representation of the content from the second computer system in the environment.

19. The method of claim 1, further comprising:
while changing the simulated resolution of the representation of the content from the second computer system based on the first set of one or more inputs in accordance with the determination that the first set of one or more inputs includes the first type of input in response to detecting the first set of one or more inputs, reducing a visual fidelity of the representation of the content from the second computer system in the environment.

20. The method of claim 19, further comprising:
in response to detecting termination of the first set of one or more inputs, increasing the visual fidelity of the representation of the content from the second computer system in the environment.

21. The method of claim 1, wherein:
prior to detecting the first set of one or more inputs, a value of the simulated resolution of the representation of the content from the second computer system is a first value; and
changing the simulated resolution of the representation of the content from the second computer system based on the first set of one or more inputs includes changing the value of the simulated resolution to a second value, different from the first value, in accordance with the first set of one or more inputs.

22. The method of claim 1, wherein:
prior to detecting the first set of one or more inputs, a value of the simulated resolution of the representation of the content from the second computer system is a first value; and
changing the simulated resolution of the representation of the content from the second computer system based on the first set of one or more inputs includes changing the value of the simulated resolution to a respective value of a set of values of simulated resolution, wherein:
in accordance with a determination that the first set of one or more inputs corresponds to a request to change the value to a first respective value that is within a threshold of a second value in the set of values, the respective value is the second value; and
in accordance with a determination that the first set of one or more inputs corresponds to a request to change the value to a second respective value that is within the threshold of a third value, different from the second value, in the set of values, the respective value is the third value.

23. The method of claim 1, wherein, prior to detecting the first set of one or more inputs, a respective portion of the representation of the content from the second computer system has a first amount of curvature, the method further comprising:
in response to detecting the first set of one or more inputs:
in accordance with a determination that the representation of the content from the second computer system has a first size in the environment relative to a viewpoint of a user of the first computer system, changing a curvature of the respective portion of the representation of the content from the second computer system from the first amount of curvature to a second amount of curvature that is different from the first amount of curvature.

24. The method of claim 23, wherein the determination that the representation of the content from the second computer system has the first size relative to the viewpoint of the user is based on a determination that the representation of the content from the second computer system occupies a first amount of a field of view of the user in the environment from the viewpoint of the user.

25. A first computer system that is in communication with one or more input devices and one or more display generation components, the first computer system comprising:
one or more processors;
memory; and
one or more programs, wherein the one or more programs are stored in the memory and configured to be executed by the one or more processors, the one or more programs including instructions for:
while displaying, via the one or more display generation components, a representation of content from a second computer system, different from the first computer system, in an environment, detecting, via the one or more input devices, a first set of one or more inputs corresponding to a request to change a size of the representation of the content in the environment; and
in response to detecting the first set of one or more inputs:
in accordance with a determination that the first set of one or more inputs includes a first type of input, changing a simulated resolution of the representation of the content in the environment based on the first set of one or more inputs, wherein changing a simulated resolution of the representation of the content increases an amount of space in the representation of content that is available for displaying content items.

26. A non-transitory computer readable storage medium storing one or more programs, the one or more programs comprising instructions, which when executed by one or more processors of a first computer system that is in communication with one or more input devices and one or more display generation components, cause the first computer system to perform a method comprising:
while displaying, via the one or more display generation components, a representation of content from a second computer system, different from the first computer system, in an environment, detecting, via the one or more input devices, a first set of one or more inputs corresponding to a request to change a size of the representation of the content in the environment; and
in response to detecting the first set of one or more inputs:
in accordance with a determination that the first set of one or more inputs includes a first type of input, changing a simulated resolution of the representation of the content in the environment based on the first set of one or more inputs, wherein changing a simulated resolution of the representation of the content increases an amount of space in the representation of content that is available for displaying content items.
